(19) United States
(12) Patent Application Publication
(10) Pub. No.: US 2019/0168047 A1
(43) Pub. Date: Jun. 6, 2019

(54) METHOD OF AND SYSTEM FOR SUPPRESSING FIRE USING ANENVIRONMENTALLY-CLEAN FREE-RADICAL CHEMICAL-REACTION INTERRUPTING WATER MIST SO AS TO REDUCE WATER DAMAGE AND SMOKE PRODUCTION AND THE RISK OF FIRE RE-IGNITION

(71) Applicant: M-Fire Suppression, Inc., Carlsbad, CA (US)

(72) Inventor: Stephen Conboy, Carlsbad, CA (US)

(73) Assignee: M-Fire Suppression, Inc., Carlsbad, CA (US)

(21) Appl. No.: 16/107,473

(22) Filed: Aug. 21, 2018

Related U.S. Application Data
(63) Continuation-in-part of application No. 15/874,874, filed on Jan. 18, 2018.
Application No. 15/874,874 is a continuation-in-part of application No. 15/866,454, filed on Jan. 9, 2018.
Application No. 15/866,454 is a continuation-in-part of application No. 15/829,914, filed on Dec. 2, 2017, now Pat. No. 10,260,232.
Application No. 15/829,914 is a continuation-in-part of application No. 15/866,456, filed on Jan. 9, 2018.
Application No. 15/866,456 is a continuation-in-part of application No. 15/866,451, filed on Jan. 9, 2018.
Application No. 15/866,451 is a continuation-in-part of application No. 16/039,291, filed on Jul. 18, 2018.
Application No. 16/039,291 is a continuation-in-part of application No. 15/925,793, filed on Mar. 20, 2018.
Application No. 15/925,793 is a continuation-in-part of application No. 16/055,001, filed on Aug. 3, 2018.
Application No. 16/055,001 is a continuation of application No. 16/104,130, filed on Aug. 16, 2018.

(51) Int. Cl. A62C 99/00; A62C 3/08; A62C 3/10; A62C 5/00; A62C 35/02; A62C 37/36; A62C 37/38; A62D 1/00

(52) U.S. Cl. CPC A62C 99/0072; A62C 3/08; A62C 3/10; A62D 1/0035; A62C 35/023; A62C 37/04; A62C 37/38; A62C 5/008

(57) ABSTRACT

A method of and apparatus for automatically suppressing a detected fire in a building, vessel or vehicle, using a cloud of microscopic droplets generated from a supply of environmentally-clean water-based free-radical chemical-reaction interrupting liquid, whereby the droplets are vaporized by heat energy from the fire, instantly cooling the fire and displacing oxygen, while the water-based chemical vapor interrupts the free-radical chemical-reactions in the combustion phase of the fire, while minimizing smoke development, water damage, and risk of fire re-ignition.

### RELATED CASES

The present patent application is a Continuation-in-Part (CIP) of: copending patent application Ser. No. 16/104,130 filed Aug. 16, 2018; copending patent application Ser. No. 16/055,001 filed Aug. 3, 2018; copending application Ser. No. 15/866,451 filed Jan. 9, 2018; co-pending application Ser. No. 16/039,291 filed Jul. 18, 2018 which is a Continuation-in-Part (CIP) of copending patent application Ser. No. 15/874,874 filed Jan. 18, 2018, which is a Continuation-in-Part (CIP) of copending patent application Ser. No. 15/866,454 filed Jan. 9, 2018 which is a Continuation-in-Part (CIP) of copending patent application Ser. No. 15/829,914 filed Dec. 2, 2017; copending U.S. patent application Ser. No. 15/925,793 filed Mar. 20, 2018; and copending patent application Ser. No. 15/866,456 filed Jan. 9, 2018 which is a Continuation-in-Part (CIP) of copending patent application Ser. No. 15/829,914 filed Dec. 2, 2017, each said patent application being commonly owned by M-Fire Suppression, Inc., and incorporated herein by reference as if fully set forth herein.

### BACKGROUND OF INVENTION

### Field of Invention

The present invention is directed towards improvements in science and technology applied in the defense of protecting people, property and business continuity, against the ravaging and destructive forces of fires whether caused by accident, lightening, arson or terrorism.

### Brief Description of the State of Knowledge in the Art

Fire is a process which involves a chemical reaction between a combustible fuel and oxygen. The prerequisites for sustained burning are: combustible fuel; oxygen; heat for ignition; and un-interrupted chemical reactions. To extinguish a fire, at least one of the four prerequisites must be removed. The fuel itself can rarely be removed, but the other parameters can be affected by different fire fighting agents. For instance, oxygen concentration can be lowered by adding inert gas into the fire, heat can be removed by wetting the combustibles, and chain reactions can be interrupted by adding a chemical.

Water is the oldest, most widely used and universally available fire fighting agent known to man. It is non-toxic, environmentally-friendly, and has superior fire protection capabilities when compared to every other agent.

As shown in FIG. 1, traditional sprinkler systems 1 provide a highly effective method of fire suppression and extinguishment. When installing fire sprinklers 2 in a high-rise facility 3, water supply availability 4 is a primary consideration. The National Fire Protection Association (NFPA), based in Quincy, Mass., defines a high-rise as a structure that measures more than 75 feet in height (translating to 7 stories or higher). For buildings that are more than 75 feet tall, the newest edition of the NFPA 14 Standard on the Installation of Standpipes and Hose Systems requires water pressure of 100 psi (pounds per square inch) at the top of the standpipe. Older buildings with existing standpipes 5 may have been designed according to the older NFPA 14 Standard, requiring only 65 psi available at the top. This would likely necessitate an increase in the rated pressure of the existing fire pump.

As shown in FIG. 2, there are two different classes of conventional water sprinkler systems: wet systems 5 adapted for frost free rooms, not at risk of freezing; and dry systems 6 adapted for rooms exposed to frost and at risk of freezing. However, regarding of which type of system is deployed in a given environment, sprinkler systems suffer from several significant shortcomings and drawbacks. Specifically, traditional sprinkler systems discharge enormous amounts of water, predominantly in the form of large droplets, in either a protected space or directly onto the equipment to be protected against fire. Consequently, traditional large-droplet sprinkler systems require large amounts of water to operate, and frequently cause extensive water damage in the protected spaces.

In response to the shortcomings of traditional sprinkler systems, “water mist systems” were developed, originally in the 1940s, for specific applications such as passenger ferries. Renewed interest in water mist systems is due partially to the phasing out of Halon and the promising potential of water mist systems as a fire safety system for spaces where the amount of water that can be stored, or discharged, is limited. In addition to protecting residential occupancies, water mist systems are being considered for other applications such as flammable-liquid storage facilities, and electrical equipment spaces.

As illustrated in the table shown in FIG. 3A, a water mist system uses very fine water sprays (i.e. water mist). The small water droplets allow the water mist to control, suppress or extinguish fires by: (i) cooling both the flame and surrounding gases by droplet evaporation; (ii) displacing oxygen as droplets evaporate and vapor expands; and (iii) attenuating radiant heat by the small droplets themselves.

The effectiveness of a water mist system in fire suppression depends on its spray characteristics which include (i) the droplet size distribution, (ii) flux density and (iii) spray dynamics with respect to the fire scenario, such as the shielding of the fuel, fire size and ventilation conditions.

The use of water mist fire suppression, when compared to the use of gaseous agents and traditional water sprinkler systems, has revealed many advantages including: immediate activation; high efficiency in the suppression of a wide variety of fires; minimized water damage; environmentally sound characteristics; and no toxicity problems.

Today, high-pressure water mist fire protection technology is used in many applications including passenger ferries, protecting people, property and business continuity in a wide range of applications both on land and at sea.

The environmental advantages of water mist fire suppression systems are:

(i) Water mist systems consume notably less water than traditional sprinkler systems, minimizing consequential water damage;

(ii) Water mist systems do not contribute to ozone depletion or global warming;

(iii) Water mist systems do not produce toxic by-products when applied to a fire and do not require complex decommissioning procedures.

Water mist systems have proved effective in controlling, suppressing, or extinguishing many types of fires. Potential applications include the following:

(1) Gas jet fires;

(2) Flammable and combustible liquids

(3) Hazardous solids, including fires involving plastic foam furnishings

(4) Protection of aircraft occupants from an external pool fire long enough to provide time to escape;

(5) Ordinary (Class A) combustible fires such as paper, wood, and textiles;

(6) Occupancy classifications;

(7) Electrical hazards, such as transformers, switches, circuit breakers, and rotating equipment;

(8) Electronic equipment, including telecommunications equipment; and

(9) Highway and railway tunnels (see NFPA 502, Standard for Road Tunnels, Bridges, and Other Limited Access Highways).

The NFPA 750 Standard defines three (3) pressure regions for water mist-generating technologies: low pressure systems; intermediate pressure systems; and high pressure systems In the table of FIG. 3B, some exemplary water mist systems are identified for different classes of hydraulic operating pressure.

FIG. 4 shows the components of a conventional “single-fluid” (single-media) type water mist fire suppression system 10 installed in a space 11 to be protected. As shown, the system 10 comprises: one or more water misting heads 12 are mounted in a room space and connected to a section control valve 13. Each section control valve 13 is connected to a main control valve 14 that is connected to one or more hydraulic pumps 15 that can be driven by an electrical motor, a gas-pressure-driven motor, a gas turbine motor, or other motor source. When a fire 17 is automatically detected in a building section 11 by one or more automatic fire detectors 16 installed in the building section, the system controller 18 responds to such signals and activates the solenoid control valve 19 to control the flow of water from the main water supply 20 through a water filter 21, into a water storage/buffer tank 22, where it is then automatically pumped into the hydraulic pump unit 15 by a feed water pump 23, as shown. The hydraulic fluid pump unit 15 then pumps the water into the misting nozzles 12 at a low, intermediate or high pressure to produce a fine water mist in the building section to suppress and extinguish the fire 17, while the system controller 18 controls water pumping operations to maintain the level of filtered water stored in the water storage/buffer tank 22 during fire suppression operations. Typically, all water mist fire suppression systems will also include a control panel 24 with an LCD and/or touch screen display with alarm indicators and an annunciator to signal when a fire is detected by the system. Examples of such single-media water mist systems include Tyco's Aqua Mist™ ULF Water Mist Fire Suppression System, Fike's® Water Mist Fire Suppression System, Tyco's Aqua Mist™ FOG Fire Suppression System, Danfoss Semco's SEM-SAFE® Water Mist Fire Suppression System, Ultra FOG AB's Ultra FOG® Water Mist Fire Extinguishing System, and Securiplex's Fire-Scope® 5000 Water Mist Fire Extinguishing System, listed in the table of FIG. 3B.

In FIGS. 5A and 5B, a “twin-fluid” (dual-media) type pneumatically-pressurized water misting system 25 is shown comprising a supply of water 26 and a source of air-pressurized air 27, and both being connected to a piping system 28 configured for supplying both the water and pressurized air to a set of atomizing nozzles (i.e. spray heads) 29, with large water pathways. As shown in FIG. 5A, the system 25 includes solenoid check valve 30, a main check valve 31 and section check valves 32A, 32B under the control of the system controller 33 receiving alarm signals from a set of automatic fire detectors 34 installed in the spaces being protected. Typically, such systems are designed to operate at low water pressure (e.g. 75-85 psig) to allow the use of standard piping and the connection to the plant water 26 and air supply 27 when available. Upon detecting the presence of a fire, the automatic fire detectors send alarms signals to the system controller 33 which opens up the check valves 31, 32A, 32B to allow water 35 and pressurized air 36 to mix under pressure at the spray nozzles 29, illustrated in FIG. 5B, to generate a fine mist or fog 37 for suppressing and extinguishing the detected fire. As water mist 37 is generated by air impingement, rather than being forced through small orifices in misting heads under hydraulic pressure, the risk of nozzle clogging in such systems is significantly minimized. An example of this dual-media system is the Securaplex Fire-Scope 2000 Low-Pressure Dual-Media Water Fog/Mist System, listed in FIG. 3B. Variations of the system shown in FIGS. 5A and 5B will include using a pressurized inert gas, such as nitrogen (N2) rather than air, as the atomizing media defined under the NFPA 750 Standard.

FIG. 6 shows a conventional portable twin-fluid water mist fire extinguisher 40 comprising a water storage tank 41 having a 5 gallon capacity for storing deionized water. The water storage tank 41 is charged with 100 psig pressure from a small pressurized air tank 42 integrated with the frame of the housing 43 The hand-activated atomizing misting head (i.e. misting gun) 44 supporting an atomizing misting nozzle 45 that is fed water and compressed air (i.e. two fluids) by two flexible hoses 46A and 46B, one connected to the water tank 41 and the other connected to the pressurized air tank 42. The misting nozzle 45 is connected to a flow control valve 46 that is manually activated by depressing a finger-activated trigger 47 to discharge water mist 48 from the atomizing nozzle 45 onto a fire for quick suppression and extinguishment. Prior art water mist fire extinguishers can be either back-mounted, or carried in one hand while the other hand is used to hold and operate the spray-misting gun 44. Typically, deionized water is used with such portable water misting systems, to minimize the electrical conductivity of the water mist produced during the fire suppression process.

In general, high-pressure water misting systems have shown to consistently deliver better penetration into the seat of the fire than low-pressure systems. High-pressure systems have also shown to provide superior coverage of the protected volume; provide improve cooling effect from better mixing of gases and high evaporation rate; lower overall weight of the system; and consume less water during the water misting fire suppression process.

Under the NFPA 750 Standard on Water Mist Fire Suppression Systems, a number of important definitions are provided for the industry as a whole, along with a number of prescriptions and requirements to be followed. Also, the FM Approvals Group has published a number of Standards that correspond to the NFPA 750 Standard, namely: FM Approval Standard for Water Mist Systems Class Number 5560 (April 2016); FM Approval Standard for Hybrid (Water and Insert Gas) Fire Extinguishing Systems Class Number 5580 (November 2012); and FM Approvals American National Standard for Water Mist System Class Approvals 5560-2017 (November 2017). These FM Approval Standards are aligned with the NFPA 750 Standard and provide additional guidance for those involved in the design,

Referring to the NFPA 750 Standard, there are a number of definitions and requirements that will be reviewed and discussed below, to provide an introduction to the NFPA 750 Standard and a broad overview on the state of the art in the water mist fire suppression field.

For example, in the NFPA 750 Standard, Fire Extinguishment is defined as the complete suppression of a fire until there are no burning combustibles. Fire Suppression is the sharp reduction of the rate of heat release of a fire and the prevention of regrowth.

“Water Mist” is defined as a water spray for which the drop diameter—Dv0.99, for the flow-weighted cumulative volumetric distribution of water droplets, is less than 1000 μm (1 mm) within the nozzle operating pressure range.

A Water Mist System is a distribution system connected to a water supply or water and atomizing media supplies, that is equipped with one or more nozzles capable of delivering water mist intended to control, suppress, or extinguish fires and that has been demonstrated to meet the performance requirements of its listing and the NFPA 750 Standard.

The NFPA 750 Standard defines “water mist” as using fine water sprays for the efficient control, suppression, or extinguishment of fires using limited volumes of water. Properly designed water mist systems can be effective on both liquid fuel (Class B) and solid fuel (Class A) fires. Research indicates that fine (i.e., smaller than 400 microns) droplets are essential for extinguishment of Class B fires, although larger drop sizes are effective for Class A combustibles, which benefit from extinguishment by fuel wetting. For this reason, the definition of water mist in the NFPA 750 Standard includes sprays with drop diameter (i.e. Dv0.99) of up to 1000μ (1 mm).

The NFPA 750 Standard definition of “water mist” includes (i) some water sprays used in the NFPA 15 Standard on Water Spray Fixed Systems for Fire Protection, (ii) some sprays produced by standard sprinklers operating at high pressure, as well as (iii) light mists suitable for greenhouse misting and HVAC humidification systems. This range in drop size distribution is so broad that some important differences in the performance of sprays with finer different distributions are not distinguished. The relationship between drop size distribution and extinguishing capacity of a water mist is complex. In general, very fine particles enhance heat absorption and generation of water vapor. With liquid (Class B) fuels, too many “large” drops could agitate the surface of the fuel and increase burning intensity. On the other hand, larger drops could assist the spray to penetrate and wet charred, smoldering Class A fuels. Larger drops could also entrain finer drops in their wake and improve the transport of much smaller drop sizes into the seat of the fire.

Drop size distribution alone does not determine the ability of a spray to extinguish a given fire. Factors such as fuel properties, enclosure effects (which are a function of ventilation and heat confinement), spray flux density, and spray velocity (momentum) are all involved in determining whether a fire will be extinguished. The “momentum” of an element of spray is the product of its velocity and the mass of dispersed water droplets (i.e. the mass flow rate). The term velocity implies direction as well as speed. It is the momentum of a mist in a particular direction, relative to the direction of flow of the hot fire gases that enhances cooling and suppression effectiveness. Opposing directional flows bring about turbulent mixing, hence improved cooling. Therefore, all three variables—drop size distribution, flux density, and velocity—are involved in determining the ability to extinguish a fire in a given scenario.

Water mist systems can be described by the following four parameters as appropriate: (1) System Application; (2) Nozzle Type; (3) System Operation Method; and (4) System Media Type.

The NFPA 750 Standard defines System Applications as consisting of one of the following four categories:

(1) Local-application systems;

(2) Total compartment application systems;

(3) Zoned application systems; and

(4) Occupancy protection systems.

Local-application systems shall be designed and installed to provide complete distribution of mist on or around the hazard or object to be protected. Local-application systems shall be designed to protect an object or a hazard in an enclosed, unenclosed, or open outdoor condition. Local-application systems shall be actuated by either an automatic nozzle or by an integrated detection system with non-automatic water mist nozzles.

Total compartment application systems shall be designed and installed to provide complete protection of an enclosure or space. The complete protection of an enclosure or space shall be achieved by the simultaneous operation of all nozzles in the space by manual or automatic means.

Zoned application systems shall be designed to protect a predetermined portion of the compartment by the activation of a selected group of nozzles. Zoned application systems shall be designed and installed to provide complete mist distribution throughout a predetermined portion of an enclosure or space. This shall be achieved by simultaneous operation of a selected group of nozzles in a predetermined portion of the space by manual or automatic means or by an independent detection system.

Occupancy protection systems shall be designed and installed to provide automatic fire protection throughout a building or occupancy. Occupancy protection systems utilized as fire protection within buildings or occupancies shall be of the wet pipe, dry pipe, or pre-action type. Occupancy protection systems shall be actuated by automatic water mist nozzles or by an integrated detection system.

The NFPA 750 Standard defines three classes of water mist nozzles: (1) Automatic type; (2) Nonautomatic type; and (3) Multi-functional type.

The NFPA 750 Standard also defines a number of different types of water mist systems under the Standard.

A Deluge Water Mist System is a water mist system utilizing no automatic mist nozzles (open) attached to a piping network connected to the fluid supply(ies) through a valve controlled by an independent detection system installed in the same area as the mist nozzles. Deluge systems shall employ no automatic nozzles (open) attached to a piping network connected to the fluid supply(ies) through a valve controlled by an independent detection system installed in the same area as the mist nozzles. When the valve(s) is activated, the fluid shall flow into the piping network and discharge from all nozzles attached thereto.

A Dry Pipe Water Mist System is a water mist system using automatic nozzles attached to a piping system containing air, nitrogen, or inert gas under pressure, the release of which (as from an opening of an automatic nozzle) allows the water pressure to open a dry pipe valve. The water then flows into the piping system and out through any open nozzles. Dry pipe systems shall employ automatic nozzles attached to a piping network containing a pressurized gas. The loss of pressure in the piping network shall activate a control valve, which causes water to flow into the piping network and out through the activated nozzles. The pressurized piping in all dry pipe systems shall be supervised to ensure system integrity.

Engineered Water Mist Systems are those systems that need individual calculation and design to determine the flow rates, nozzle pressures, pipe size, area, or volume protected by each nozzle, discharge density of water mist, the number and types of nozzles, and the nozzle placement in a specific system.

A Local-Application Water Mist System is a water mist system arranged to discharge directly on an object or hazard in an enclosed, unenclosed, or open outdoor condition.

Occupancy Protection Systems are water mist systems utilizing automatic water mist nozzles installed throughout a building or a portion of a building and intended to control, suppress, or extinguish a fire.

A Preaction Water Mist System is a water mist system using automatic nozzles attached to a piping system that contains air that might or might not be under pressure, with a supplemental detection system installed in the same areas as the mist nozzles. The actuation of the detection system opens a valve that allows water to flow into the piping system and discharges through all opened nozzles in the system. Preaction systems shall employ automatic nozzles attached to a piping network containing a pressurized gas with a supplemental, independent detection system installed in the same area as the nozzles. Operation of the detection system shall actuate a tripping device that opens the valve, pressurizing the pipe network with water to the nozzles. The pressurized piping in all preaction systems shall be supervised to ensure system integrity.

Pre-Engineered Water Mist Systems are those systems that have predetermined pipe and tube sizes, maximum and minimum pipe lengths, number of fittings and numbers and types of nozzles, nozzle pressures, atomizing media, and water storage quantities and that do not require additional hydraulic calculations.

A Total Compartment Application Water Mist System is a deluge water mist system that provides complete protection of an enclosure or space by the simultaneous operation of all nozzles in the space by manual or automatic means.

A Wet Pipe Water Mist System is a water mist system using automatic nozzles attached to a piping system containing water and connected to a water supply so that water discharges immediately from nozzles operated by the heat from a fire.

Wet pipe systems shall employ automatic nozzles attached to a piping network pressurized with water up to the nozzles.

A Water Mist Nozzle is defined as a special purpose device, containing one or more orifices, designed to produce and deliver a water spray meeting either the definition of water mist or meeting the specific requirements of an approved water mist fire test protocol. Automatic Water Mist Nozzles are nozzles that operate independently of other nozzles by means of a detection/activation device built into the nozzle. Multi-functional Water Mist Nozzles are nozzles capable of operation using both automatic and no automatic means.

As indicated in the table of FIG. 3B, a High Pressure Water Mist System under the NFPA 750 Standard is a water mist system where the distribution system piping is exposed to pressures of 34.5 bar (500 psi) or greater. An Intermediate Pressure System is a water mist system where the distribution system piping is exposed to pressures greater than 12.1 bar (175 psi) but less than 34.5 bar (500 psi). And a Low Pressure System is a water mist system where the distribution piping is exposed to pressures of 12.1 bar (175 psi) or less.

A Propellant is a compressed gas used as a prime mover to push water out of storage vessels, through pipe networks, or through distribution components. Water Mist, Atomizing Media is compressed air or other gases that produce water mist by mechanical mixing with water.

Under the NFPA 750 Standard, water mist systems are classified by two media system types: (1) single-fluid or single media, as illustrated in FIG. 4; and (2) twin-fluid or dual-media as illustrated in FIGS. 5A and 5B.

While water mist systems have numerous applications, the NFPA 750 Standard recommends that water mist systems shall not be used for direct application to materials that react with water to produce violent reactions, or significant amounts of hazardous products. Such materials include the following:

(1) Reactive metals, such as lithium, sodium, potassium, magnesium, titanium, zirconium, uranium, and plutonium;

(2) Metal alkoxides, such as sodium methoxide;

(3) Metal amides, such as sodium amide;

(4) Carbides, such as calcium carbide;

(5) Halides, such as benzoyl chloride and aluminum chloride;

(6) Hydrides, such as lithium aluminum hydride;

(7) Oxyhalides, such as phosphorus oxybromide;

(8) Silanes, such as trichloromethylsilane;

(9) Sulfides, such as phosphorus pentasulfide; and

(10) Cyanates, such as methylisocyanate.

Also, under the NFPA 750 Standard, water mist systems shall not be used for direct application to liquefied gases at cryogenic temperatures (such as liquefied natural gas), which boil violently when heated by water. The NFPA 750 Standards defines that occupancy classifications shall relate to water mist system design, installation, and water supply requirements only, as designated for the occupancies by their listing. Light hazard occupancies shall be defined as occupancies or portions of other occupancies where the quantity and/or combustibility of contents is low, and fires with relatively low rates of heat release are expected.

Specific applications include hazards and conditions similar to the following:

(1) Machinery spaces;

(2) Combustion turbines;

(3) Wet benches and other similar processing equipment;

(4) Local application;

(5) Industrial oil cookers;

(6) Computer room raised floors;

(7) Chemical fume hoods; and

(8) Continuous wood board presses.

As disclosed in “Water-Based Fire-Extinguishing Agents by Dr. Anthony E. Finnerty, U.S. Army Research Laboratory, Aberdeen Proving Ground, Md. (1995), it is well known that the fire suppression efficiency of water mist systems can be improved to be more effective against hydrocarbon fires (e.g. JP-8 Jet Fuel) by adding additive agents into water solutions, such as 60% of potassium acetate in water, and 40% solution of potassium carbonate in water. However, while adding dissolved salts in water are known to lower the mass evaporation rate of the resulting aqueous solution, the chemical suppression action of the dissolved salts in water mist droplets are often not fully utilized because of the difficulty in delivering water mist droplets into the plume of a flame, as discussed in the 1997 paper entitled “Evaporation of A Small Water Droplet Containing An Additive”, by Michelle D. King, et al, published in Proceedings of the ASME National Heat Transfer Conference, Baltimore, Md., 1997.

While prior art water mist fire suppression systems represent a significant and important advancement in the art of fighting fire with water as a fire suppressing medium, conventional water mist fire suppression systems and methods are still in need of significant improvement to provide better fire protection and suppression with reduced water consumption, water damage, and smoke development.

Therefore, there is a great need for new and improved methods of and apparatus for suppressing and extinguishing fires and providing improved defense and protection to life and property alike, while overcoming the shortcomings and drawbacks of prior art methods and apparatus.

### OBJECTS AND SUMMARY OF THE PRESENT INVENTION

Accordingly, a primary object of the present is to provide a new and improved clean-chemistry water mist fire suppression system adapted for use in diverse applications where property and life require protection against fire.

Another object of the present invention is to provide a new and improved method of suppressing a detected fire using cloud of microscopic droplets generated from a supply of environmentally-clean water-based free-radical chemical-reaction interrupting liquid (i.e. water-based solution), while minimizing water damage, smoke development, and risk of fire re-ignition.

Another object of the present invention is to provide such a new and improved method of and apparatus for automatically suppressing a detected fire in a building, vessel or vehicle, using a cloud of microscopic droplets generated from a supply of environmentally-clean water-based free-radical chemical-reaction interrupting liquid, whereby the droplets are vaporized by heat energy from the fire, instantly cooling the fire and displacing oxygen, while the micro-droplets in the water-based chemical vapor contain dissolved ions (i.e. electrically-charged atoms or molecules) supplying free-electrons that pair with and stabilize the free-radicals before any other molecules in the combustion phase can do so to sustain the chemical-reactions (i.e. free-electrons that reduce and stabilize the free-radicals before rapidly-oxidizing molecules within the combustion phase of the fire to sustain the chemical-reactions), and thereby quickly suppress and extinguish the fire.

Another object of the present invention is a single-fluid (i.e. signal media) building fire suppression system using clean-chemistry free-radical chemical-reaction interrupting water-misting, wherein the system comprises a plurality of liquid misting heads mounted in a room space and connected to a section control valve that is connected to a main control valve, where the main control valve is connected to a hydraulic fluid pump unit that pumps into the misting nozzles at a either (i) environmentally-clean water-based free-radical chemical-reaction interrupting liquid supplied from a clean-chemistry liquid storage/buffer tank via a feed fluid pump controlled by a system controller when a fire or extreme source of heat energy is automatically detected within the room or space by one or more automatic fire detectors in the building section, or (ii) filtered water supplied from the water storage/buffer tank if and when the supply of water-based free-radical chemical-reaction interrupting liquid falls below a predetermined threshold level, while the automatic fire detector still detects predetermined conditions of fire and/or smoke in the building section, so that the system continues to produce fine fog-like water mist in the building section and extinguish the fire, while the system controller automatically controls a solenoid control valve controlling the clean-chemistry water-based free-radical chemical reaction liquid and a solenoid control valve controlling the supply of water from the main water supply, as required by the operational requirements of the system.

Another object of the present invention is to provide a novel method of producing a new and improved clean-chemistry free-radical chemical reaction interrupting water-based misting cloud from the misting orifices formed in a nozzle head hydraulically driven with a clean-chemistry water-based free-radical chemical reaction interrupting liquid, and filling a room or space in which the detected fire exists with dispensed clean-chemical water mist of the present invention, consisting of microscopic clean-chemistry water droplets which evaporate when contacting the fire, causing rapid cooling and vapor expansion and oxygen displacement, and the chemical vapor interrupting the free-radical chemical reactions within the combustion phase of the fire, thereby suppressing or extinguishing the fire and reducing smoke development and preventing re-ignition of fire.

Another object of the present invention is to provide a novel method of suppressing a fire in a building, vessel or vehicle using the clean-chemistry water-based free-radical chemical-reaction interrupting cloud, so as to rapidly suppress and extinguish fire with less water, smoke development and risk of re-ignition, wherein (a) the presence of a fire in a building, vessel or vehicle is automatically detected by a clean-chemistry water-based misting fire suppression system supporting automatic fire detectors, (b) environmentally-clean water-based free-radical chemical-reaction interrupting liquid is supplied to one or more misting nozzles with tiny openings under low, intermediate or high hydraulic pressure, thereby forming a cloud of fine fog-like mist comprising billions of microscopic droplets, (c) when the water-based free-radical chemical-reaction interrupting droplets approach a burning fire, the water-based free-radical chemical-reaction interrupting droplets flash evaporate around the fire and rapidly expands near the burning fire, changing from a liquid to a gas, causing fire to cool, and displacing oxygen, and (d) the water-based free-radical chemical-reaction vapor interrupting the free-radical chemical reactions within the combustion phase of the fire, thereby suppressing or extinguishing the fire and reducing smoke development and preventing re-ignition of fire.

Another object of the present invention is to provide method of suppressing a fire in a building, vessel or vehicle using multiple sources of water-based fire suppressing agents supplied to electronically-controlled misting apparatus, wherein (a) the presence of a fire in a building, vessel or vehicle is automatically detected by a clean-chemistry water-based misting fire suppression system supporting automatic fire detectors, (b) environmentally-clean water-based free-radical chemical-reaction interrupting liquid is supplied to one or more misting nozzles with tiny openings under hydraulic pressure, thereby forming a cloud of fine fog-like mist comprising billions of microscopic droplets, (c) when the water-based free-radical chemical-reaction interrupting droplets approach a burning fire, the droplets flash evaporate around the fire and rapidly expands near the burning fire, changing from a liquid to a gas, causing fire to cool, and displacing oxygen, (d) the water-based free-radical chemical-reaction vapor interrupting the free-radical chemical-reactions within the combustion phase of the fire, thereby suppressing or extinguishing the fire and reducing smoke development and preventing re-ignition of fire, and (e) if the supply of water-based clean-chemistry free-radical chemical-reaction interrupting liquid falls below a threshold level, while automatic fire detector still detect predetermined conditions of fire and smoke, then the system controller automatically switches the misting supply to water and continues to produce fine fog-like water mist in the building to extinguish the detected fire.

Another object of the present invention is to provide a new and improved fire suppression system using clean free-radical chemical reaction interrupting water-misting, wherein the system comprises a plurality of atomizing-type liquid misting heads (i.e. nozzles) supplied with clean water-based free-radical chemical reaction interrupting liquid and a pressurized supply of atomizing media (e.g. insert gas such as pressurized air or N2) mounted in a room space and connected to a section control valve that is connected to a main control valve, where the main control valve is connected to a hydraulic fluid pump unit that pumps into the misting nozzles either (i) environmentally-clean water-based free-radical chemical-reaction interrupting liquid supplied from a clean-chemistry liquid storage/buffer tank via a feed fluid pump controlled by a system controller, along with a pressurized atomizing media when a fire or extreme source of heat energy is automatically detected within the room or space by one or more electronic fire/smoke sensors in the section, or (ii) filtered water supplied from the water storage/buffer tank, along with a pressurized atomizing media if and when the supply of water-based free-radical chemical-reaction interrupting liquid falls below a predetermined threshold level, while the electronic fire/smoke sensors still detect predetermined conditions of fire and/or smoke in the section, so that the system continues to produce fine fog-like water mist in the section and extinguish the fire, while the programmed system controller automatically controls a solenoid control valve controlling the clean-chemistry water-based free-radical chemical reaction liquid, and pressurized atomizing media and a solenoid control valve controlling the supply of water from the main water supply, as required by the programming of the system controller.

Another object of the present invention is to provide a new and improved method of producing a clean-chemistry free-radical chemical reaction interrupting water-based misting cloud from misting orifices formed in the atomizing-type nozzle head, supplied with both water-based free-radical chemical reaction interrupting liquid and pressurized atomizing media (e.g. pressurized air or N2) and filling a room or space therewith, and in which the detected fire exists with dispensed clean-chemical water mist of the present invention, consisting of microscopic clean-chemistry water droplets which evaporate when contacting the fire, causing rapid cooling and vapor expansion and oxygen displacement, and the chemical vapor interrupting the free-radical chemical reactions within the combustion phase of the fire, thereby suppressing or extinguishing the fire and reducing smoke development and preventing re-ignition of fire.

Another object of the present invention is to provide a new and improved method of suppressing a fire in a building, vessel or vehicle using the clean-chemistry water-based free-radical chemical-reaction interrupting cloud, so as to rapidly suppress and extinguish fire with less water, smoke development and risk of re-ignition, wherein (a) the presence of a fire in a building, vessel or vehicle is automatically detected by a clean-chemistry water-based misting fire suppression system provided with provided with a supply of environmentally-clean free-radical chemical reaction interrupting liquid, (b) environmentally-clean water-based free-radical chemical-reaction interrupting liquid is supplied to one or more misting nozzles with tiny openings under hydraulic pressure, thereby forming a cloud of fine fog-like mist comprising billions of microscopic droplets, (c) when the water-based free-radical chemical-reaction droplets approach a burning fire, the droplets flash evaporate around the fire and rapidly expands near the burning fire, changing from a liquid to a gas, causing fire to cool, and displacing oxygen, and (d) the water-based free-radical chemical-reaction vapor interrupting the free-radical chemical reactions within the combustion phase of the fire, thereby suppressing or extinguishing the fire and reducing smoke development and preventing re-ignition of fire.

Another object of the present invention is to provide a new and improved method of suppressing a fire in a building, vessel or vehicle using multiple sources of water-based fire suppressing agents supplied to electronically-controlled misting apparatus, wherein (a) the presence of a fire in a building, vessel or vehicle is automatically detected by a clean-chemistry water-based misting fire suppression system with a supply of environmentally-clean free-radical chemical-reaction interrupting liquid, (b) environmentally-clean water-based free-radical chemical-reaction interrupting liquid is supplied to one or more misting nozzles with tiny openings under high hydraulic pressure, thereby forming a cloud of fine fog-like mist comprising billions of microscopic droplets, (c) when the water-based free-radical chemical-reaction droplets approach a burning fire, the droplets flash evaporate around the fire and rapidly expands near the burning fire, changing from a liquid to a gas, causing fire to cool, and displacing oxygen, (d) the water-based free-radical chemical-reaction vapor interrupting the free-radical chemical reactions within the combustion phase of the fire, thereby suppressing or extinguishing the fire and reducing smoke development and preventing re-ignition of fire, and (e) if the supply of water-based anti-fire liquid falls below a threshold level, while automatic fire detectors still detect predetermined conditions of fire and smoke, then the system controller automatically switches the misting supply to water and continues to produce fine fog-like water mist in the building to extinguish the detected fire.

Another object of the present invention is to provide a portable clean-chemistry free-radical chemical-reaction interrupting water misting fire extinguisher according to the present invention comprising a liquid storage tank containing an environmentally-clean water-based free-radical chemical-reaction interrupting liquid, charged with air-pressure from a small pressurized air tank integrated with the housing, and having a hand-activated gun-style misting for discharging clean-chemistry water-based free-radical chemical-reaction interrupting mist clouds from the nozzle onto a fire for quick suppression and extinguishment.

Another object of the present invention is to provide a wireless network for monitoring fire suppression systems employing the electronically-controlled misting of environmentally-clean water-based free-radical chemical-reaction interrupting liquid, sprayed in the vicinity of an automatically-detected fire, including supplying environmentally-clean water-based free-radical chemical-reaction interrupting liquid (and atomizing media) to the fire suppression systems.

Another object of the present invention is to provide a high-rise building in which one or more of the fire suppression systems are installed and commissioned, for automatically generating clean-chemistry water-based free-radical chemical-reaction interrupting mist within designated sections in the building to automatically suppress detected fire outbreaks.

Another object of the present invention is to provide a school building in which one or more of the fire suppression systems are installed and commissioned, for automatically generating clean-chemistry water-based free-radical chemical-reaction interrupting mist within designated sections in the building to automatically suppress detected fire outbreaks.

Another object of the present invention is to provide one or more of the fire suppression systems are installed and commissioned, for automatically generating clean-chemistry water-based free-radical chemical-reaction interrupting mist within designated spaces in the cargo vessel to automatically suppress detected fire outbreaks.

Another object of the present invention is to provide an armored tank vehicle in which one or more of the fire suppression systems are installed and commissioned, for automatically generating clean-chemistry water-based free-radical chemical-reaction interrupting mist within designated spaces in the vehicle to automatically suppress detected fire outbreaks.

Another object of the present invention is to provide a cargo hold space on a jet aircraft in which one or more of the fire suppression systems are installed and commissioned, for automatically generating clean-chemistry water-based free-radical chemical-reaction interrupting mist within designated spaces in the jet aircraft to automatically suppress detected fire outbreaks.

Another object of the present invention is to provide a school bus vehicle in which one or more of the fire suppression systems are installed and commissioned, for automatically generating clean-chemistry water-based free-radical chemical-reaction interrupting mist within designated spaces in the school bus vehicle to automatically suppress detected fire outbreaks.

Another object of the present invention is to provide an ISO shipping container in which one or more of the fire suppression systems are installed and commissioned, for automatically generating clean-chemistry water-based free-radical chemical-reaction interrupting mist within designated space of the ISO shipping container to automatically suppress detected fire outbreak.

Another object of the present invention is to provide a passenger ship vessel in which one or more of the fire suppression systems are installed and commissioned, for automatically generating clean-chemistry water-based free-radical chemical-reaction interrupting mist within designated spaces in the passenger ship vessel to automatically suppress detected fire outbreaks.

Another object of the present invention is to provide automotive vehicle and roadway tunnel in which one or more of the fire suppression systems are installed and commissioned, for automatically generating clean-chemistry water-based free-radical chemical-reaction interrupting mist within designated spaces inside the tunnel to automatically suppress detected fire outbreaks.

Another object of the present invention is to provide an airport terminal in which one or more of the fire suppression systems are installed and commissioned, for automatically generating clean-chemistry water-based free-radical chemical-reaction interrupting mist within designated spaces in the airport terminal to automatically suppress detected fire outbreaks.

Another object of the present invention is to provide a train tunnel in which one or more of the fire suppression systems are installed and commissioned, for automatically generating clean-chemistry water-based free-radical chemical-reaction interrupting mist within designated spaces in the train tunnel to automatically suppress detected fire outbreaks.

Another object of the present invention is to provide a yacht vessel in which one or more of the fire suppression systems are installed and commissioned, for automatically generating clean-chemistry water-based free-radical chemical-reaction interrupting mist within designated spaces in the yacht vessel to automatically suppress detected fire outbreaks.

Another object of the present invention is to provide an ocean-based oil and/or gas drilling and processing platform in which one or more of the fire suppression systems are installed and commissioned, for automatically generating clean-chemistry water-based free-radical chemical-reaction interrupting mist within designated spaces in the oil and/or gas drilling platform to automatically suppress detected fire outbreaks.

Another object of the present invention is to provide a tractor and trailer vehicle in which one or more of the fire suppression systems are installed and commissioned, for automatically generating clean-chemistry water-based free-radical chemical-reaction interrupting mist within designated spaces in the tractor and trailer vehicle to automatically suppress detected fire outbreaks.

Another object of the present invention is to provide a space-station, in which one or more of the fire suppression systems are installed and commissioned, for automatically generating clean-chemistry water-based free-radical chemical-reaction interrupting mist within designated spaces in the space-station to automatically suppress detected fire outbreaks.

Another object of the present invention is to provide a pre-fabricated modular home, in which one or more of the fire suppression systems are installed and commissioned, for automatically generating clean-chemistry water-based free-radical chemical-reaction interrupting mist within designated spaces in the modular home to automatically suppress detected fire outbreaks.

Another object of the present invention is to provide a new and improved system for automatically generate electronic refill orders, so that a third-party service can automatically replenish the tanks with clean chemistry free-radical chemical-reaction interrupting liquid when the fluid level falls below a certain level in the supply tank.

These and other benefits and advantages to be gained by using the features of the present invention will become more apparent hereinafter and in the appended Claims to Invention.

### BRIEF DESCRIPTION OF THE DRAWINGS

The following Objects of the Present Invention will become more fully understood when read in conjunction of the Detailed Description of the Illustrative Embodiments, and the appended Drawings, wherein:

FIG. 1 is a schematic representation of a conventional high-rise infrastructure with fire sprinkler retrofit system showing an existing high-rise infrastructure and a fire sprinkler system to be retrofitted into the high-rise infrastructure;

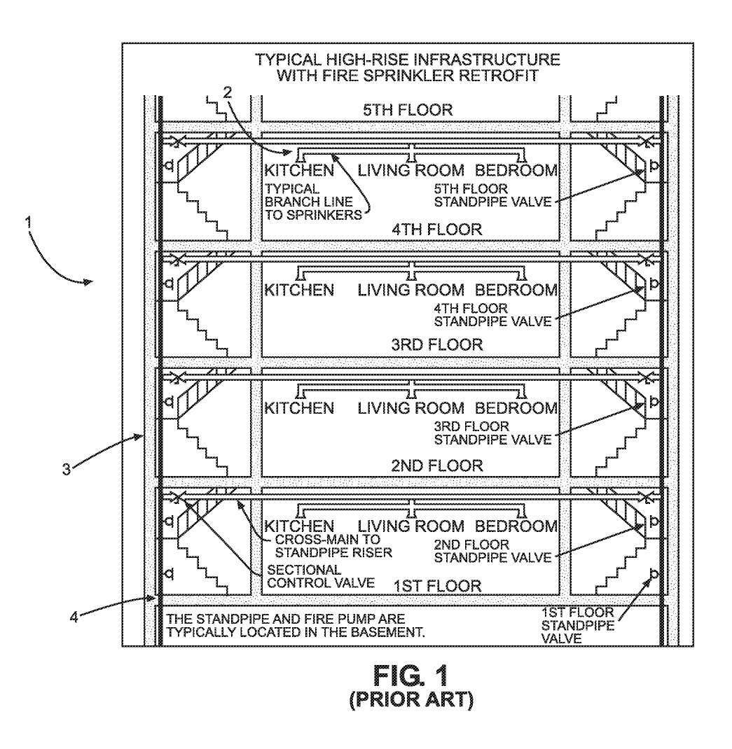

FIG. 2 is a schematic representation of a high-rise building showing two different kinds of conventional sprinkler systems installed in the building, namely (i) a wet-type sprinkler system for frost-free rooms (i.e. ambient temperature above 0 degrees Celsius) supplied with water from an interim tank supplied by municipal water supply, and driven by a sprinkler pump connected to the interim tank via a suction line, and (ii) a dry-type sprinkler system for rooms exposed to frost (i.e. ambient temperature less than 0 degrees Celsius) supplied by a compressed water tank drive by a compressor and water tank fill pump;

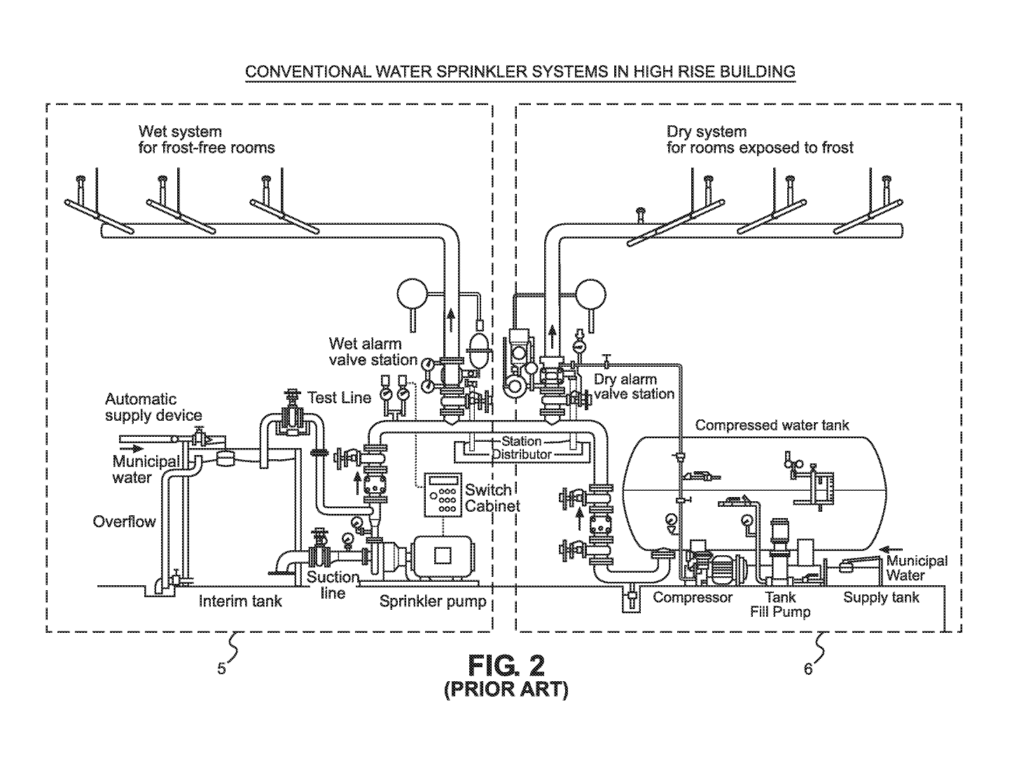

FIG. 3A is a schematic representation illustrating the water droplet diameter range for fire fighting, showing the size of water mist droplets relative to rain, clouds, sea fog, oil fog and smoke;

FIG. 3B is table organized by the three classes of water mist fire suppression under NFPA 750 Standard (2015 Edition), namely (i) Low Pressure Systems with distribution piping systems exposed to pressures less than 175 psi (12.1 bar), (ii) Intermediate Pressure Systems distribution piping exposed to pressure greater than 175 psi (12.1 bar) and less than 500 psi (34.5 bar), and (iii) High Pressure Systems distribution piping exposed to pressures in excess of 500 psi (34.5 bar), and exemplary commercial water mist systems classified under the NFPA 750 Standard On Water Mist Fire Protection Systems (2015 Edition) published by the NFPA, Quincy, Mass., USA;

FIG. 4 is a schematic representation of a conventional single-fluid hydraulically-pressurized water misting fire suppression system installed in a building with multiple building sections, wherein each building section has multiple misting heads mounted in the room space and connected to a section control valve that is connected to a main control valve, where the main control valve is connected to a hydraulic pump fed water from a water storage/buffer tank via a feed water pump controlled by a system controller, where the system controller is programmed to control a solenoid control valve controlling the supply of water from a main water supply into a water filter unit that feds the water storage tank;

FIG. 5A is a schematic diagram of a conventional twin-fluid pneumatically-pressurized water misting system for fire suppression, showing distilled water forced through piping by pressurized air stored in the water storage cylinders, and out of misting nozzles to produce a misting pattern that fills the room or space in which the detected fire exists for extinguishing the same using the dispensed water mist consisting of micro-water droplets which evaporate when in contact with the fire, causing rapid cooling and vapor expansion and oxygen displacement to help extinguish the fire;

FIG. 5B is a cross-sectional view of a nozzle used in the conventional twin-fluid pneumatically-pressurized water misting system for fire suppression shown in FIG. 5B, wherein water and pressurized air are simultaneously supplied to the pneumatically-atomizing water mist nozzle to produce fine water mist or fog for fire suppression;

FIG. 6 is a conventional handle-supportable twin-fluid type water misting fire extinguisher containing a supply of water charged with a source of pressurized air, for producing and directing water mist onto a fire so that the dispensed water mist, consisting of micro-water droplets, evaporates when making contact with the fire, causing rapid cooling, vapor expansion and oxygen displacement to help extinguish the fire;

FIG. 7 is a schematic representation of a single-fluid (i.e. signal media) building fire suppression system using clean-chemistry free-radical chemical-reaction interrupting water-misting of the present invention, wherein the system comprises a plurality of liquid misting heads mounted in a room space and connected to a section control valve that is connected to a main control valve, where the main control valve is connected to a hydraulic fluid pump unit that pumps into the misting nozzles at a either (i) environmentally-clean water-based free-radical chemical-reaction interrupting liquid supplied from a clean-chemistry liquid storage/buffer tank via a feed fluid pump controlled by a system controller when a fire or extreme source of heat energy is automatically detected within the room or space by one or more automatic fire detectors in the building section, or (ii) filtered water supplied from the water storage/buffer tank if and when the supply of water-based free-radical chemical-reaction interrupting liquid falls below a predetermined threshold level, while the automatic fire detector still detect predetermined conditions of fire and/or smoke in the building section, so that the system continues to produce fine fog-like water mist in the building section and extinguish the fire, while the system controller automatically controls a solenoid control valve controlling the clean-chemistry water-based free-radical chemical reaction liquid and a solenoid control valve controlling the supply of water from the main water supply, as required by the operational requirements of the system;

FIG. 8A is a graphical illustration of an exemplary water misting nozzle from the fire suppression system of the present invention represented in FIG. 7, showing an exemplary clean-chemistry free-radical chemical reaction interrupting water-based misting cloud produced from its multiple misting orifices formed in the nozzle head, and filling a room or space in which the detected fire exists with dispensed clean-chemical water mist of the present invention, consisting of microscopic clean-chemistry water droplets which evaporate when contacting the fire, causing rapid cooling and vapor expansion and oxygen displacement, and the chemical vapor interrupting the free-radical chemical reactions within the combustion phase of the fire, thereby suppressing or extinguishing the fire and reducing smoke development and preventing re-ignition of fire;

FIG. 8B is a graphical illustration of a set of exemplary water misting nozzles from the fire suppression system of the present invention represented in FIGS. 7 and 8A, showing an exemplary clean-chemistry free-radical chemical reaction interrupting water-based misting clouds produced from its multiple misting nozzles, and filling a room or space in which the detected fire exists with dispensed clean-chemical water mist of the present invention, consisting of microscopic clean-chemistry water droplets which evaporate when contacting the fire, causing rapid cooling and vapor expansion and oxygen displacement, and the chemical vapor interrupting the free-radical chemical reactions within the combustion phase of the fire, thereby suppressing or extinguishing;

FIG. 9 is a flow chart describing the method of suppressing a fire in a building, vessel or vehicle using the clean-chemistry water-based free-radical chemical-reaction interrupting cloud of the present invention, to rapidly suppress and extinguish fire with less water, smoke development and risk of re-ignition, in accordance with the principles of the present invention illustrated in FIGS. 7, 8A and 8B, wherein (a) the presence of a fire in a building, vessel or vehicle is automatically detected by a clean-chemistry water-based misting fire suppression system supporting automatic fire detectors, (b) environmentally-clean water-based free-radical chemical-reaction interrupting liquid is supplied to one or more misting nozzles with tiny openings under low, intermediate or high hydraulic pressure, thereby forming a cloud of fine fog-like mist comprising billions of microscopic droplets, (c) when the water-based free-radical chemical-reaction interrupting droplets approach a burning fire, the water-based free-radical chemical-reaction interrupting droplets flash evaporate around the fire and rapidly expands near the burning fire, changing from a liquid to a gas, causing fire to cool, and displacing oxygen, and (d) the water-based free-radical chemical-reaction vapor interrupting the free-radical chemical reactions within the combustion phase of the fire, thereby suppressing or extinguishing the fire and reducing smoke development and preventing re-ignition of fire;

FIG. 10 is a flow chart describing the method of suppressing a fire in a building, vessel or vehicle using multiple sources of water-based fire suppressing agents supplied to electronically-controlled misting apparatus of the present invention illustrated in FIGS. 7, 8A and 8B, wherein (a) the presence of a fire in a building, vessel or vehicle is automatically detected by a clean-chemistry water-based misting fire suppression system supporting automatic fire detectors, (b) environmentally-clean water-based free-radical chemical-reaction interrupting liquid is supplied to one or more misting nozzles with tiny openings under hydraulic pressure, thereby forming a cloud of fine fog-like mist comprising billions of microscopic droplets, (c) when the water-based free-radical chemical-reaction interrupting droplets approach a burning fire, the droplets flash evaporate around the fire and rapidly expands near the burning fire, changing from a liquid to a gas, causing fire to cool, and displacing oxygen, (d) the water-based free-radical chemical-reaction vapor interrupting the free-radical chemical-reactions within the combustion phase of the fire, thereby suppressing or extinguishing the fire and reducing smoke development and preventing re-ignition of fire, and (e) if the supply of water-based clean-chemistry free-radical chemical-reaction interrupting liquid falls below a threshold level, while automatic fire detector still detect predetermined conditions of fire and smoke, then the system controller automatically switches the misting supply to water and continues to produce fine fog-like water mist in the building to extinguish the detected fire;

FIG. 11 is a schematic representation of a fire suppression system using clean free-radical chemical reaction interrupting water-misting of the present invention, wherein the system comprises a plurality of atomizing-type liquid misting heads (i.e. nozzles) supplied with clean water-based free-radical chemical reaction interrupting liquid and a pressurized supply of atomizing media (e.g. insert gas such as pressurized air or N2) mounted in a room space and connected to a section control valve that is connected to a main control valve, where the main control valve is connected to a hydraulic fluid pump unit that pumps into the misting nozzles either (i) environmentally-clean water-based free-radical chemical-reaction interrupting liquid supplied from a clean-chemistry liquid storage/buffer tank via a feed fluid pump controlled by a system controller, along with a pressurized atomizing media (e.g. insert gas, such as pressurized air or N2) when a fire or extreme source of heat energy is automatically detected within the room or space by one or more automatic fire detectors in the section, or (ii) filtered water supplied from the water storage/buffer tank, along with a pressurized atomizing media (e.g. insert gas, such as pressurized air or N2) if and when the supply of water-based free-radical chemical-reaction interrupting liquid falls below a predetermined threshold level, while the automatic fire detectors still detect predetermined conditions of fire and/or smoke in the section, so that the system continues to produce fine fog-like water mist in the section and extinguish the fire, while the programmed system controller automatically controls a solenoid control valve controlling the clean-chemistry water-based free-radical chemical reaction liquid, and pressurized atomizing media (e.g. pressurized air or N2) and a solenoid control valve controlling the supply of water from the main water supply, as required by the programming of the system controller;

FIG. 12A is a graphical illustration of an exemplary water misting nozzle from the fire suppression system of the present invention represented in FIG. 11, showing an exemplary clean-chemistry free-radical chemical reaction interrupting water-based misting cloud produced from its multiple misting orifices formed in the atomizing-type nozzle head, supplied with both water-based free-radical chemical reaction interrupting liquid and pressurized atomizing media (e.g. pressurized air or N2) and filling a room or space therewith, and in which the detected fire exists with dispensed clean-chemical water mist of the present invention, consisting of microscopic clean-chemistry water droplets which evaporate when contacting the fire, causing rapid cooling and vapor expansion and oxygen displacement, and the chemical vapor interrupting the free-radical chemical reactions within the combustion phase of the fire, thereby suppressing or extinguishing the fire and reducing smoke development and preventing re-ignition of fire;

FIG. 12B is a graphical illustration of a set of exemplary water misting nozzles from the fire suppression system of the present invention represented in FIGS. 11 and 12A, showing an exemplary clean-chemistry free-radical chemical reaction interrupting water-based misting clouds produced from its multiple misting nozzles, and filling a room or space in which the detected fire exists with dispensed clean-chemical water mist of the present invention, consisting of microscopic clean-chemistry water droplets which evaporate when contacting the fire, causing rapid cooling and vapor expansion and oxygen displacement, and the chemical vapor interrupting the free-radical chemical reactions within the combustion phase of the fire, thereby suppressing or extinguishing;

FIG. 13 is a flow chart describing the method of suppressing a fire in a building, vessel or vehicle using the clean-chemistry water-based free-radical chemical-reaction interrupting cloud of the present invention, to rapidly suppress and extinguish fire with less water, smoke development and risk of re-ignition, in accordance with the principles of the present invention illustrated in FIGS. 11, 12A and 12B, wherein (a) the presence of a fire in a building, vessel or vehicle is automatically detected by a clean-chemistry water-based misting fire suppression system provided with provided with a supply of environmentally-clean free-radical chemical reaction interrupting liquid, (b) environmentally-clean water-based free-radical chemical-reaction interrupting liquid is supplied to one or more misting nozzles with tiny openings under hydraulic pressure, thereby forming a cloud of fine fog-like mist comprising billions of microscopic droplets, (c) when the water-based free-radical chemical-reaction droplets approach a burning fire, the droplets flash evaporate around the fire and rapidly expands near the burning fire, changing from a liquid to a gas, causing fire to cool, and displacing oxygen, and (d) the water-based free-radical chemical-reaction vapor interrupting the free-radical chemical reactions within the combustion phase of the fire, thereby suppressing or extinguishing the fire and reducing smoke development and preventing re-ignition of fire;

FIG. 14 is a flow chart describing the method of suppressing a fire in a building, vessel or vehicle using multiple sources of water-based fire suppressing agents supplied to electronically-controlled misting apparatus of the present invention illustrated in FIGS. 11, 12A and 12B, wherein (a) the presence of a fire in a building, vessel or vehicle is automatically detected by a clean-chemistry water-based misting fire suppression system with a supply of environmentally-clean free-radical chemical-reaction interrupting liquid, (b) environmentally-clean water-based free-radical chemical-reaction interrupting liquid is supplied to one or more misting nozzles with tiny openings under high hydraulic pressure, thereby forming a cloud of fine fog-like mist comprising billions of microscopic droplets, (c) when the water-based free-radical chemical-reaction droplets approach a burning fire, the droplets flash evaporate around the fire and rapidly expands near the burning fire, changing from a liquid to a gas, causing fire to cool, and displacing oxygen, (d) the water-based free-radical chemical-reaction vapor interrupting the free-radical chemical reactions within the combustion phase of the fire, thereby suppressing or extinguishing the fire and reducing smoke development and preventing re-ignition of fire, and (e) if the supply of water-based anti-fire liquid falls below a threshold level, while automatic fire detectors still detect predetermined conditions of fire and smoke, then the system controller automatically switches the misting supply to water and continues to produce fine fog-like water mist in the building to extinguish the detected fire;

FIG. 15 is a perspective view of a portable clean-chemistry free-radical chemical-reaction interrupting water misting fire extinguisher according to the present invention comprising a liquid storage tank containing an environmentally-clean water-based free-radical chemical-reaction interrupting liquid, charged with air-pressure from a small pressurized air tank integrated with the housing, and having a hand-activated gun-style misting for discharging clean-chemistry water-based free-radical chemical-reaction interrupting mist clouds from the nozzle onto a fire for quick suppression and extinguishment;

FIG. 16 is a schematic representation of a wireless network for monitoring fire suppression systems of the present invention illustrated in FIGS. 7 through 15 employing the electronically-controlled misting of environmentally-clean water-based free-radical chemical-reaction interrupting (ECFRCRI) liquid, sprayed in the vicinity of an automatically-detected fire, including supplying environmentally-clean water-based free-radical chemical-reaction interrupting (ECFRCRI) liquid (and atomizing media) to the fire suppression systems of the present invention to meet and support fire safety requirements of such deployed systems;

FIG. 17A is a perspective view of an exemplary mobile computing device deployed on the system network of the present invention;

FIG. 17B shows a system diagram for an exemplary mobile client computer system deployed on the system network of the present invention;

FIG. 17C is a graphical representation of a graphical user interface (GUI) of the mobile application supported on the mobile client computer system shown in FIG. 17B, showing the high level services support by the application;

FIG. 18 is a schematic representation of a high-rise building in which one or more of the fire suppression systems of the present invention shown in FIGS. 7 through 15 are installed and commissioned, for automatically generating clean-chemistry water-based free-radical chemical-reaction interrupting misting clouds within designated sections in the building to automatically suppress detected fire outbreaks in accordance with the principles of the present invention;

FIG. 19 is a schematic representation of an elementary school building in which one or more of the fire suppression systems of the present invention shown in FIGS. 7 through 15 are installed and commissioned, for automatically generating clean-chemistry water-based free-radical chemical-reaction interrupting misting clouds within designated sections in the building to automatically suppress detected fire outbreaks in accordance with the principles of the present invention;

FIG. 20 is a schematic representation of a cargo vessel in which one or more of the fire suppression systems of the present invention shown in FIGS. 7 through 15 are installed and commissioned, for automatically generating clean-chemistry water-based free-radical chemical-reaction interrupting misting clouds within designated spaces in the cargo vessel to automatically suppress detected fire outbreaks in accordance with the principles of the present invention;

FIG. 21 is a schematic representation of an armored tank vehicle in which one or more of the fire suppression systems of the present invention shown in FIGS. 7 through 15 are installed and commissioned, for automatically generating clean-chemistry water-based free-radical chemical-reaction interrupting misting clouds within designated spaces in the vehicle to automatically suppress detected fire outbreaks in accordance with the principles of the present invention;

FIG. 22 is a schematic representation of a cargo hold space on a jet aircraft in which one or more of the fire suppression systems of the present invention shown in FIGS. 7 through 15 are installed and commissioned, for automatically generating clean-chemistry water-based free-radical chemical-reaction interrupting misting clouds within designated spaces in the jet aircraft to automatically suppress detected fire outbreaks in accordance with the principles of the present invention;

FIG. 23 is a schematic representation of a school bus vehicle in which one or more of the fire suppression systems of the present invention shown in FIGS. 7 through 15 are installed and commissioned, for automatically generating clean-chemistry water-based free-radical chemical-reaction interrupting misting clouds within designated spaces in the school bus vehicle to automatically suppress detected fire outbreaks in accordance with the principles of the present invention;

FIG. 24 is a schematic representation of an ISO shipping container in which one or more of the fire suppression systems of the present invention shown in FIGS. 7 through 15 are installed and commissioned, for automatically generating clean-chemistry water-based free-radical chemical-reaction interrupting misting clouds within designated space of the ISO shipping container to automatically suppress detected fire outbreaks in accordance with the principles of the present invention;

FIG. 25 is a schematic representation of a passenger ship vessel in which one or more of the fire suppression systems of the present invention shown in FIGS. 7 through 15 are installed and commissioned, for automatically generating clean-chemistry water-based free-radical chemical-reaction interrupting misting clouds within designated spaces in the passenger ship vessel to automatically suppress detected fire outbreaks in accordance with the principles of the present invention;

FIG. 26 is a schematic representation of automotive vehicle and roadway tunnel in which one or more of the fire suppression systems of the present invention shown in FIGS. 7 through 15 are installed and commissioned, for automatically generating clean-chemistry water-based free-radical chemical-reaction interrupting misting clouds within designated spaces inside the tunnel to automatically suppress detected fire outbreaks in accordance with the principles of the present invention;

FIG. 27 is a schematic representation of an airport terminal in which one or more of the fire suppression systems of the present invention shown in FIGS. 7 through 14 are installed and commissioned, for automatically generating clean-chemistry water-based free-radical chemical-reaction interrupting misting clouds within designated spaces in the airport terminal to automatically suppress detected fire outbreaks in accordance with the principles of the present invention;

FIG. 28 is a schematic representation of a train tunnel in which one or more of the fire suppression systems of the present invention shown in FIGS. 7 through 15 are installed and commissioned, for automatically generating clean-chemistry water-based free-radical chemical-reaction interrupting misting clouds within designated spaces in the train tunnel to automatically suppress detected fire outbreaks in accordance with the principles of the present invention;

FIG. 29 is a schematic representation of a yacht vessel in which one or more of the fire suppression systems of the present invention shown in FIGS. 7 through 15 are installed and commissioned, for automatically generating clean-chemistry water-based free-radical chemical-reaction interrupting misting clouds within designated spaces in the yacht vessel to automatically suppress detected fire outbreaks in accordance with the principles of the present invention;

FIG. 30 is a schematic representation of an ocean-based oil and/or gas drilling and processing platform in which one or more of the fire suppression systems of the present invention shown in FIGS. 7 through 15 are installed and commissioned, for automatically generating clean-chemistry water-based free-radical chemical-reaction interrupting misting clouds within designated spaces in the oil and/or gas drilling platform to automatically suppress detected fire outbreaks in accordance with the principles of the present invention;

FIG. 31 is a schematic representation of a tractor and trailer vehicle in which one or more of the fire suppression systems of the present invention shown in FIGS. 7 through 15 are installed and commissioned, for automatically generating clean-chemistry water-based free-radical chemical-reaction interrupting misting clouds within designated spaces in the tractor and trailer vehicle to automatically suppress detected fire outbreaks in accordance with the principles of the present invention;

FIG. 32 is a schematic representation of a space-based station in which one or more of the fire suppression systems of the present invention shown in FIGS. 7 through 15 are installed and commissioned, for automatically generating clean-chemistry water-based free-radical chemical-reaction interrupting misting clouds within designated spaces in the space-based station to automatically suppress detected fire outbreaks in accordance with the principles of the present invention;

FIG. 33 is a schematic representation of a prefabricated home in which one or more of the fire suppression systems of the present invention shown in FIGS. 7 through 15 are installed and commissioned, for automatically generating clean-chemistry water-based free-radical chemical-reaction interrupting misting clouds within designated spaces in the prefabricated home to automatically suppress detected fire outbreaks in accordance with the principles of the present invention; and

FIG. 34 is a schematic representation of a prefabricated modular home in which one or more of the fire suppression systems of the present invention shown in FIGS. 7 through 15 are installed and commissioned, for automatically generating clean-chemistry water-based free-radical chemical-reaction interrupting misting clouds within designated spaces in the modular home to automatically suppress detected fire outbreaks in accordance with the principles of the present invention;

### DETAILED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

Specification of the Fire Suppression System of the First Illustrative Embodiment of the Present Invention Producing Water-Based Mist from an Environmentally-Clean Water-Based Free-Radical Chemical-Reaction Interrupting Liquid Using Hydraulically-Pressurized Misting Nozzles

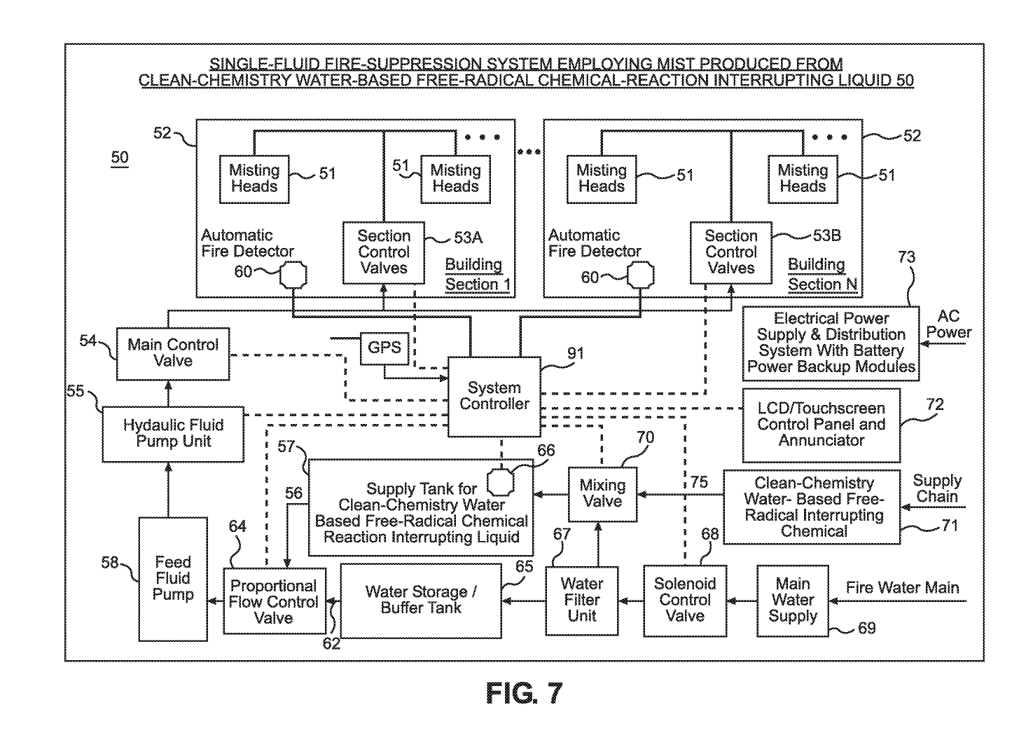

FIG. 7 show a fire suppression system 50 in accordance with the principles of the present invention designed and adapted to use environmentally-clean (i.e. clean-chemistry) water-based free-radical chemical-reaction interrupting (FRCRI) liquid (i.e. water-based solution) to produce a fire suppressing mist cloud having a clean chemistry that is characterized by the capacity to interrupt the free-radical chemical-reactions within the combustion phase of the fire being suppressed by the system. As used herein, within the combustion phase of a fire, there are molecule fragments of unpaired electrons that are highly reactive with oxygen to produce carbon dioxide, and sustain the chemical-reactions, converting fuels into combustion products, heat, and light. These unstable species, generated during the combustion phase of fire, are called “free-radicals” and exist as vapor during combustion phase of fire.

As shown in FIG. 7, the water mist fire suppression system 50 comprises: a plurality of low, intermediate or high hydraulic pressure driven liquid misting heads (i.e. spray nozzles) 51, each mounted in a space 52 to be protected from fire and smoke and connected to a section control valve 53A, 53B by way of piping, wherein each section control valve 52A, 53B is connected to a main control valve 54 via piping to a hydraulic/fluid pump unit 55 (e.g. fixed displacement pumps including gear pumps, Gerotor (generated rotor) pumps, and screw vane pumps, and variable displacement pumps including bent axis pumps, in-line axial piston pumps, radial piston pumps, rotary vane pumps, and diaphragm or membrane pumps) that pumps into the misting nozzles 51 and out their orifices, at low, intermediate or high pressure, either (i) environmentally-clean water-based free-radical chemical-reaction interrupting liquid 56 supplied from a clean-chemistry liquid storage/buffer tank 57 via a feed fluid pump 58 through proportional flow control valve 64 controlled by a system controller 59 when a fire or extreme source of heat energy is automatically detected by an automatic fire detector 60 within the room or space 52 by one or more automatic fire detectors 60 in the building section 52 so as to produce a fine clean-chemistry water-based free-radical chemical-reaction interrupting mist 61, or (ii) filtered water 62 supplied from the water storage/buffer tank 65 if and when the supply of water-based free-radical chemical-reaction interrupting liquid 56 falls below a predetermined threshold level (detected by liquid level sensor 66), while automatic fire detectors (e.g. fire/smoke sensors) as broadly understood under the NFPA 750 Standard still detect predetermined conditions of fire and/or smoke in the building section 52, so that the system controller (e.g. programmed microprocessor) 59 continues to produce fine fog-like water mist in the activated building section(s) 52 and suppress and extinguish the fire, while the programmed system controller 59 automatically controls the proportional flow control valve 64 controlling the clean-chemistry water-based free-radical chemical reaction liquid 56 and the solenoid control valve 68 controlling the supply of filtered water 68 from the main water supply 69, as required by the programming of the fire suppression system 50.

In the illustrative embodiment, the proportional flow control valve 64 will be electronically-controlled by the system controller 59, include one or more solenoids, and have the capacity to accurately measure and control the mass flow rates flowing into multiple (e.g. two) input ports provided on the proportional flow control valve 64, as well as its output mass flow rate, thereby enabling the desired precise proportioned blending of controlled input mass flows as required for the specific application at hand (e.g. in accordance with a required blending ratio C=A/B, where A and B are the mass flow inputs and C is the mass flow output). There are different ways to achieve the proportional flow control valve 64 used in system 50. For example, the device can realized as a single off-the-shelf integrated assembly, including solenoid flow rate control valves on each input port, flow rate sensors on each input port, flow rate control electronics and power supply inputs, all integrated in a single housing/package. This would be the preferred embodiment. Alternatively, two or more single input port mass flow control valves can integrated and provided with external controls to realize the mass flow control and blending required for the present invention, as described in great detail above. Numerous commercial proportional flow control valves are available from different manufacturers that can be readily adapted and configured for controlling the proportional blending of two mass flow rates (liquid 56 and water 68) in any proportion (e.g. ratio AB) with excellent results.

As shown in FIG. 7, the fire suppression system 50 further comprises: an electrical power supply and distribution system 73 with battery power backup modules; an LCD touch-screen or LCD panel with hard-keyboard annunciator panel 72 supporting controls and an interface for monitoring and commissioning the fire suppression system by authorized personnel. All of the mentioned system components described above in FIG. 7 are connected hydraulically using adequately sized piping made from stainless steel or copper tubing, and in some cases, advanced plastic piping such as CPVC piping capable of withstanding higher temperatures and pressures than conventional PVC piping. Engineers will look to local building codes when practicing the clean-chemistry water mist fire suppression systems of the present invention.

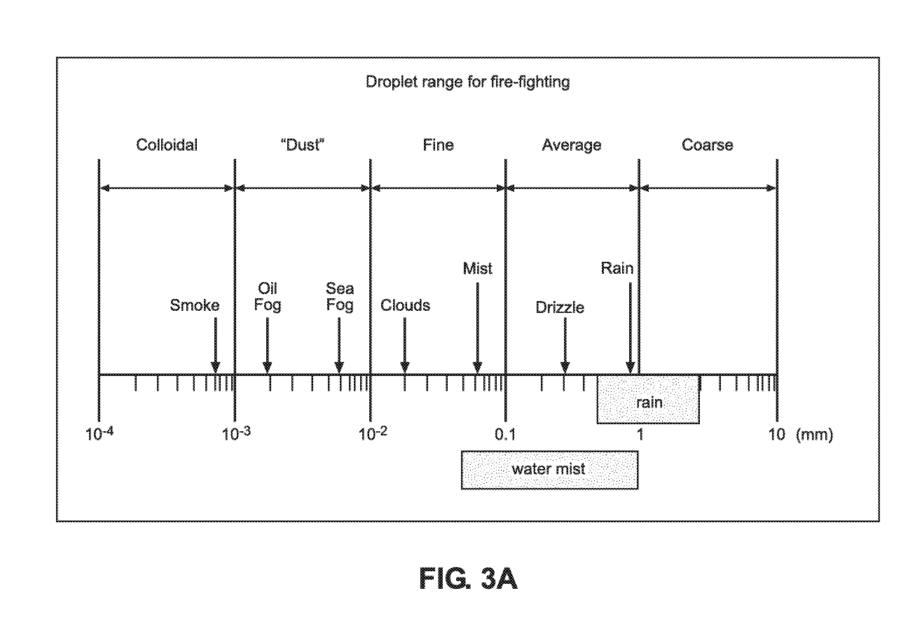

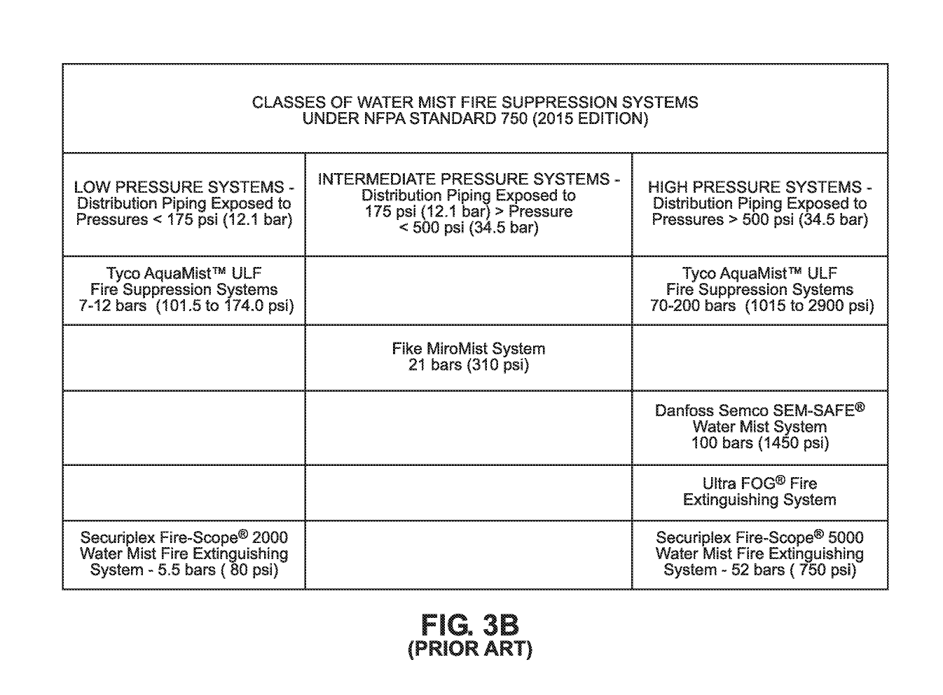

Notably, many of the components used in the clean-chemistry water mist system of the present invention shown in FIG. 7 can be found in the conventional water mist fire suppression systems such as, for example, those systems identified in FIG. 3B. Such components will include hydraulic pumps, section valves, control valves, automatic fire detectors, piping, hydraulic misting nozzles (spray heads), system controllers, and other system components that may be required when practicing any particular embodiment of the present invention. Also, those skilled in the art will understand the value in using conventional hydraulic fluid system modeling software to design the fire suppression system of the present invention so that adequate pressure is generated within the system to do the work necessary to hydraulically produce the clean-chemistry water mist, while achieving all other system design requirements.

In some embodiments of the present invention, a mixing valve 70 will be provided, and connected to the water filter unit 67 and a tank supplying clean-chemistry free-radical chemical-reaction chemical concentrate 75 (provided from a supply chain) for mixing clean water-based free-radical chemical-reaction interrupting liquid 56 for storage in the supply tank 56 which typically will have a capacity to store sufficient liquid to flood the entire cubic space being protected by the fire suppression system. Preferably, the clean-chemistry free-radical chemical-reaction interrupting concentrate 75 in tank 71 will be supplied in liquid form for ease of mixing with water at mixing valve 70. However, less preferred, the fire suppression additive agent can be provided in dry form as well, and mixed with water supplied from the water filter unit 67.

Preferably, the clean water-based free-radical chemical-reaction interrupting liquid 56 is realized using Hartindo AF31 Total Fire Inhibitor chemical liquid, developed by Hartindo Chemicatama Industri of Jakarta, Indonesia, and commercially available from Newstar Chemicals (M) SDN BHD of Selangor Darul Ehsan, Malaysia, http://newstarchemicals.com/products.html. Hartindo AF31 Total Fire Inhibitor chemical liquid has the required free-radical chemical reaction interrupting chemistry of the present invention, such that chemical molecules in Hartindo AF31 Total Fire Inhibitor chemical liquid, when transformed into a clean-chemistry-water-based mist 56, provides a countless supply of water-based micro-droplets, each containing dissolved ions (i.e. electrically-charged atoms or molecules) supplying free-electrons that pair with and stabilize the free-radicals before any other molecules in the combustion phase can do so to sustain the chemical-reactions (i.e. free-electrons that reduce and stabilize the free-radicals before rapidly-oxidizing molecules within the combustion phase of the fire to sustain the chemical-reactions), and thereby quickly suppressing and extinguishing the fire.

When constructed and operational, the clean-chemistry water mist fire suppression system 50 of the present invention shown in FIG. 7 will be charged with an adequate supply/store of environmentally-clean free-radical chemical-reaction interrupting liquid 56 for protecting the designated space (e.g. building, vessel or vehicle) against a fire outbreak. In some applications, the volumetric capacity of the supply tank 57 may be as small as 50 gallons, and other applications, while in other applications, the capacity of the supply tank 57 may exceed tens of thousands of gallons of free-radical chemical-reaction interrupting liquid.

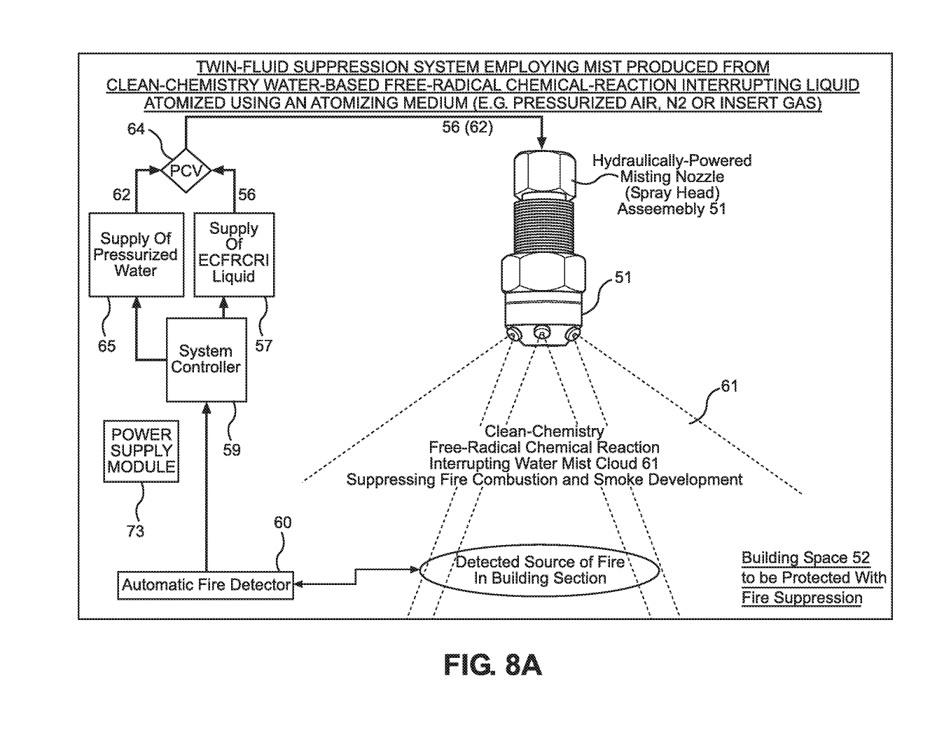

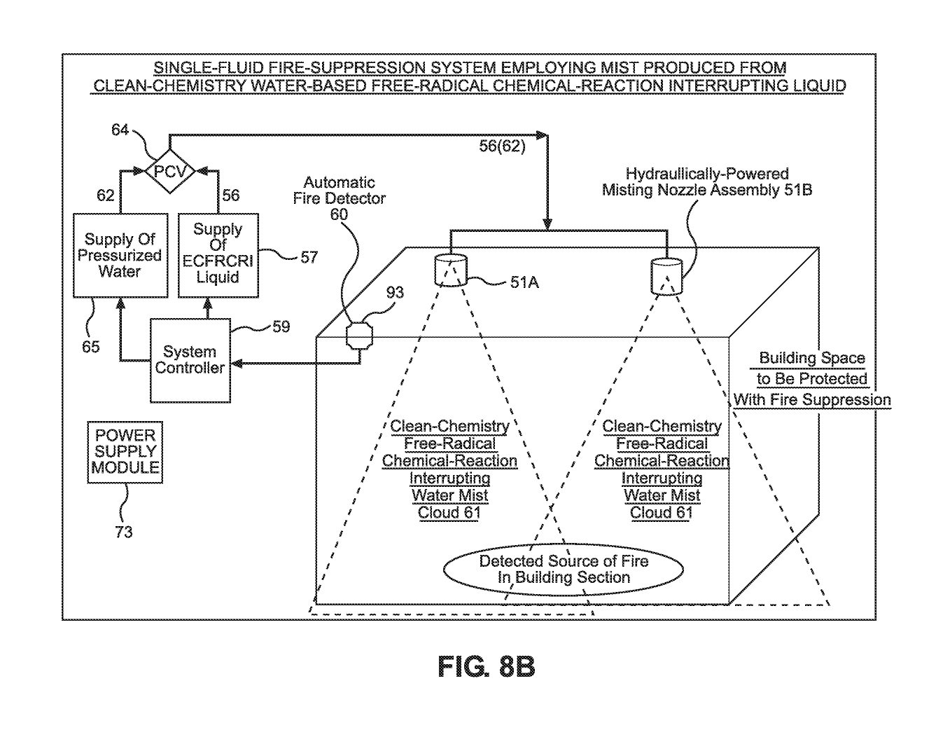

Upon automatic detection of a fire outbreak, by the automatic fire detectors 60 employed in the system, the system 50 will automatically deliver the free-radical chemical-reaction interrupting liquid 56 under adequate hydraulic pressure, through the system of piping and control valves 54, 64 into the hydraulic spray nozzles 51 so as to automatically generate and deliver clean water-based free-radical chemical-reaction interrupting mist 61 to the protected space for rapidly suppressing and extinguishing detected fire outbreak, as illustrated in FIGS. 8A and 8B.

The automatic fire sensors 60 used in the fire suppression system 50 can be any conventional electronic fire and smoke detector based on the sensing and detection of heat, radiant energy, fire and/or smoke using technologies known in the fire and smoke detection arts, typically following the NFPA 72 Standard on National Fire Alarm and Signaling Code, 2019 Edition. Under the NFPA 750 Standard (2016 Edition), a “Detector” is device suitable for connection to a circuit that has a sensor that responds to a physical stimulus such as gas, heat, or smoke. An “Automatic Fire Detector” is defined as a device designed to detect the presence of a fire signature and to initiate action. Under the NFPA Standard, “automatic fire detectors” are classified as embracing all of the following detectors: Automatic Fire Extinguishing or Suppression System Operation Detectors, Fire-Gas Detectors, Heat Detectors, Other Fire Detectors, Radiant Energy-Sensing Fire Detectors, and Smoke Detectors.

For the purpose of this Code, Automatic Fire Detectors are classified as follows: Automatic Fire Extinguishing or Suppression System Operation Detector, Fire-Gas Detector, Heat Detector, Other Fire Detectors, Radiant Energy-Sensing Fire Detector, and Smoke Detector, as defined below. The many different kinds of Detectors that that currently exist and fall under “Automatic Fire Detectors” are defined and identified below in technical detail.

An Automatic Fire Extinguishing or Suppression System Operation Detector is a device that automatically detects the operation of a fire extinguishing or suppression system by means appropriate to the system employed.

A Combination Detector is a device that either responds to more than one of the fire phenomena or employs more than one operating principle to sense one of these phenomena. Typical examples are a combination of a heat detector with a smoke detector, or a combination rate-of-rise and fixed-temperature heat detector. This device has listings for each sensing method employed.

An Electrical Conductivity Heat Detector is a line-type or spot-type sensing element in which resistance varies as a function of temperature.

A Fire-Gas Detector is a device that detects gases produced by a fire.

A Fixed-Temperature Detector is a device that responds when its operating element becomes heated to a predetermined level.

A Flame Detector is a radiant energy-sensing fire detector that detects the radiant energy emitted by a flame.

A Flame is a body or stream of gaseous material involved in the combustion process and emitting radiant energy at specific wavelength bands determined by the combustion chemistry of the fuel. In most cases, some portion of the emitted radiant energy is visible to the human eye.

A Gas Detector is a device that detects the presence of a specified gas concentration. Gas detectors can be either spot-type or line-type detectors.

A Heat Detector is a fire detector that detects either abnormally high temperature or rate-of-temperature rise, or both.

A Line-Type Detector is a device in which detection is continuous along a path. Typical examples are rate-of-rise pneumatic tubing detectors, projected beam smoke detectors, and heat-sensitive cable.

A Multi-Criteria Detector is a device that contains multiple sensors that separately respond to physical stimulus such as heat, smoke, or fire gases, or employs more than one sensor to sense the same stimulus. This sensor is capable of generating only one alarm signal from the sensors employed in the design either independently or in combination. The sensor output signal is mathematically evaluated to determine when an alarm signal is warranted. The evaluation can be performed either at the detector or at the control unit. This detector has a single listing that establishes the primary function of the detector.

A Multi-Sensor Detector is a device that contains multiple sensors that separately respond to physical stimulus such as heat, smoke, or fire gases, or employs more than one sensor to sense the same stimulus. A device capable of generating multiple alarm signals from any one of the sensors employed in the design, independently or in combination. The sensor output signals are mathematically evaluated to determine when an alarm signal is warranted. The evaluation can be performed either at the detector or at the control unit. This device has listings for each sensing method employed.

A Pneumatic Rate-of-Rise Tubing Heat Detector is a line-type detector comprising small-diameter tubing, usually copper, that is installed on the ceiling or high on the walls throughout the protected area. The tubing is terminated in a detector unit containing diaphragms and associated contacts set to actuate at a predetermined pressure. The system is sealed except for calibrated vents that compensate for normal changes in temperature.

A Projected Beam-Type Detector is a type of photoelectric light obscuration smoke detector, wherein the beam spans the protected area.

A Radiant Energy-Sensing Fire Detector is a device that detects radiant energy, such as ultraviolet, visible, or infrared, that is emitted as a product of combustion reaction and obeys the laws of optics.

A Rate Compensation Detector is a device that responds when the temperature of the air surrounding the device reaches a predetermined level, regardless of the rate-of-temperature rise.

A Rate-of-Rise Detector is a device that responds when the temperature rises at a rate exceeding a predetermined value.

A Smoke Detector is a device that detects visible or invisible particles of combustion.

A Spark/Ember Detector is a radiant energy-sensing fire detector that is designed to detect sparks or embers, or both. These devices are normally intended to operate in dark environments and in the infrared part of the spectrum.

A Spot-Type Detector is a device in which the detecting element is concentrated at a particular location. Typical examples are bimetallic detectors, fusible alloy detectors, certain pneumatic rate-of-rise detectors, certain smoke detectors, and thermoelectric detectors.

Other Fire Detectors are devices that detect a phenomenon other than heat, smoke, flame, or gases produced by a fire, such as (i) electromagnetic radiation over particular bands, (ii) changes in ambient pressure, (iii) acoustical energy, and (iv) other forms of energy produced or modulated by a fire.

It is understood that any one or more of these Detectors described above can be used to practice the “automatic fire detector” elements of the clean-chemistry water mist fire suppression system of the present invention. In many instances, a combination of Detectors will be used to provide the automatic fire detection functionalies required to provide demanding fire suppression and extinguishment in diverse types of occupancy and fields of application.

In some applications, the automatic fire detector 60 may be realized as a commercially-available FLIR AF315 f (Model FLIR A315 f, 90) IR temperature sensor having built-in “smartness” such as analysis, alarm functionality, and autonomous communication using standard protocols, to support automatic fire detection through real-time IR thermal image analysis.

In the illustrative embodiment, the fire suppression system 50 supports several modes of operation under the system controller 59, namely: (i) a Clean-Chemistry Water Misting Mode, wherein only clean free-radical chemical-reaction interrupting water solution 56 is supplied through the control valve 64 and to the fluid pump unit 55 and supplied to the nozzles 51 under pressure to generate a clean free-radical chemical-reaction interrupting mist cloud(s) 61 to suppress and extinguish a detected fire outbreak, and for the control valve 64 to supply pure filtered water 62 to the fluid pump unit 55 and to nozzles 51 only when free-radical chemical-reaction interrupting liquid 56 is consumed or depleted before the detected fire outbreak is completely suppressed and extinguished, in which case, pure filtered water 62 is automatically supplied to the fluid pump unit 55 to generate pure water mist and complete water mist fire suppression operations on system 50; (ii) a Blended Clean-Chemistry Water Misting Mode, wherein clean free-radical chemical-reaction interrupting water solution 56 and clean filtered water 62 are blended together in prespecified and controlled proportions (e.g. 40/60 or 50/50) using proportional flow control valve 64 operated under the programmed system controller 59, so that clean-chemistry mist 61 is generated from the misting heads/nozzles 51 for suppressing and extinguishing a detected fire outbreak; (iii) a Pure Water Misting Mode, wherein only pure filtered water solution 62 is used by the system 50 to generate pure water mist to suppress and extinguish a detected fire outbreak, a mode typically used in the event the supply of clean free-radical chemical reaction interrupting liquid 56 has been temporarily depleted and not yet replenished in the system 50 for whatever reason; and (iv) a Flush and Rinse Mode, wherein pure clean filtered water 62 is supplied through control valve 64 to fluid pump unit 54 and through the nozzles (i.e. misting heads) 51 to flush the system and rinse and clean the nozzles 51 in preparation for the next fire suppression cycle under the control of the system controller 59.

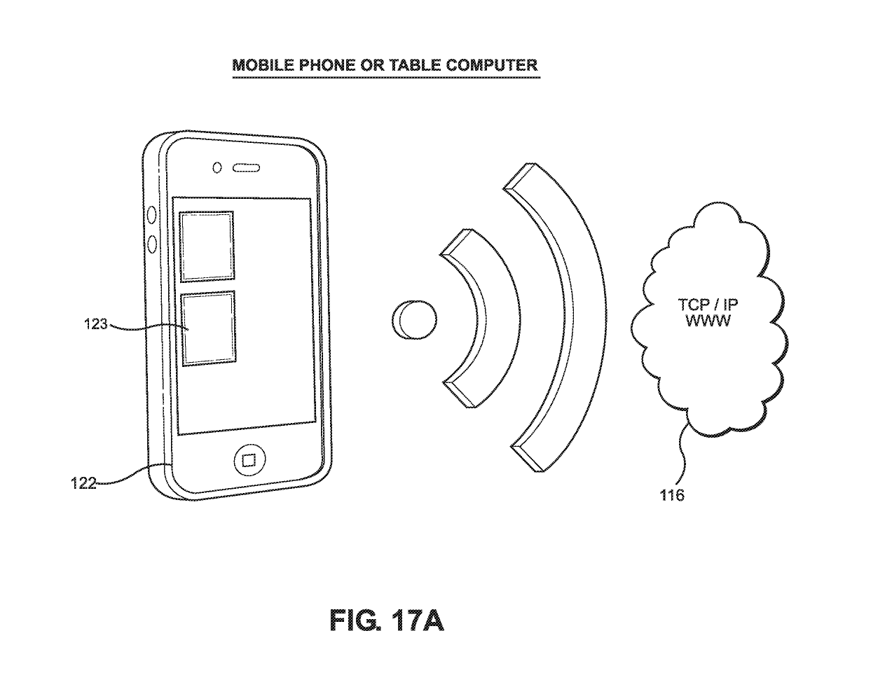

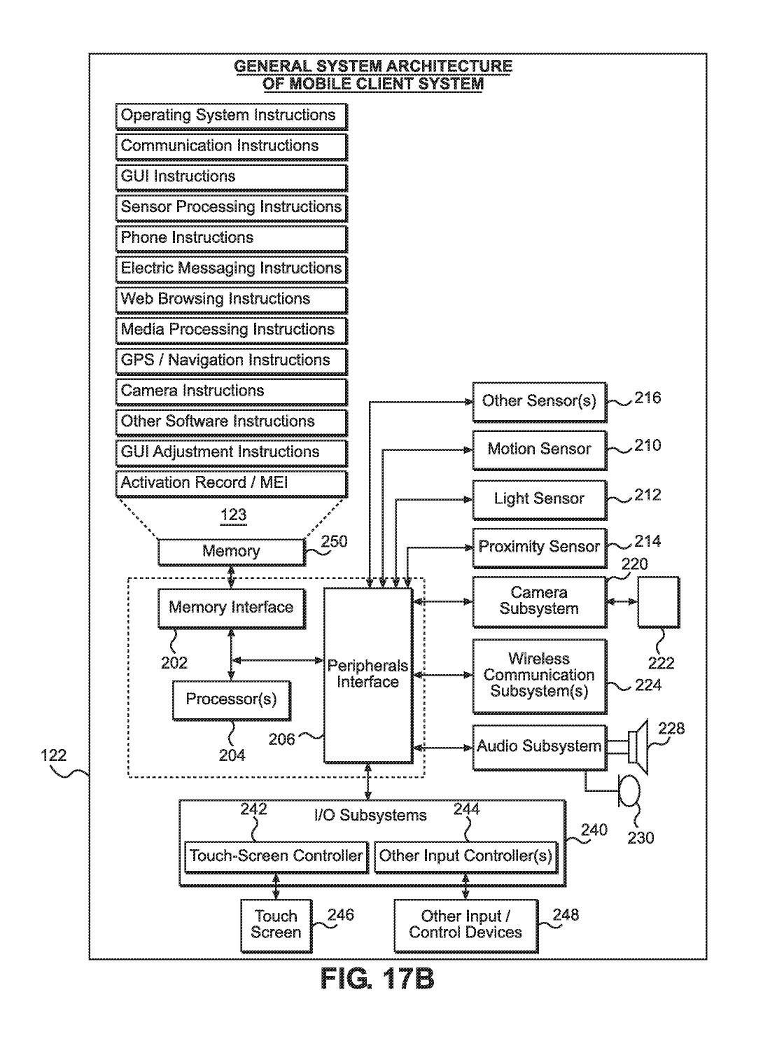

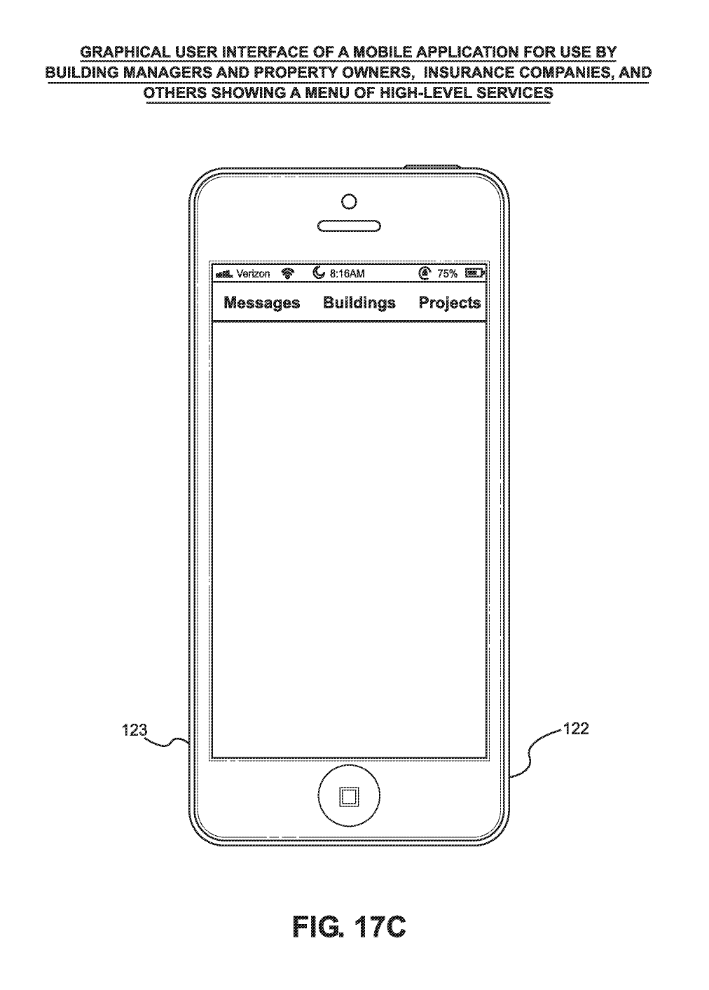

Preferably, each of these Modes of System Operation are provided a mode control button supported on the control panel 72, as shown in FIG. 7. Alternatively, the Modes can be selected by a specific program instructions entered at the control panel shown in FIG. 7, or even by remote control over the Internet using the mobile application 122 on mobile computer, illustrated in FIGS. 17, 17A, 17B, and 17C. In either case, the authorized system operator will select the Mode which is desired for the purpose at hand.

For purposes of illustration only, Modes (i) and (ii) are depicted in the fire suppression processes shown in FIGS. 8A and 8B. However, it is understood, that Modes (iii) and (iv) would be supported by the same apparatus, except reconfigured to support the specific mode of operation described above.

In FIG. 8A, a hydraulically-pressurized water misting nozzle 51 is shown being driven with environmentally-clean water-based free-radical chemical-reaction interrupting (FRCRI) liquid 56 supplied from the supply tank 57 maintained in the water-based misting system 50 of FIG. 7. As shown in FIG. 8A, an exemplary free-radical chemical reaction interrupting water-based misting pattern 61 is produced from the multiple misting orifices formed the hydraulically-pressurized spray/misting nozzle head 51, and connected to its input port, typically threaded to a piping connector. The discharged clean-chemistry free-radical chemical-reaction interrupting water mist rapidly fills a room or space in which the fire outbreak is automatically detected, in most circumstances, except when a manual firm alarm has been activated by manual pulling operation. The free-radical chemical-reaction interrupting water mist 61 consists of microscopic water droplets embodying clean free-radical chemical-reaction interruption chemistry, which instantly evaporates when contacting the fire, (i) causing rapid cooling, (ii) vapor expansion, (iii) oxygen displacement, and (iv) interruption of the free-radical chemical reactions within the combustion phase of the fire, thereby suppressing or extinguishing the fire, reducing smoke development and preventing re-ignition of fire, in significantly improved ways over the use of conventional water mist.

The water-based micro-droplets produced from the clean-chemistry water-based solution (i.e. liquid) contain dissolved ions (i.e. electrically-charged atoms or molecules) supplying free-electrons that pair with and stabilize the free-radicals before any other molecules in the combustion phase can do so to sustain the chemical-reactions (i.e. free-electrons that reduce and stabilize the free-radicals before rapidly-oxidizing molecules within the combustion phase of the fire to sustain the chemical-reactions), and thereby quickly suppress and extinguish the fire.

FIG. 8B shows the fire suppression system of the first illustrative embodiment of the present invention, illustrated in FIG. 8B, with the exception of showing multiple mist spray nozzles 51A and 51B installed in the space being protected by the clean-chemistry free-radical chemical-reaction interrupting water mist cloud technology of the present invention.

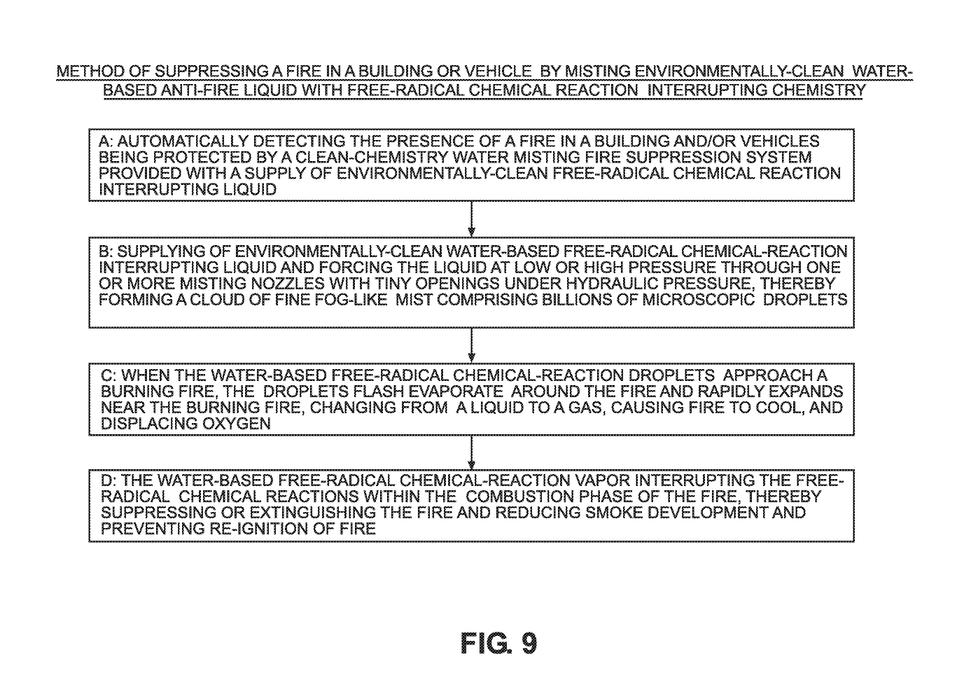

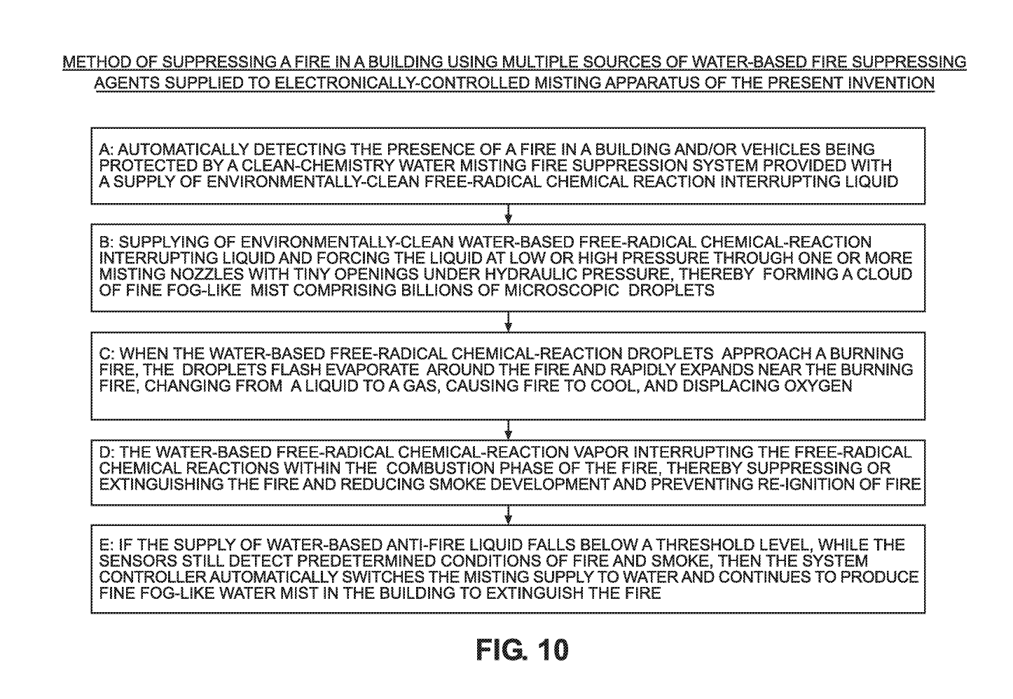

As shown in FIGS. 8A and 8B, when a fire is automatically detected in a building section (or protected space) by one or more automatic fire detectors 60 installed in the building section, the system controller 59 responds to such signals and activates the proportional flow control valve 64 to control the flow of water from the main water supply 69 through a water filter 67, into a clean-chemistry water-based free-radical chemical-reaction interrupting liquid storage tank 57, where it is then automatically pumped into the hydraulic pump unit 55 by a feed water pump 58, as shown. The hydraulic fluid pump unit 55 then pumps the clean-chemistry misting liquid 56 into the misting nozzles 51 at a low, intermediate or high pressure to produce a fine clean-chemistry free-radical chemical-reaction interrupting water mist 61 in the building section to quickly suppress and extinguish the fire, while the system controller 59 controls water pumping operations to maintain the level of the clean-chemistry water-based misting liquid 56 stored in the liquid storage/buffer tank 57 during fire suppression operations, as described in FIG. 9. In the event the level of clean-chemistry free-radical chemical-reaction interrupting liquid 56 in the supply tank 57 falls below a threshold level, as detected by the automatic liquid/fluid level sensor 66 (e.g. light-based, float-based, mechanical-based etc.), then the system controller activates solenoid control valves 53A and 53B to cause water from the water storage tank 57 to flow into the feed fluid pump 58 and hydraulic fluid pump unit 55, as described in greater detail below in FIG. 10.

For purposes of illustration, fire suppression system 50 is assumed to be operating in either Mode (i) or (ii) described above in the methods described in FIGS. 9 and 10 described below.

FIG. 9 describes the method of suppressing a fire in a building, vessel, vehicle or space according to the present invention illustrated in FIGS. 7 and 8, by misting environmentally-clean water provided with free-radical chemical-reaction interrupting chemistry, which (i) rapidly suppresses and extinguishes fire with significantly less water than conventional water mist system, while developing significantly less smoke, with significantly less risk of re-ignition, in a manner far superior to conventional water mist fire suppression methods.

As shown in FIG. 9, the method comprises the following steps: (a) automatically detecting the presence of a fire in a building, vessel, vehicle or space using an automatic fire detector 60 supported in a clean-chemistry water mist fire suppression system 50 operating in Mode (i) or (ii) described above; (b) supplying environmentally-clean water-based free-radical chemical-reaction interrupting liquid 56 to one or more misting nozzles (i.e. spray heads) 51 with ultra small openings, operating under low, intermediate or high hydraulic pressure, as required, to form a cloud of fine fog-like mist comprising billions of microscopic free-radical chemical-reaction interrupting water droplets; (c) when the free-radical chemical-reaction interrupting water droplets approach a burning fire, the droplets flash evaporate around the fire and rapidly expanding near the burning fire, changing from a liquid to a gas, causing fire to cool, and displacing oxygen; and (d) the water-based clean-chemistry vapor interrupting the free-radical chemical-reactions within the combustion phase of the fire, thereby suppressing or extinguishing the fire, reducing smoke development and preventing re-ignition of fire, in a manner superior to conventional water mist fire suppression methods.

This superior performance can be attributed to the fact that the micro-droplets of the clean-chemistry water mist will vaporize when absorbing the radiant heat energy of the hot fire, rapidly expanding into a vapor, cooling down the fire, and displacing oxygen. Also the chemical molecules in the micro-droplets will interfere with the free radicals (H+, OH−, O) and interrupt these free-radical chemical reactions within the combustion phase of a fire, and extinguishing the fire. Free-radical chemical-reaction interruption of the combustion phase is achieved by providing to the fire, water-based micro-droplets that contain dissolved ions (i.e. electrically-charged atoms or molecules) supplying free-electrons that pair with and stabilize the free-radicals before any other molecules in the combustion phase can do so to sustain the chemical-reactions (i.e. free-electrons that reduce and stabilize the free-radicals before rapidly-oxidizing molecules within the combustion phase of the fire to sustain the chemical-reactions), and thereby quickly suppress and extinguish the fire.

FIG. 10 describes a method of suppressing a fire in a building, vessel or vehicle using multiple sources of water-based fire suppressing agents supplied to electronically-controlled misting apparatus of the present invention illustrated in FIGS. 7, 8A and 8B. As described, the method comprises: (a) the water mist fire suppression system 50 of the present invention automatically detecting the presence of a fire in a building, vessel, vehicle or space, while configured in Mode (i) or (ii) described above; (b) supplying environmentally-clean water-based free-radical chemical-reaction interrupting liquid 56 to one or more misting nozzles 51 with tiny openings under low, intermediate or high hydraulic pressure, thereby forming a cloud of fine fog-like mist comprising billions of microscopic droplets; (c) when the water-based free-radical chemical-reaction droplets approach a burning fire, the droplets flash evaporating around the fire and rapidly expanding near the burning fire, changing from a liquid to a gas, causing fire to cool, and displacing oxygen; (d) the water-based free-radical chemical-reaction vapor interrupting the free-radical chemical reactions within the combustion phase of the fire, thereby suppressing or extinguishing the fire and reducing smoke development and preventing re-ignition of fire; and (e) if the supply of water-based free-radical chemical-reaction interrupting liquid 56 falls below a threshold level, while automatic fire detectors 60 still detect predetermined conditions of fire and smoke, the system 50 automatically switches the misting supply to the water main 69 and continues to produce fine fog-like water mist in the building to extinguish the detected fire. This provides a fire suppression safety backup measure, in the event the supply of water-based free-radical chemical-reaction interrupting liquid 56 is consumed or depleted during a fire suppression operation in a building, vessel or other space being fire protected.

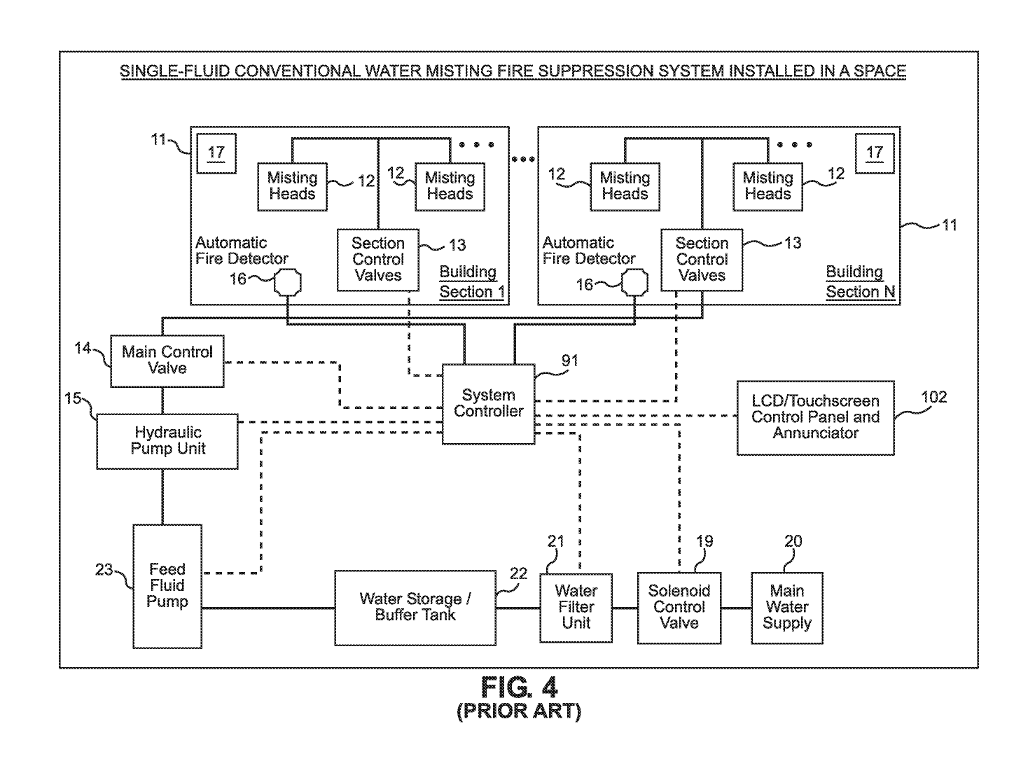

This superior performance of the clean-chemistry water mist system 50 can be attributed to the fact that the micro-droplets of clean-chemistry water mist 61 will vaporize when absorbing the radiant heat energy of a hot fire, rapidly expanding into a vapor, cooling down the fire, and displacing oxygen. Also, the chemical molecules in the micro-droplets of the misting cloud 108 will also interfere with and interrupt the free radicals (H+, OH−, O) in the chemical reactions within the combustion phase of a fire, further suppressing and extinguishing the fire with great efficiency. Free-radical chemical-reaction interruption of the combustion phase is achieved by providing to the fire, water-based micro-droplets that contain dissolved ions (i.e. electrically-charged atoms or molecules) supplying free-electrons that pair with and stabilize the free-radicals before any other molecules in the combustion phase can do so to sustain the chemical-reactions (i.e. free-electrons that reduce and stabilize the free-radicals before rapidly-oxidizing molecules within the combustion phase of the fire to sustain the chemical-reactions), and thereby quickly suppress and extinguish the fire. This is a major advantage of the clean-chemistry water mist system 50 of the present invention over conventional water misting systems as described in FIG. 4.

The clean-chemistry water misting methods and apparatus of the present invention shown and described in FIGS. 7 through 10 can be practiced in either dry or wet type clean-chemistry water mist fire suppression systems alike, within the scope and spirit of the present invention.

In order to prevent any possible buildup of scale or deposits within the fine orifices of the nozzles 51, the system 50 is provided with a rinse mode, in which pure filtered water 64 is pumped through the misting heads (i.e. nozzles) 51 after a fire has been extinguished using the clean-chemistry free-radical chemical-reaction interrupting liquid 56, while the system is being reset for a new fire alarm response cycle. During this rinse mode, activated by a designated button on the control panel 72, the system controller 59 sends signals to the proportional flow control valve 64 which allows pure filtered water to flow from tank 65 to the feed pump 58. The fed pump 58 feeds the hydraulic fluid pump 55 with liquid which is pumped through the piping system and into the nozzles 51 under required pressure, to generate water mist for a predetermined short period of time (e.g. 30 seconds) sufficient to rinse out the nozzles and their fine orifices, and thereby prepare the system for its next fire alarm response cycle, without the risk of orifice build up or clogging.

Specification of the Fire Suppression System of the Second Illustrative Embodiment of the Present Invention Producing Clean-Chemistry Water Mist from Environmentally-Clean Free-Radical Chemical-Reaction Interrupting Liquid Using Atomizing Misting Nozzles and A Pressurized Atomizing Agent (E.G. Pressurized Air, N2 or Other Inert Gas)

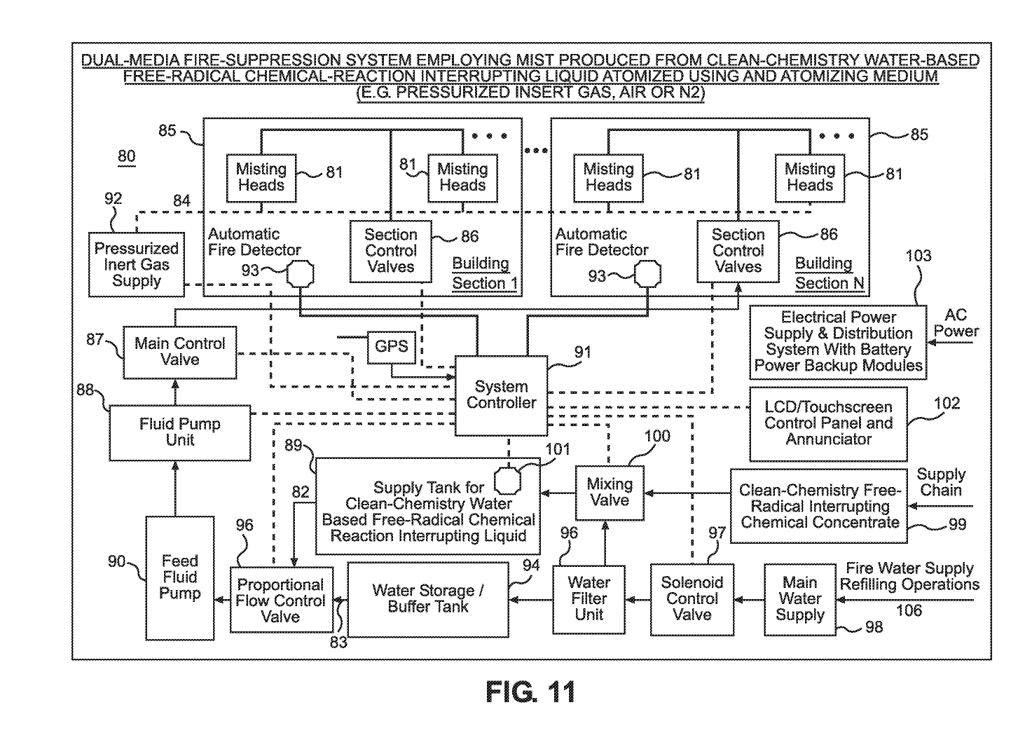

FIG. 11 describes a fire suppression system 80 according to a second illustrative embodiment of the present invention, using clean-chemistry free-radical chemical-reaction interrupting water misting according to the principles of the present invention. As shown, the fire suppression system 80 comprises: a plurality of atomizing-type liquid misting heads (i.e. nozzles) 81 supplied with (i) clean water-based free-radical chemical reaction interrupting liquid 82 (or water 83 in pure-water misting mode) and also a pressurized supply of atomizing media (e.g. pressurized insert gas, such as N2 or air) 84, wherein each nozzle head 81 is mounted in a room space 85 and connected to a section control valve 86 using adequate piping (e.g. stainless steel or copper tubing) that is connected to a main control valve 87.

As shown in FIG. 11, the main control valve 87 is connected to a fluid pump unit 88 that pumps into the misting nozzles (i.e. atomizing spray heads) 81 either (i) environmentally-clean water-based free-radical chemical-reaction interrupting liquid 82 supplied from a clean-chemistry liquid storage/buffer tank 89 via a feed fluid pump 90 controlled by system controller 91, along with a pressurized atomizing media (e.g. insert gas, such as N2 or air) 84 stored in pressurized cylinder tanks 92, when a fire or extreme source of heat energy is automatically detected within the room or space 85 by one or more automatic fire detectors 93 in the section, or (ii) filtered water 83 supplied from the water storage/buffer tank 94, along with a pressurized atomizing media (e.g. insert gas, such as N2 or air) 84 if and when the supply of water-based free-radical chemical-reaction interrupting liquid 82 falls below a predetermined threshold level, while the automatic fire detectors 93 still detect predetermined conditions of fire and/or smoke in the section.

Under such conditions described above, the clean-chemistry water mist fire suppression system 80 continues to produce fine fog-like water mist in the section in which the fire has been detected, while the programmed system controller 91 automatically controls the proportional flow control valve 96 controlling the clean-chemistry water-based free-radical chemical reaction liquid 82 and pure filtered water 96 (in a proportioned blending/mixing ratio AB as required by the enabled Mode of System operation), and pressurized atomizing media (e.g. N2 or air) 84 and the solenoid control valve 97 controlling the supply of water 106 from the main water supply 98, as required by the programming of the system controller 91. All of the mentioned system components are connected hydraulically using adequately sized piping made from stainless steel or copper tubing, and in some cases, advanced plastic piping such as CPVC piping capable of withstanding higher temperatures and pressures than conventional PVC piping.

In the illustrative embodiment, the proportional control valve 96 will be electronically-controlled by the system controller 91, include one or more solenoids, and have the capacity to accurately measure and control the mass flow rates flowing into multiple (e.g. two) input ports provided on the proportional control valve 96, as well as its output mass flow rate, thereby enabling the desired precise proportioned blending of controlled input mass flows as required for the specific application at hand (e.g. in accordance with a required blending ratio C=A/B, where A and B are the mass flow input rates and C is the mass flow rate output).

There are different ways to achieve the proportional control valve 96 used in system 80. For example, the device can realized as a single off-the-shelf integrated assembly, including solenoid flow rate control valves on each input port, flow rate sensors on each input port, flow rate control electronics and power supply inputs, all integrated in a single housing/package. This would be the preferred embodiment. Alternatively, two or more single input port mass flow control valves can integrated and provided with external controls to realize the mass flow control and blending required for the present invention, as described in great detail above. Numerous commercial proportional control valves are available from different manufacturers that can be readily adapted and configured for controlling the proportional blending of two mass flow rates (liquid 82 and water 83) in any proportion (e.g. ratio AB) with excellent results.

As shown in FIG. 11, the mass flow rate of the pressurized air or inert gas 84 will be measured/metered and controlled by an electronically-controlled mass flow control valve 92A inserted in the pipeline after the pressurized supply tank 92 and operated under the control of the system controller 91 so that the mass flow rates of pressurized air (or other inert gas such as N2) is precisely metered before flowing into the atomizing misting heads 81 and interacting with liquid 82 and/or filtered water 96, depending on which Mode of System Operation the system 80 has been configured by selecting control buttons supported on the control panel 102.

Notably, many of the components used in the clean-chemistry water mist system of the present invention 80 shown in FIG. 11 can be found in conventional water mist fire suppression systems, including those systems identified in FIG. 3B. Such components will include low, intermediate or high pressure fluid pumps, section valves, control valves, piping, hydraulic misting nozzles (spray heads), system controllers, automatic fire detectors, and other system components required by the system of the present invention. Also, those skilled in the art will understand the value in using conventional hydraulic fluid system modeling software to design the fire suppression system of the present invention so that adequate pressure is generated within the system to do the work necessary to hydraulically produce the clean-chemistry water mist, while achieving all other system design requirements.

Preferably, the clean water-based free-radical chemical-reaction interrupting liquid 96 is realized using Hartindo AF31 Total Fire Inhibitor chemical liquid, developed by Hartindo Chemicatama Industri of Jakarta, Indonesia, and commercially available from Newstar Chemicals (M) SDN BHD of Selangor Darul Ehsan, Malaysia, http://newstarchemicals.com/products.html. Hartindo AF31 Total Fire Inhibitor chemical liquid has the required free-radical chemical reaction interrupting chemistry of the present invention, such that chemical molecules in Hartindo AF31 Total Fire Inhibitor chemical liquid, when transformed into a clean-chemistry-water-based mist 82, provides a countless supply of water-based micro-droplets, each containing dissolved ions (i.e. electrically-charged atoms or molecules) supplying free-electrons that pair with and stabilize the free-radicals before any other molecules in the combustion phase can do so to sustain the chemical-reactions (i.e. free-electrons that reduce and stabilize the free-radicals before rapidly-oxidizing molecules within the combustion phase of the fire to sustain the chemical-reactions), and thereby quickly suppressing and extinguishing the fire.

In the illustrative embodiment, the fire suppression system 80 supports several modes of operation under the system controller 91, namely: (i) a Clean-Chemistry Water Misting Mode, wherein only clean free-radical chemical-reaction interrupting water solution 82 is supplied through the control valve 96 and to the fluid pump unit 88 and supplied to the nozzles 51 under pressure to generate a clean free-radical chemical-reaction interrupting mist cloud(s) 108 to suppress and extinguish a detected fire outbreak, and for the control valve 96 to supply pure filtered water 83 to the fluid pump unit 88 and to nozzles 82 only when free-radical chemical-reaction interrupting liquid 82 is consumed or depleted before the detected fire outbreak is completely suppressed and extinguished, in which case, pure filtered water 83 is automatically supplied to the fluid pump unit 88 to generate pure water mist and complete water mist fire suppression operations on system 80; (ii) a Blended Clean-Chemistry Water Misting Mode, wherein clean free-radical chemical-reaction interrupting water solution 82 and clean filtered water 83 are blended together in prespecified and controlled proportions (e.g. 40/60 or 50/50) using proportional flow control valve 96 operated under the programmed system controller 91, so that clean-chemistry mist 61 is generated from the misting heads/nozzles 51 for suppressing and extinguishing a detected fire outbreak; (iii) a Pure Water Misting Mode, wherein only pure filtered water solution 83 is used by the system 80 to generate pure water mist to suppress and extinguish a detected fire outbreak, a mode typically used in the event the supply of clean free-radical chemical reaction interrupting liquid 82 has been temporarily depleted and not yet replenished in the system 80 for whatever reason; and (iv) a Flush and Rinse Mode, wherein pure clean filtered water 83 is supplied through control valve 96 to fluid pump unit 88 and through the nozzles (i.e. misting heads) 82 to flush the system and rinse and clean the nozzles 82 in preparation for the next fire suppression cycle under the control of the system controller 91.

Preferably, each of these Modes of System Operation are provided a mode control button supported on the control panel 72, as shown in FIG. 7. Alternatively, the Modes can be selected by a specific program instructions entered at the control panel shown in FIG. 7, or even by remote control over the Internet using the mobile application 122 on mobile computer, illustrated in FIGS. 17, 17A, 17B, and 17C. In either case, the authorized system operator will select the Mode which is desired for the purpose at hand.

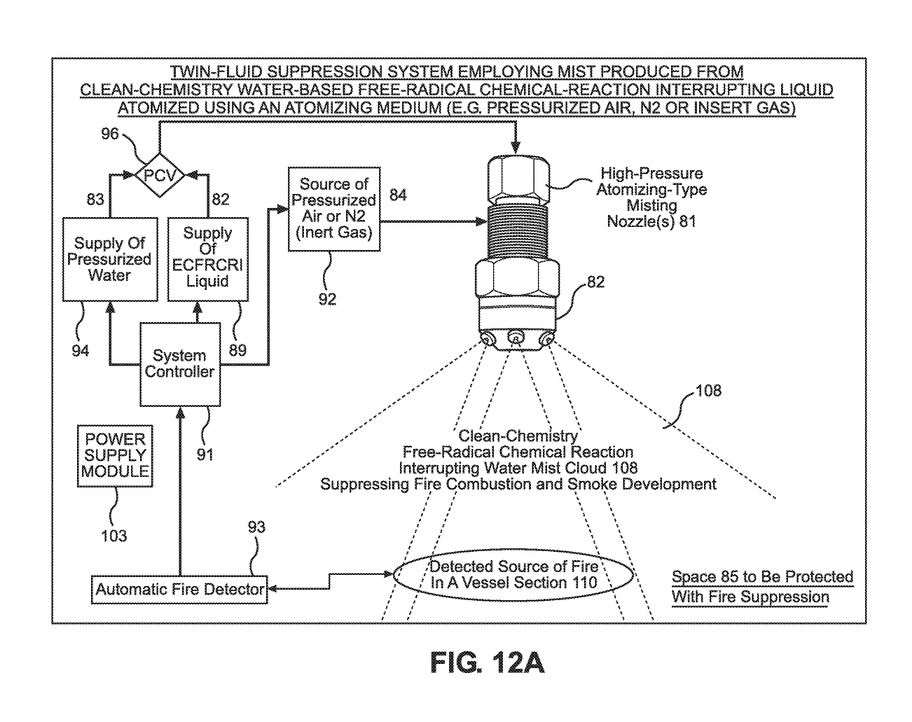

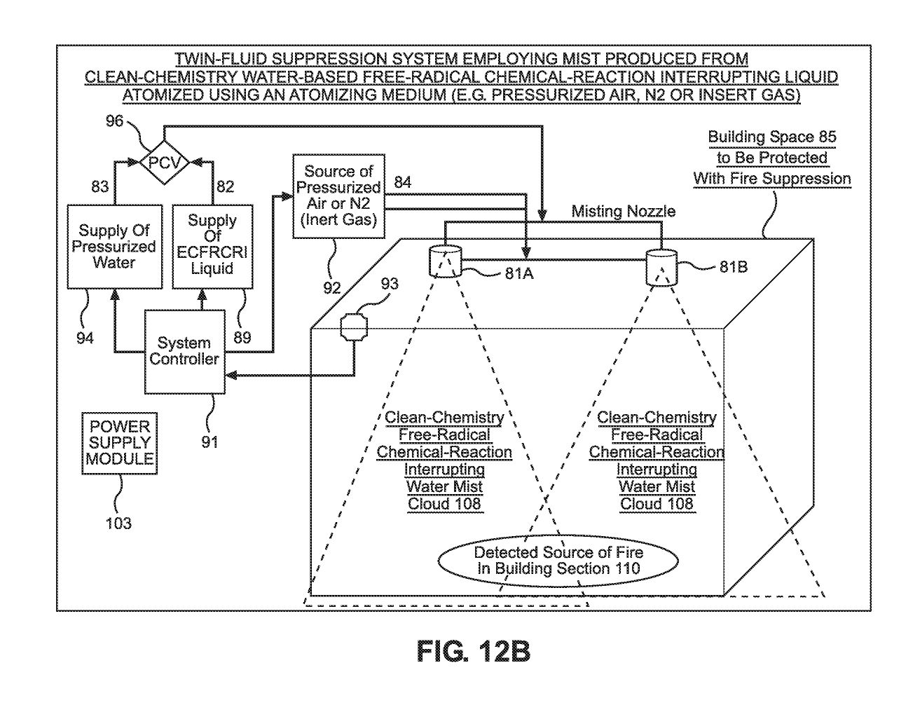

For purposes of illustration only, Modes (i) and (ii) described above are depicted in the fire suppression processes shown in FIGS. 12A and 12B. However, it is understood, that Modes (iii) and (iv) would be supported by the same apparatus, except reconfigured to support the specific mode of operation described above.

FIG. 12A shows an exemplary water misting nozzle 81 used in the water-based misting system depicted in FIG. 11, illustrating a clean-chemistry free-radical chemical-reaction interrupting water misting cloud 108 produced from one or more orifices formed in the atomizing-type misting nozzle (i.e. spray head) 81. As shown, the misting nozzle 81 is supplied with both (i) water-based free-radical chemical-reaction interrupting liquid 82 and (ii) pressurized atomizing media (e.g. N2 or air) 83, generating clean-chemistry water mist 108 rapidly discharged from the nozzle and filling the space in which fire 110 outbreak was detected. As illustrated, the clean-chemistry water mist consists of microscopic clean-chemistry water droplets that evaporate when contacting the fire, causing rapid cooling, evaporation, rapid vapor expansion and oxygen displacement, while the chemical vapor interrupts the free-radical chemical-reactions within the combustion phase of the fire, thereby suppressing or extinguishing the fire and reducing smoke development and preventing re-ignition of fire, in a manner superior to conventional water mist fire suppression methods.

FIG. 12B shows the fire suppression system of the first illustrative embodiment of the present invention, as illustrated in FIG. 12A, with the exception of showing multiple mist spray nozzles 81A and 81B installed in the space being protected by the clean-chemistry free-radical chemical-reaction interrupting water mist cloud technology of the present invention.

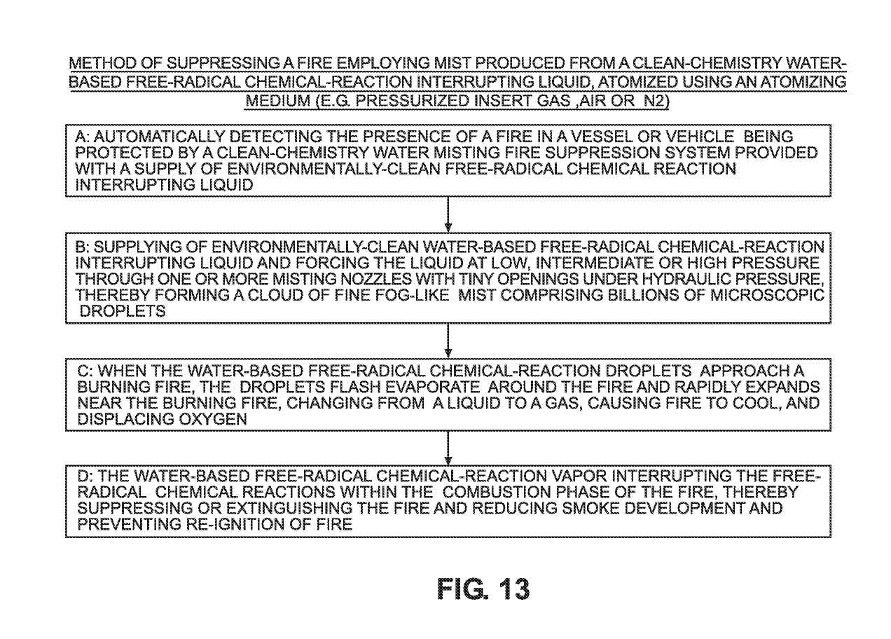

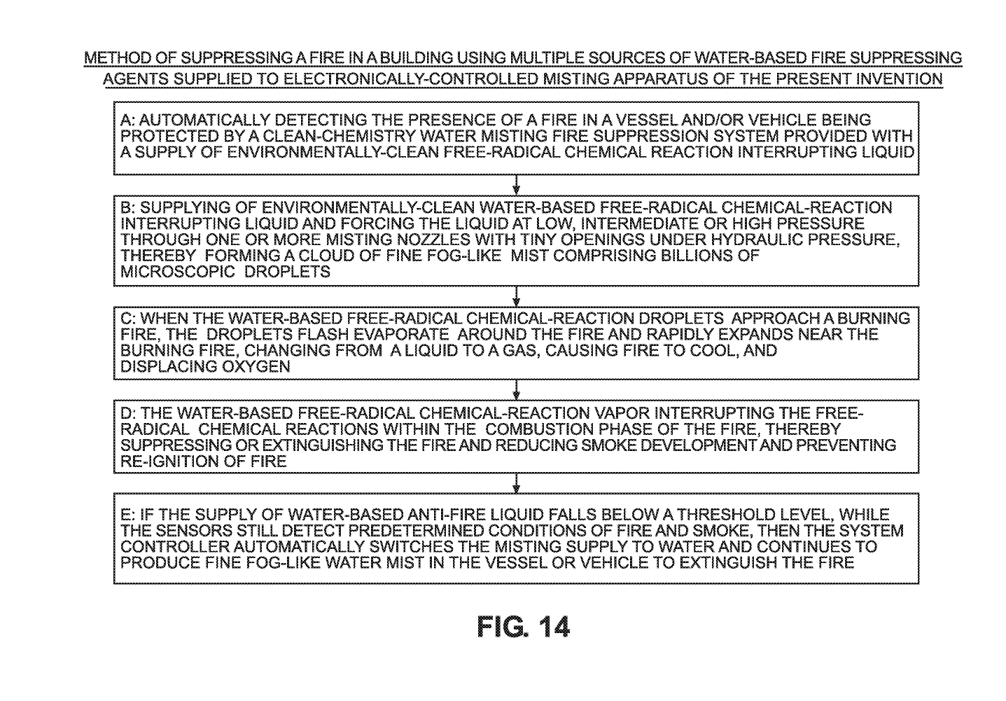

As shown in FIGS. 12A and 12B, when a fire is automatically detected in a building section (vessel, vehicle or protected space) by one or more automatic fire detectors 93 installed therein, the system controller 91 responds to such signals and activates the proportional flow control valve 96 to control the flow of clean-chemistry water-based free-radical chemical-reaction interrupting liquid 82 from storage tank 89, into the fluid pump unit 88 by feed water pump 90, as shown. The fluid pump unit 88 then pumps the clean-chemistry misting liquid 82 into the misting nozzles 81 typically at a low or intermediate pressure, while a source of atomizing media (e.g. pressurized air, N2 or other insert gas) 84 is supplied simultaneously from supply tank 92 to the atomizing misting nozzles 91, so as to produce a fine clean-chemistry free-radical chemical-reaction interrupting water misting cloud 108 in the building section to quickly suppress and extinguish the fire, while the system controller 91 controls water pumping operations to maintain the level of the clean-chemistry water-based misting liquid 82 stored in the liquid storage/buffer tank 89 during fire suppression operations, as described in FIG. 13. In the event the level of clean-chemistry free-radical chemical-reaction interrupting liquid 82 in the supply tank 89 falls below a threshold level, as detected by the automatic liquid/fluid level sensor 101 (e.g. light-based, float-based, mechanical-based etc.), then the system controller activates solenoid control valves 96 and 97 to cause water from the water storage tank 94 to flow into the feed fluid pump 90 and fluid pump unit 88, as driven the atomizing misting nozzles 81, with the pressurized atomizing media/gas 84, as described in greater detail below in FIG. 14, to generate a pure-water based misting cloud in the space for fire suppression and extinguishment using pure water 83 from water supply 94, rather then clean-chemistry free-radical chemical-reaction interrupting liquid 82 from supply tank 89, as described above.

For purposes of illustration, the fire suppression system 80 is assumed to be operating in either mode (i) or (ii) described above in the methods described in FIGS. 13 and 14 described below.

FIG. 13 describes the method of suppressing a fire in a building, vessel, vehicle, or space by misting a clean-chemistry water-based free-radical chemical-reaction interrupting liquid 82 supplied from tank 89, to (i) rapidly suppress and extinguish a detected fire outbreak using significantly less water than conventional water mist fire suppression systems, (ii) produce significantly less smoke, and (iii) reduce the risk of re-ignition of the suppressed fire, in accordance with the principles of the present invention illustrated in FIGS. 11, 12A and 12B.

As shown in FIG. 13, the method comprises: (a) automatically detecting the presence of a fire in a building, vessel, vehicle or space using an automatic fire detector 93 supported by the water-based misting fire suppression system 80 configured in Mode (i) or (ii), and also provided with a supply of environmentally-clean free-radical chemical reaction interrupting liquid 82 for pressurized-gas atomizing-type mist producing nozzles 81; (b) in response to the detection of fire 110, automatically supplying the water-based free-radical chemical-reaction interrupting liquid 82 to one or more misting nozzles 81 with tiny openings under fluid pressure as required, to form a cloud of fine fog-like mist 108 comprising billions of microscopic droplets in the space 85; (c) when the water-based free-radical chemical-reaction droplets approach a burning fire, the droplets flash evaporating around the fire, rapidly expanding near the burning fire, changing from a liquid to a gas, causing the fire to cool, and displacing oxygen; and (d) the free-radical chemical-reaction vapor interrupting the free-radical chemical-reactions within the combustion phase of the fire 110, thereby suppressing or extinguishing the fire, reducing smoke development, and preventing re-ignition of fire, in a manner superior to conventional water mist fire suppression methods.

FIG. 14 describes the method of suppressing a fire in a building, vessel or vehicle using multiple sources including (i) water-based fire suppressing agents (e.g. water-based free-radical chemical-reaction interrupting liquid 82, and (ii) a pressurized atomizing agent (e.g. an inert gas such as N2 or air) 83 supplied to the gas-pressurized misting apparatus of the present invention illustrated in FIGS. 11, 12A and 12B.

As shown in FIG. 14, the method comprises: (a) automatically detecting the presence of a fire in a building, vessel, vehicle or space using automatic fire detectors 93 supported by a water-based misting fire suppression system 80 configured in Mode (i) or (ii) and provided with a supply of environmentally-clean free-radical chemical reaction interrupting liquid 83; (b) supplying environmentally-clean water-based free-radical chemical-reaction interrupting liquid 82 to one or more misting nozzles 81 with tiny openings under fluid pressure, so as to form a cloud of fine fog-like mist 108 comprising billions of microscopic droplets; (c) when the water-based free-radical chemical-reaction droplets approach a burning fire, the droplets flash evaporating around the fire 110, rapidly expanding near the burning fire, changing from a liquid to a gas, causing the fire to cool, and displacing oxygen; (d) the water-based free-radical chemical-reaction vapor 108 interrupting the free-radical chemical reactions within the combustion phase of the fire, thereby suppressing or extinguishing the fire, reducing smoke development, and preventing re-ignition of fire 110; and (e) if the supply of water-based free-radical chemical-reaction interrupting liquid 82 falls below a threshold level as sensed by electronic level sensor 101, while automatic fire detectors (e.g. fire and smoke detectors) 93 still detect predetermined conditions of fire and/or smoke, then the system controller 91 automatically activates proportional flow control valve 96 and switches the misting supply line from clean-chemistry free-radical chemical-reaction interrupting liquid 82 from supply tank 89 to pure-water 83 from water tank 94 maintained by the water supply main 98, and then the system 80 continues to produce fine fog-like water mist from its spray heads 81 (i.e. misting nozzles) to suppress and extinguish the detected fire 110.

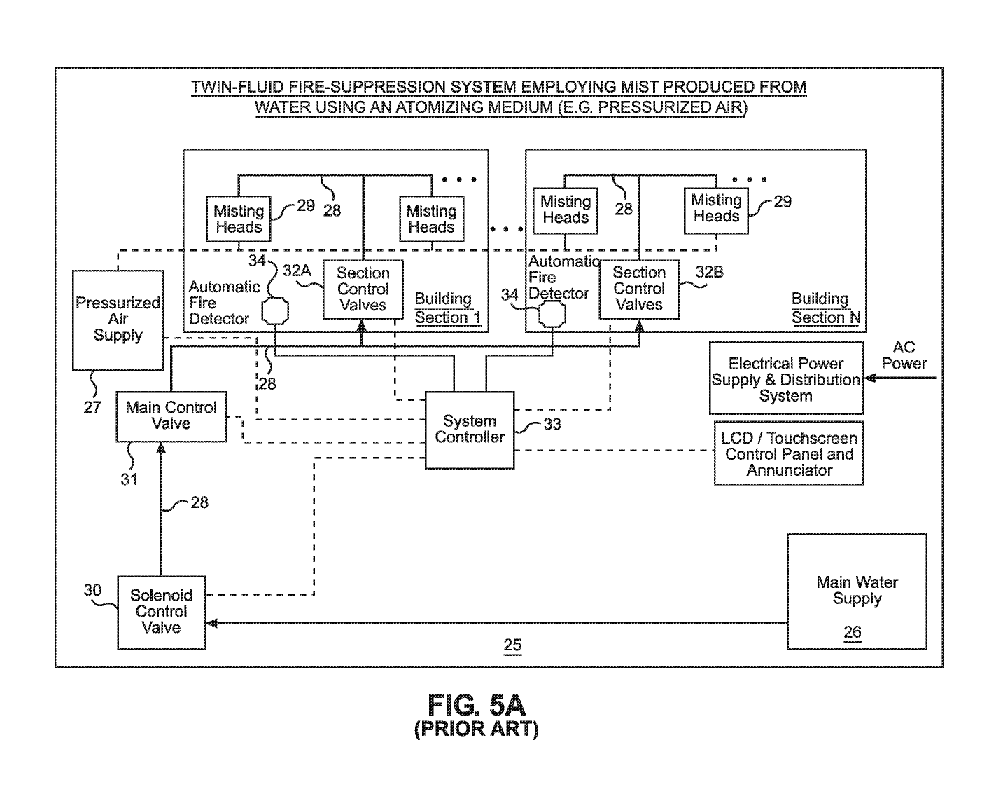

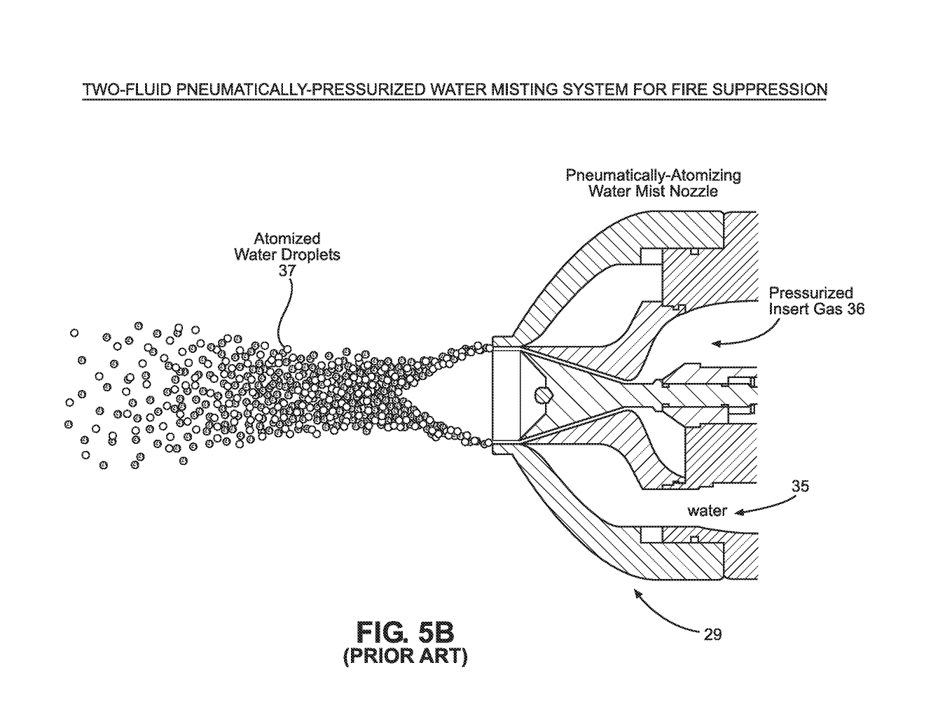

This superior performance of the clean-chemistry water mist system 80 can be attributed to the fact that the micro-droplets of clean-chemistry water mist 108 will vaporize when absorbing the radiant heat energy of a hot fire, rapidly expanding into a vapor, cooling down the fire, and displacing oxygen. At the same time, the chemical molecules in the micro-droplets of the misting cloud 108 will also interfere with and interrupt the free radicals (H+ hydrogen ions, OH— hydroxide ions, O) in the chemical reactions within the combustion phase of a fire, further suppressing and extinguishing the fire with great efficiency. Free-radical chemical-reaction interruption of the combustion phase is achieved by providing to the fire, water-based micro-droplets that contain dissolved ions (i.e. electrically-charged atoms or molecules) supplying free-electrons that pair with and stabilize the free-radicals before any other molecules in the combustion phase can do so to sustain the chemical-reactions (i.e. free-electrons that reduce and stabilize the free-radicals before rapidly-oxidizing molecules within the combustion phase of the fire to sustain the chemical-reactions), and thereby quickly suppress and extinguish the fire. This is a major advantage of the clean-chemistry water mist system 80 of the present invention over conventional water misting systems as described in FIGS. 5A and 5B

Many different types of air-atomizing nozzle head designs can be used in practicing the water mist fire suppression system 80 shown in FIGS. 11 through 14. Numerous nozzle vendors, such as Bete Fog Nozzle, Inc., of Greenfield, Mass., offer atomizing-type misting nozzles for use in the system of FIG. 11 so as to produce the clean-chemistry water-based misting patterns required for adequate fire suppression under the operating pressure and flow rate requirements of the specific application. Those skilled in the art will understand the value in using conventional hydraulic fluid system modeling software to design the fire suppression system of the present invention so that adequate pressure is generated within the system to do the work necessary to produce the clean-chemistry water mist using the atomizing media, while achieving all other system design requirements.

The clean-chemistry water misting methods and apparatus of the present invention shown and described in FIGS. 11 through 14 can be practiced in either dry or wet type clean-chemistry water mist fire suppression systems alike, within the scope and spirit of the present invention.

In order to prevent any possible buildup of scale or deposits within the fine orifices of the nozzles 81, the system 80 is provided with a rinse mode, in which pure filtered water 64 is pumped through the misting heads (i.e. nozzles) 81 after a fire has been extinguished using the clean-chemistry free-radical chemical-reaction interrupting liquid 56, while the system is being reset for a new fire alarm response cycle. During this rinse mode, activated by a designated button on the control panel 102, the system controller 91 sends signals to the proportional flow control valve 96 which allows pure filtered water to flow from tank 94 to the feed pump 90. The fed pump 90 feeds the fluid pump 88 with liquid which is pumped through the piping system and into the nozzles 81 under required pressure, to generate water mist for a predetermined short period of time (e.g. 30 seconds) sufficient to rinse out the nozzles and their fine orifices, and thereby prepare the system for its next fire alarm response cycle, without the risk of orifice build up or clogging.

### Specification of Portable Fire Extinguisher for Suppressing and Extinguishing Fire Using Clean-Chemistry Free-Radical Chemical-Reaction Interrupting Misting Clouds

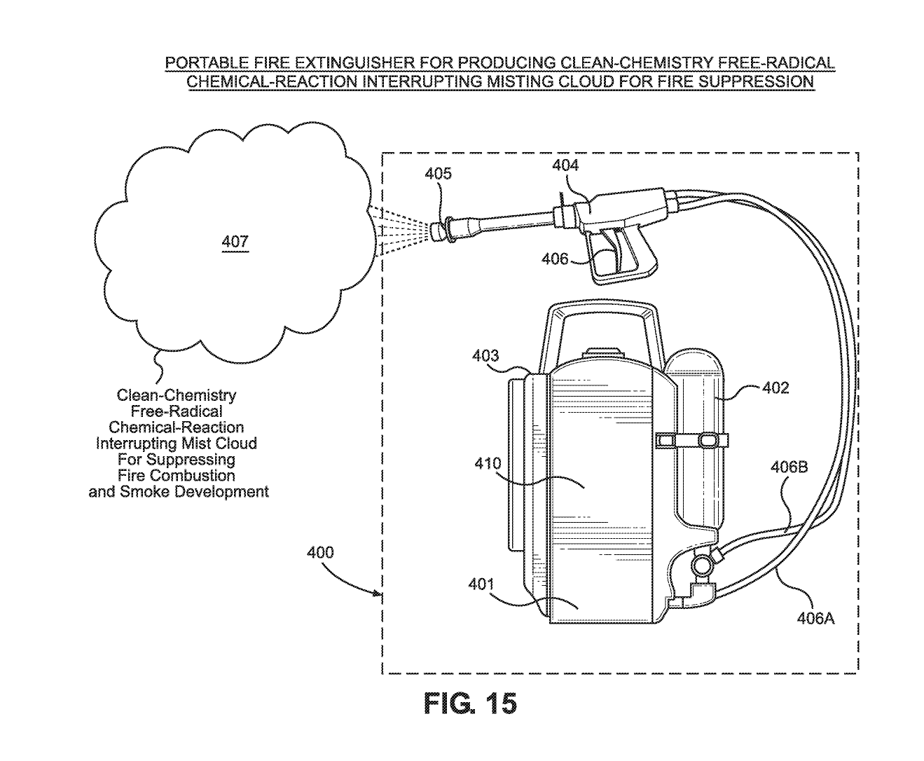

FIG. 15 shows a hand-supportable clean-chemistry water-based free-radical chemical-reaction interrupting misting fire extinguisher 400 according to the present invention. As shown, the portable system 400 comprises: a liquid storage tank 401 containing 5 gallons of environmentally-clean water-based free-radical chemical-reaction interrupting liquid 410, charged with 100 psig pressure from a small pressurized air tank 402 integrated with the housing 403. The hand-activated gun-style misting head (i.e. spray misting gun) 404 is provided with a stainless-steel misting nozzle 45 that is connected to two flexible hoses 406A and 406B. Hose 406A is connected to the water tank 41 and hose 406B is connected to the pressurized air tank 402. The hand-held gun-style misting head 404 with misting nozzle 405 is manually activated by the user depressing a finger-activated trigger 406 to discharge clean-chemistry water-based free-radical chemical-reaction interrupting mist clouds 407 from the nozzle 405 onto a fire for quick suppression and extinguishment. The portable system can be either back-mounted, or carried in one hand while the other hand is used to hold and operate the spray-misting gun 404. Preferably, the clean water-based free-radical chemical-reaction interrupting liquid 410 is realized using Hartindo AF31 Total Fire Inhibitor chemical liquid, developed by Hartindo Chemicatama Industri of Jakarta, Indonesia, and commercially available from Newstar Chemicals (M) SDN BHD of Selangor Darul Ehsan, Malaysia, http://newstarchemicals.com/products.html. Hartindo AF31 Total Fire Inhibitor chemical liquid 410 has the required free-radical chemical reaction interrupting chemistry of the present invention, such that the chemical molecules in Hartindo AF31 Total Fire Inhibitor chemical liquid will interfere with the free radicals generated during the combustion phase of a fire, and interrupt these free-radical chemical reactions within the combustion phase, to suppress and extinguish the fire. Specifically, the Hartindo AF31 Total Fire Inhibitor chemical liquid has the required free-radical chemical reaction interrupting chemistry of the present invention, such that chemical molecules in Hartindo AF31 Total Fire Inhibitor chemical liquid, when transformed into a clean-chemistry-water-based mist, provides a countless supply of water-based micro-droplets, each containing dissolved ions (i.e. electrically-charged atoms or molecules) supplying free-electrons that pair with and stabilize the free-radicals (H+, OH−, O) before any other molecules in the combustion phase can do so to sustain the chemical-reactions (i.e. free-electrons that reduce and stabilize the free-radicals before rapidly-oxidizing molecules within the combustion phase of the fire to sustain the chemical-reactions), and thereby quickly suppressing and extinguishing the fire.

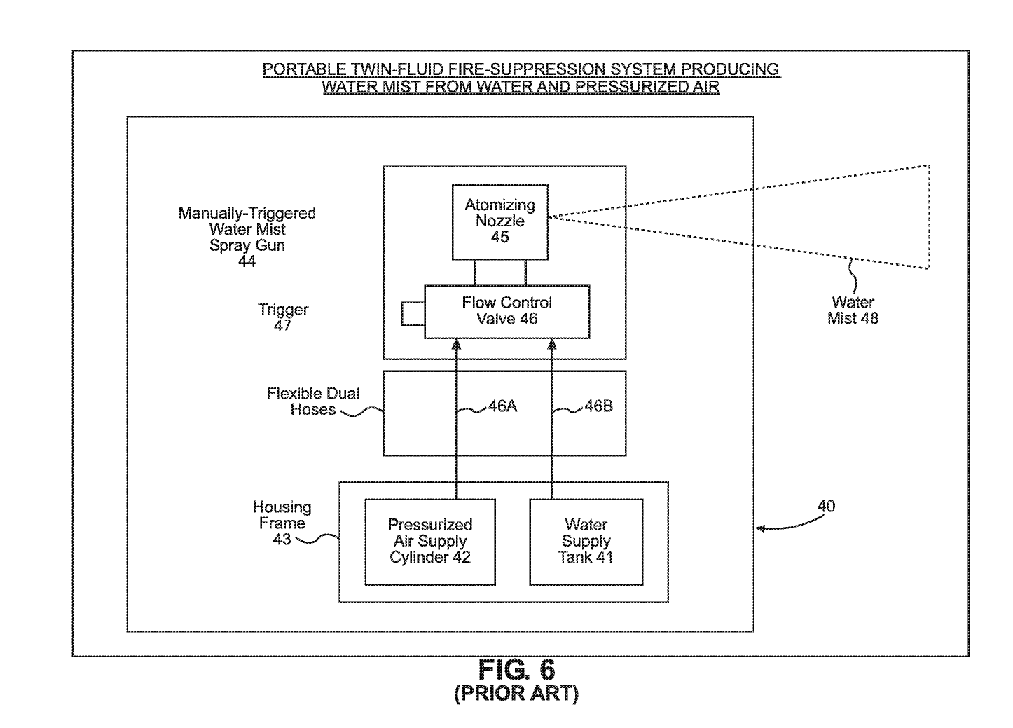

The superior performance of system 400 over conventional portable water mist systems shown in FIG. 6 can be attributed to the fact that the micro-droplets of the clean-chemistry water mist 407 will vaporize when absorbing the radiant heat energy of the hot fire, rapidly expanding into a vapor, cooling down the fire, and displacing oxygen. Also the chemical molecules in the micro-droplets will interfere with the free radicals (H+, OH−, O) and interrupt these free-radical chemical reactions within the combustion phase of a fire, and extinguishing the fire.

Specification of the Wireless System Network of the Present Invention Designed for Managing the Ordering, Delivery and Supply of Environmentally-Clean Water-Based Free-Radical Chemical-Reaction Interrupting Liquid to Buildings, Vessels and Other Spaces to be Protected Against Fire Around the World

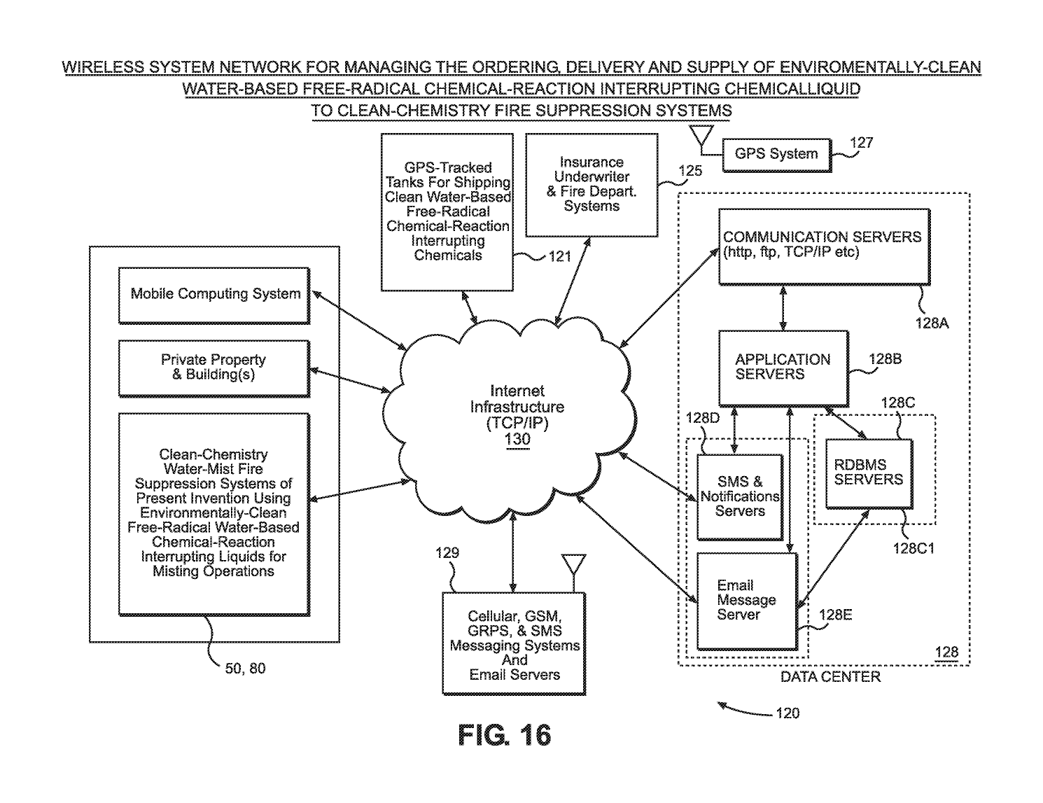

FIG. 16 shows a wireless system network 120 for monitoring the improved clean-chemistry water mist fire suppression systems of the present invention 50, 80 and 400 illustrated in FIGS. 7 through 15. Each of these systems employs misting of clean-chemistry water-based free-radical chemical-reaction interrupting liquids 56, 82 410 sprayed in the vicinity of an automatically-detected fire. To support such systems, the system network 120 is configured to supply clean-chemistry water-based free-radical chemical-reaction interrupting liquid (and atomizing media) to any size network of such water mist fire suppression systems, typically commissioned to meet and support the fire safety requirements of specific spaces and occupancies under the NFPA 750 Standard. By managing the supply and delivery of water-based free-radical chemical-reaction interrupting liquid 56, 82 supplies to buildings, vessels and other spaces to be protected against fire around the world, property owners and fire insurance companies will take comfort in knowing that their properties will receive reliable and superior fire suppression services to reduce the risk of loss of property and life due to the outbreak of fire and development of smoke.

As shown in FIG. 16, the system network 120 comprises: GPS-tracked/barcoded/RFID-tagged tanks 121 for shipping clean water-based free-radical chemical-reaction interrupting (liquid or dry) chemicals 56, 82; mobile computing systems 122 running the mobile application of the present invention 123 and used by property owners/managers, fire departments for managing clean-chemistry water mist fire suppression systems 50 and 80 of the present invention; insurance underwriters and fire departments and supporting systems 125; web application and web servers of fire departments 126; GPS system 127 for providing GPS-location services to each and every system components in the system network 120; one or more data centers 128 each containing clusters of web, application and database servers 128A, 128B, 128C for supporting messaging, notifications, and microservices associated withe ordering and delivery of GPS-tracked tanks (e.g. totes) and mobile computing and communication devices 122 configured in accordance with the principles of the present invention. As shown, each data center 128 also includes an SMS server 128D and an email message server 128E for communicating with registered users on the system network 120 who use a mobile computing device (e.g. an Apple® iPhone or iPad tablet) 122 with the mobile application 123 installed thereon and configured for the purposes described herein. Such communication services will include SMS/text, email and push-notification services known in the mobile communications arts.

As shown in FIG. 16, the system network 120 also includes a GPS system 127 for transmitting GPS reference signals transmitted from a constellation of GPS satellites deployed in orbit around the Earth, to GPS transceivers 127A installed aboard each GPS-tracked ground-based misting system of the present invention. From the GPS signals it receives, each GPS transceiver aboard each water mist fire suppression system 50, 80 is capable of computing in real-time the GPS location of its host system, in terms of longitude and latitude. In the case of the Empire State Building in NYC, N.Y., its GPS location is specified as: N40° 44.9064′, W073° 59.0735′; and in number only format, as: 40.748440, −73.984559, with the first number indicating latitude, and the second number representing longitude (the minus sign indicates “west”).

As shown in FIG. 16, the Internet-based system network 120 comprises: cellular phone and SMS messaging systems 129 and email servers 129 operably connected to the TCP/IP infrastructure of the Internet 130; a network of mobile computing systems 122 running enterprise-level mobile application software 123, operably connected to the TCP/IP infrastructure of the Internet 130; each provided with GPS-tracking and having wireless internet connectivity with the TCP/IP infrastructure of the Internet, using various communication technologies (e.g. GSM, BlueTooth, WIFI, and other wireless networking protocols well known in the wireless communications arts); and one or more industrial-strength data center(s) 128, preferably mirrored with each other and running Border Gateway Protocol (BGP) between its router gateways, and operably connected to the TCP/IP infrastructure of the Internet.

Referring to FIG. 16, the cluster of communication servers 128A is accessed by web-enabled mobile computing clients 122 (e.g. smart phones, wireless tablet computers, desktop computers, computer workstations, etc.) used by many stakeholders accessing services supported by the system network 120. The cluster of application servers 128A implement many core and compositional object-oriented software modules supporting the system network 120. Typically, the cluster of RDBMS servers 128C use SQL to query and manage datasets residing in its distributed data storage environment, although non-relational data storage methods and technologies such as Apache's HaDoop non-relational distributed data storage system may be used as well.

In general, the system network 120 will be realized as an industrial-strength, carrier-class Internet-based network of object-oriented system design, deployed over a global data packet-switched communication network comprising numerous computing systems and networking components, as shown. As such, the information network of the present invention is often referred to herein as the “system” or “system network.” The Internet-based system network can be implemented using any object-oriented integrated development environment (IDE) such as for example: the Java Platform, Enterprise Edition, or Java EE (formerly J2EE); Websphere IDE by IBM; Weblogic IDE by BEA; a non-Java IDE such as Microsoft's .NET IDE; or other suitably configured development and deployment environment well known in the art.

Preferably, although not necessary, the system network 120 would be designed according to object-oriented systems engineering (DOSE) methods using UML-based modeling tools such as ROSE by Rational Software, Inc. using an industry-standard Rational Unified Process (RUP) or Enterprise Unified Process (EUP), both well known in the art. Implementation programming languages can include C, Objective C, C, Java, PHP, Python, Google's GO, and other computer programming languages known in the art. Preferably, the system network is deployed as a three-tier server architecture with a double-firewall, and appropriate network switching and routing technologies well known in the art. In some deployments, private/public/hybrid cloud service providers, such Amazon Web Services (AWS), may be used to deploy Kubernetes, an open-source software container/cluster management/orchestration system, for automating deployment, scaling, and management of containerized software applications, such as the mobile enterprise-level application 123, described above. Such practices are well known in the computer programming, networking and digital communication arts.

### Specification of System Architecture of an Exemplary Mobile Smartphone System Deployed on the System Network of the Present Invention

FIG. 17A shows an exemplary mobile computing device deployed on the system network 120 supporting the mobile clean-chemistry water-mist fire suppression management application 123 of the present invention deployed as a component of the system network 120 as shown in FIG. 16, and providing services that support the management, operation and monitoring of the fire suppression systems 50, 80 and 400 as shown in FIGS. 7 through 15.

As shown in FIG. 17B, the mobile smartphone device 122 can include a memory interface 202, one or more data processors, image processors and/or central processing units 204, and a peripherals interface 206. The memory interface 202, the one or more processors 204 and/or the peripherals interface 206 can be separate components or can be integrated in one or more integrated circuits. The various components in the mobile device can be coupled by one or more communication buses or signal lines. Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions. Other sensors 216 can also be connected to the peripherals interface 206, such as a positioning system (e.g. GPS receiver), a temperature sensor, a biometric sensor, a gyroscope, or other sensing device, to facilitate related functionalities.

As shown in FIG. 17B, a camera subsystem 220 and an optical sensor 222, e.g. a charged coupled device (CCD) or a complementary metal-oxide semiconductor (CMOS) optical sensor, can be utilized to facilitate camera functions, such as recording photographs and video clips. Communication functions can be facilitated through one or more wireless communication subsystems 224, which can include radio frequency receivers and transmitters and/or optical (e.g. infrared) receivers and transmitters. The specific design and implementation of the communication subsystem 224 can depend on the communication network(s) over which the mobile device is intended to operate. For example, the mobile device 122 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the device 122 may be configured as a base station for other wireless devices. An audio subsystem 226 can be coupled to a speaker 228 and a microphone 230 to facilitate voice-enabled functions, such as voice recognition, voice replication, digital recording, and telephony functions. The I/O subsystem 240 can include a touch screen controller 242 and/or other input controller(s) 244. The touch-screen controller 242 can be coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246. The other input controller(s) 244 can be coupled to other input/control devices 248, such as one or more buttons, rocker switches, thumb-wheel, infrared port, USB port, and/or a pointer device such as a stylus. The one or more buttons (not shown) can include an up/down button for volume control of the speaker 228 and/or the microphone 230. Such buttons and controls can be implemented as a hardware objects, or touch-screen graphical interface objects, touched and controlled by the system user. Additional features of mobile smartphone device 122 can be found in U.S. Pat. No. 8,631,358 incorporated herein by reference in its entirety.

### Different Ways of Implementing the Mobile Client Machines and Devices on the System Network of the Present Invention

In one illustrative embodiment, the enterprise-level system network is realized as a robust suite of hosted services delivered to Web-based client subsystems 122 using an application service provider (ASP) model. In this embodiment, the Web-enabled mobile application 123 can be realized using a web-browser application running on the operating system (OS) (e.g. Linux, Application IOS, etc) of a mobile computing device 122 to support online modes of system operation, only. However, it is understood that some or all of the services provided by the system network 120 can be accessed using Java clients, or a native client application, running on the operating system of a client computing device, to support both online and limited off-line modes of system operation. In such embodiments, the native mobile application 123 would have access to local memory (e.g. a local RDBMS) on the client device 120, accessible during off-line modes of operation to enable consumers to use certain or many of the system functions supported by the system network during off-line/off-network modes of operation. It is also possible to store in the local RDBMS of the mobile computing device 122 most if not all relevant data collected by the mobile application for any particular clean-chemistry water misting fire suppression system deployment.

As shown and described herein, the system network 120 has been designed for several different kinds of user roles. Depending on which role, for which the user requests registration, the system network will request different sets of registration information, including name of user, address, contact information, etc. In the case of a web-based responsive application on the mobile computing device 122, once a user has successfully registered with the system network, the system network will automatically serve a native client GUI, or an HTML5 GUI, adapted for the registered user. Thereafter, when the user logs into the system network, using his/her account name and password, the system network will automatically generate and serve GUI screens described below for the role that the user has been registered with the system network.

In the illustrative embodiment, the client-side of the system network 120 can be realized as mobile web-browser application, or as a native application, each having a “responsive-design” and adapted to run on any client computing device (e.g. iPhone, iPad, Android or other Web-enabled computing device) 122 and designed for use by anyone interested in managing, monitoring and working to defend against the threat of fires.

FIG. 17C shows a graphical user interface (GUI) of the mobile application supported on the mobile client computer system shown in FIGS. 17A and 17B, illustrating exemplary high level services support by the application. An entire set of GUIs will be created and deployed to support the services provided by the mobile application 122.

Specification of Application Environments in which Fire Suppression System of Present Invention can be Installed and Commissioned

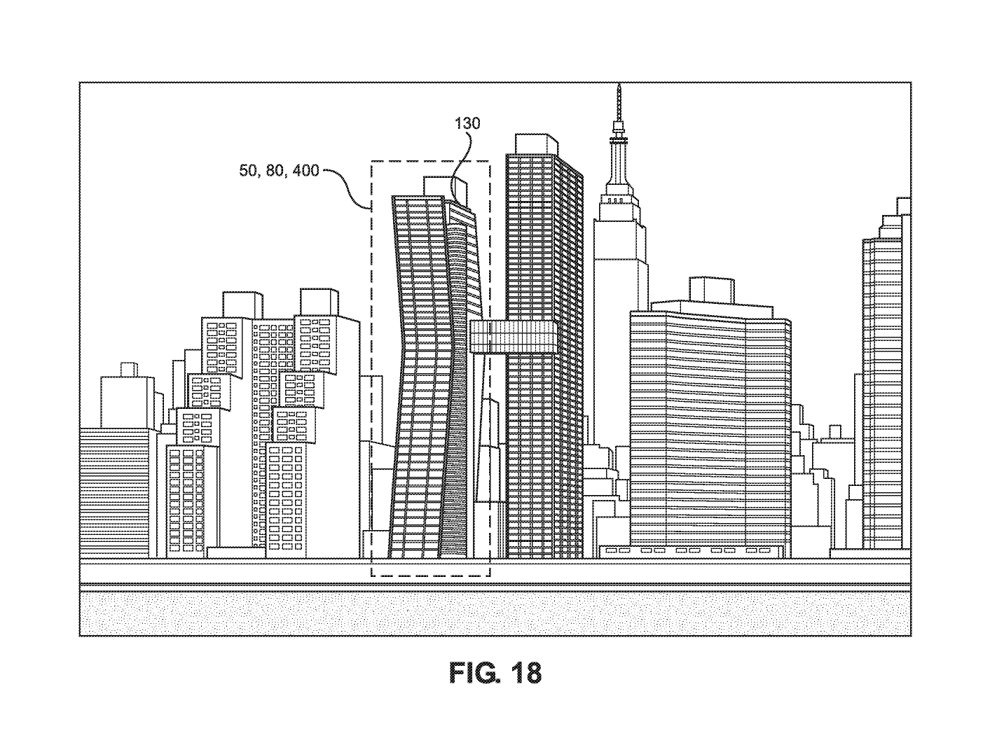

The clean-chemistry water mist systems of the present invention described in detail above can be used in numerous fire suppression applications, from protecting multi-story buildings, manufacturing factories, production lines, shipping vessels, passenger vehicles, public spaces, industrial spaces, military environments, and the like. For illustration purposes only, a number of applications environments for the present invention are shown and illustrated in FIGS. 18 through 33.

FIG. 18 shows a high-rise building 130 in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated sections in the building, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

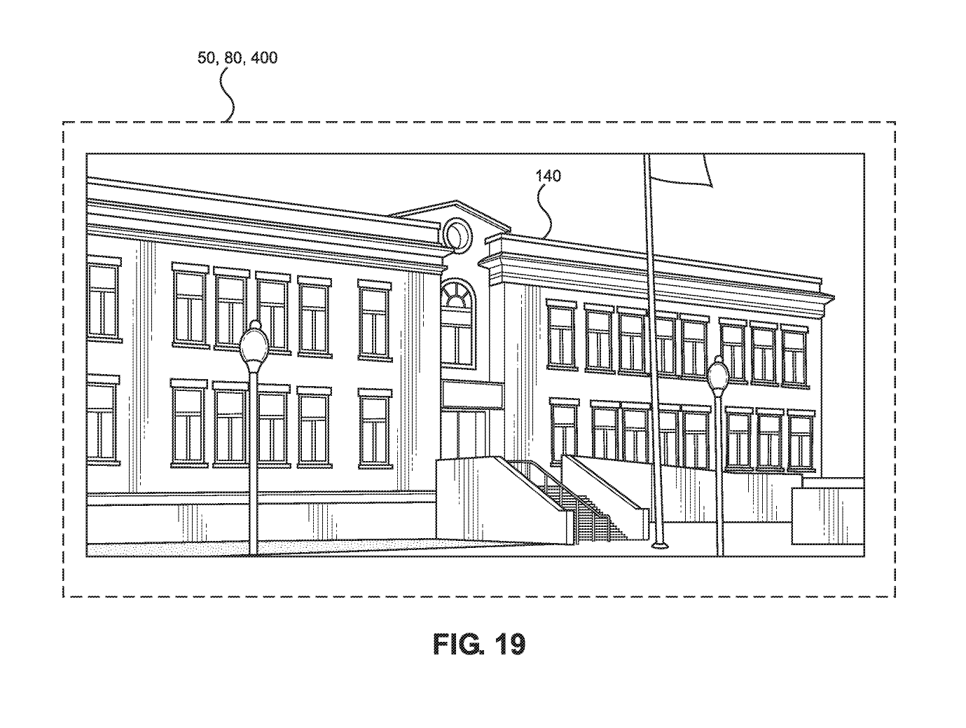

FIG. 19 shows an elementary school building 140 in which one or more of the fire suppression systems of the present invention 50, 80 shown in FIGS. 7 through 14 are installed and commissioned, for automatically generating clean-chemistry water-based free-radical chemical-reaction interrupting mist 61, 108 within designated sections in the building, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

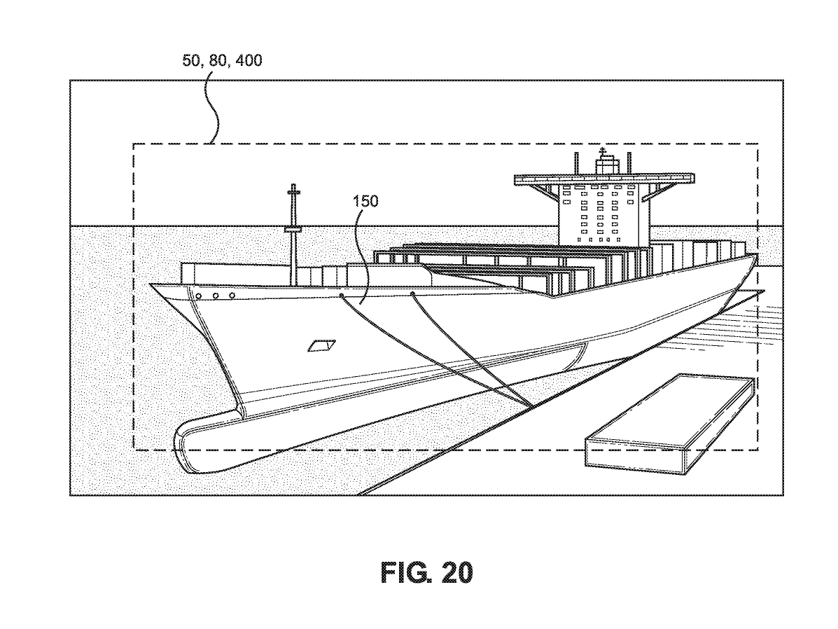

FIG. 20 shows a cargo vessel 150 in which one or more of the fire suppression systems of the present invention 50, 80 shown in FIGS. 7 through 15 are installed and commissioned, for automatically generating clean-chemistry water-based free-radical chemical-reaction interrupting mist clouds of the present invention 61, 108, within designated spaces in the cargo vessel, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

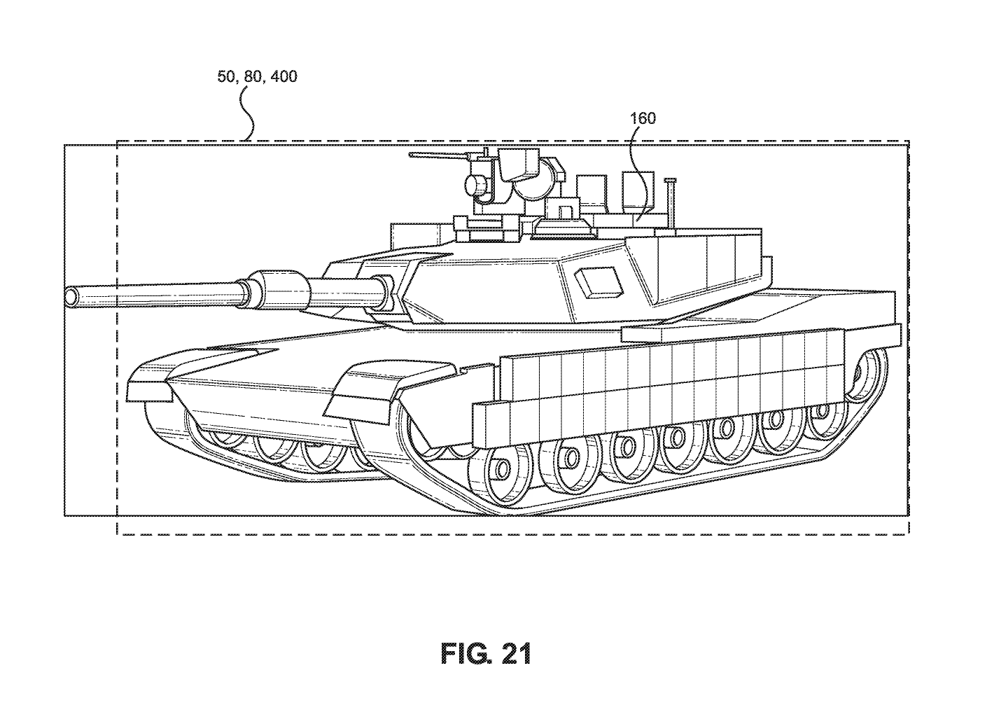

FIG. 21 shows an armored tank vehicle 160 in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated spaces in the vehicle, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

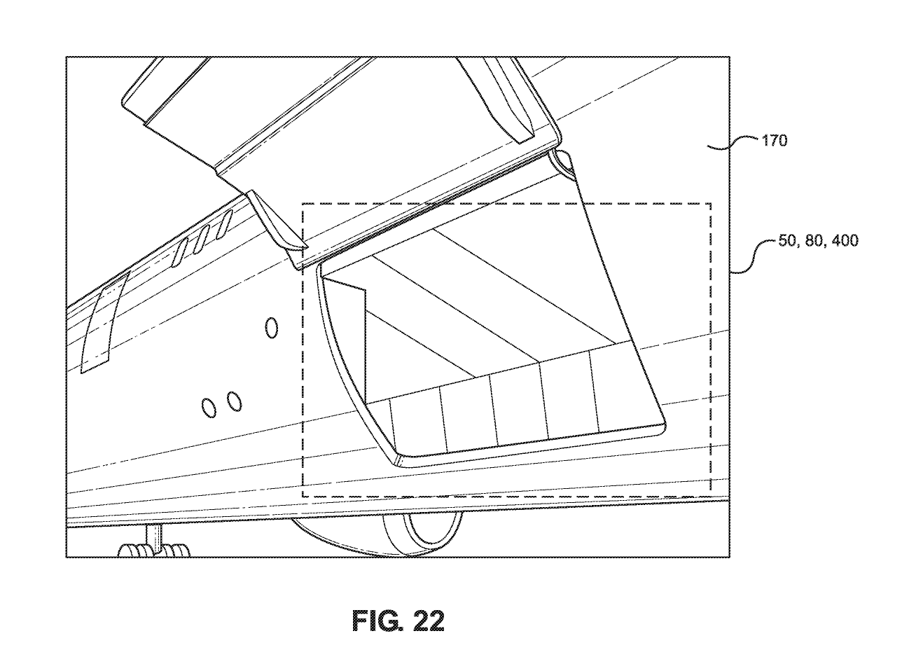

FIG. 22 shows a cargo hold space on a jet aircraft 170 in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated spaces in the jet aircraft, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

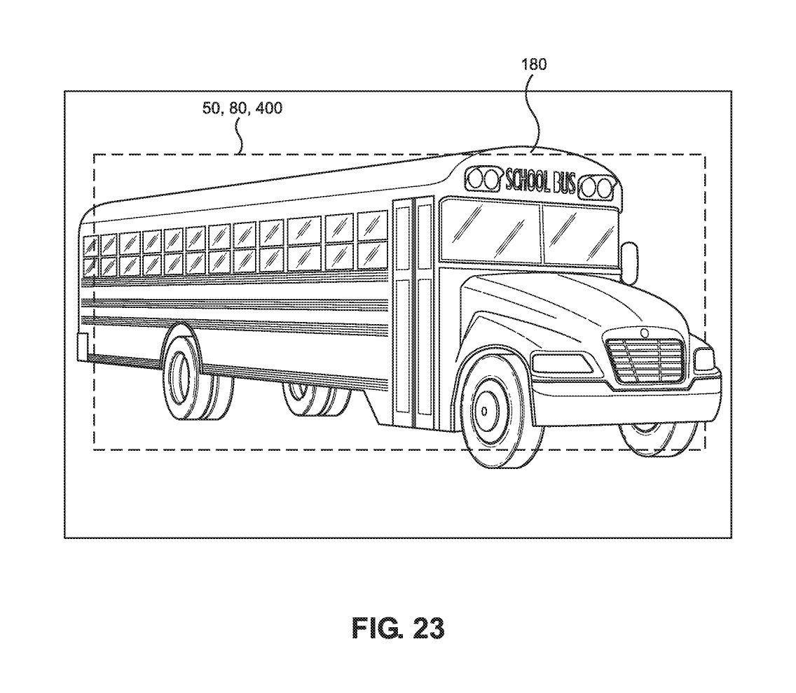

FIG. 23 shows a school bus vehicle 180 in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated spaces in the school bus vehicle, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

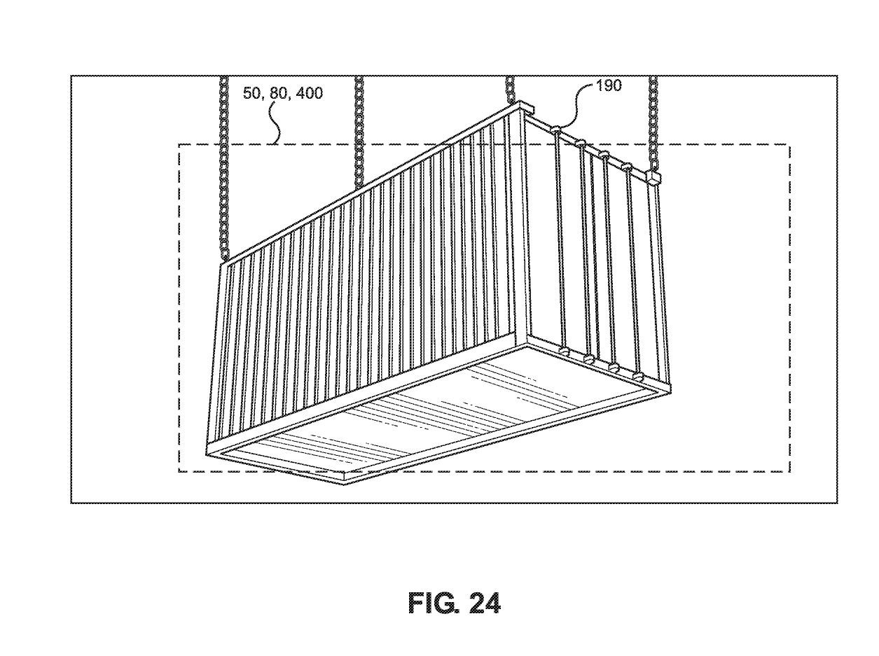

FIG. 24 shows an ISO shipping container 190 in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated space of the ISO shipping container, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

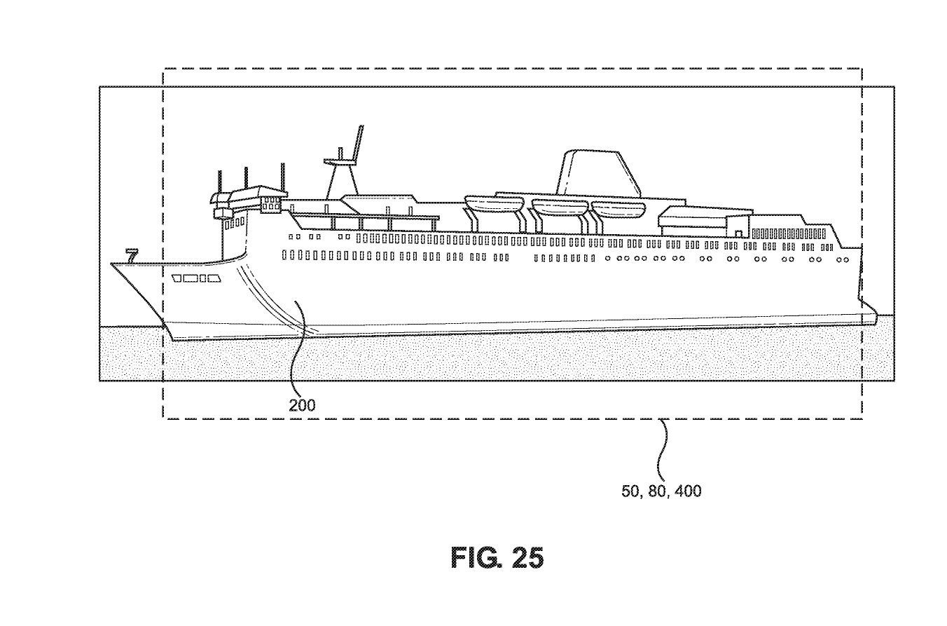

FIG. 25 shows a passenger ship vessel 200 in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated spaces in the passenger ship vessel, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

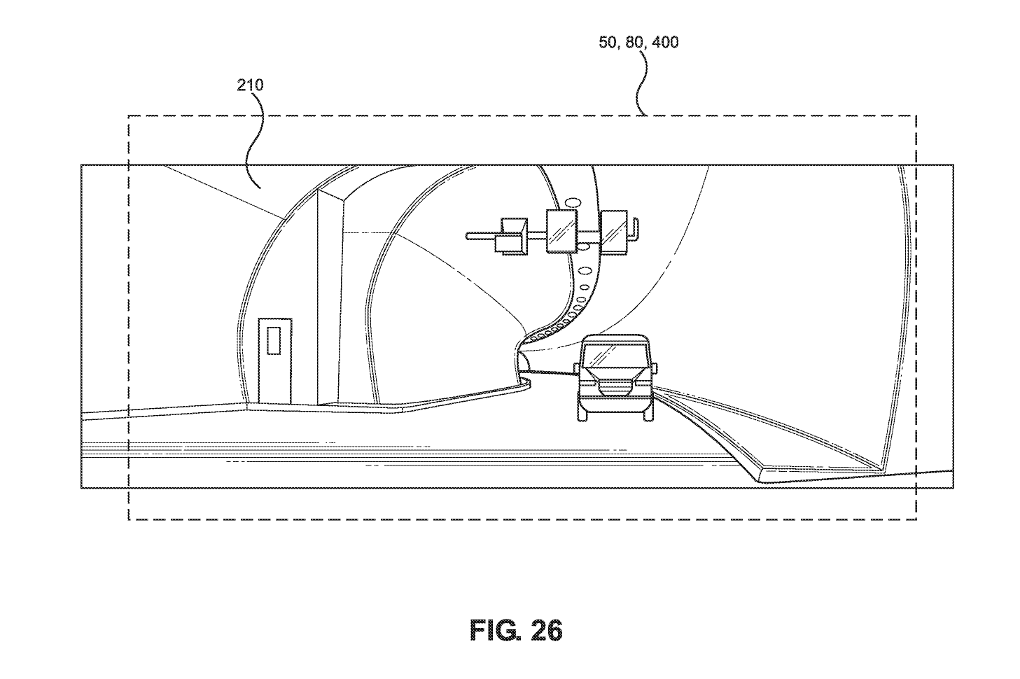

FIG. 26 shows an automotive vehicle and roadway tunnel 210 in which one or more of the fire suppression systems of the present invention 50, 80 shown in FIGS. 7 through 14 are installed and commissioned, for automatically generating clean-chemistry water-based free-radical chemical-reaction interrupting mist 61, 108 within designated spaces inside the tunnel, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

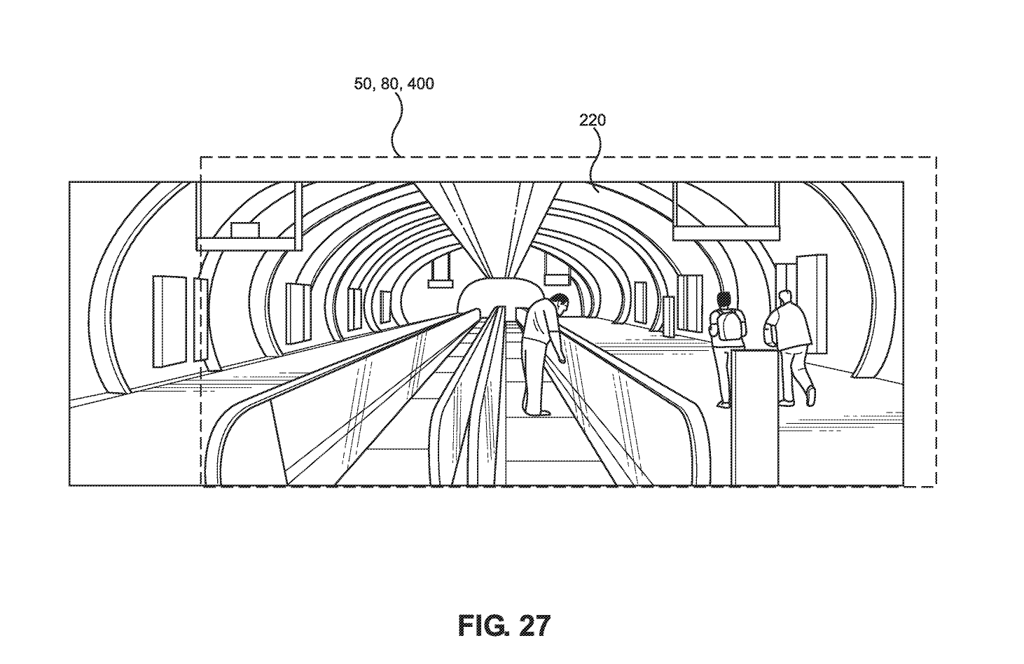

FIG. 27 shows an airport terminal 220 in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated spaces in the airport terminal, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

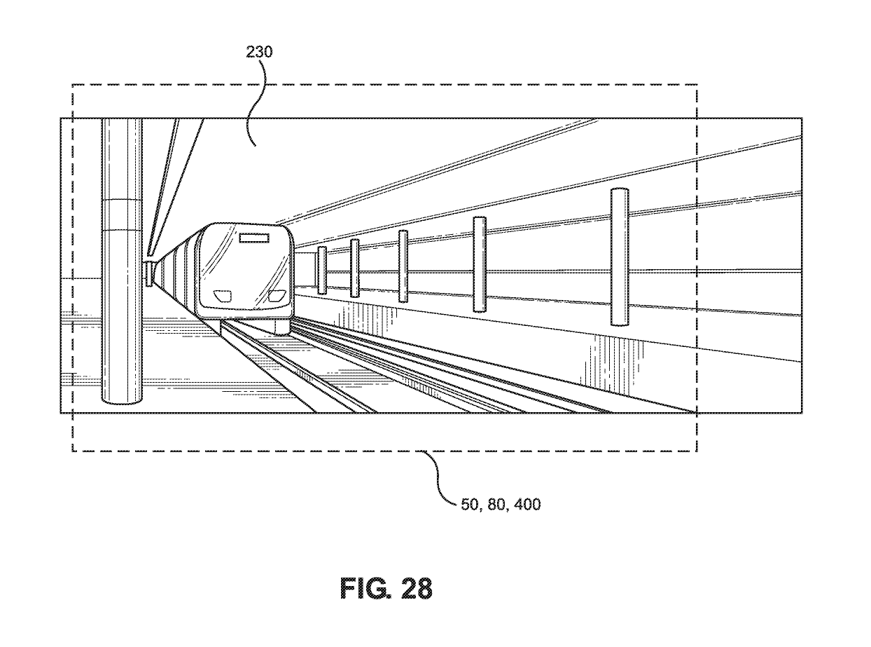

FIG. 28 shows a train tunnel 230 in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated spaces in the train tunnel, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

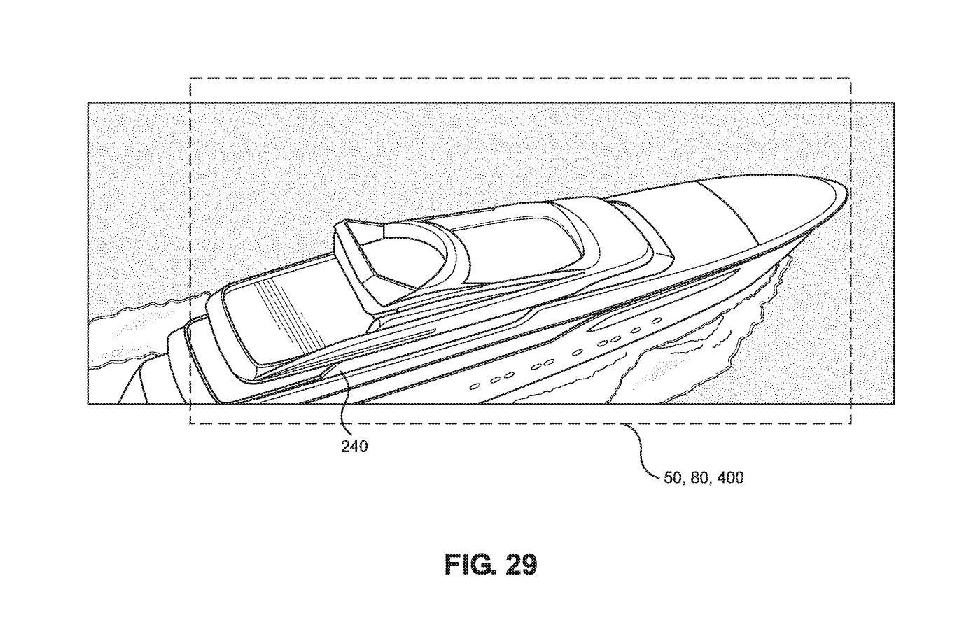

FIG. 29 shows a yacht vessel 240 in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated spaces in the yacht vessel, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

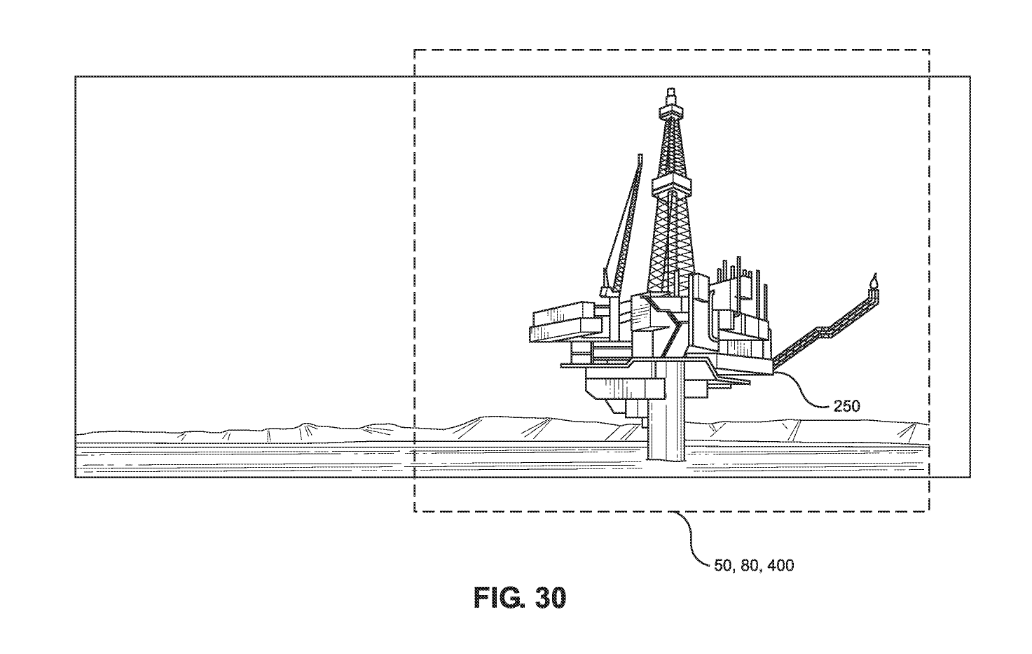

FIG. 30 shows an ocean-based oil and/or gas drilling and processing platform 250 in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated spaces in the oil and/or gas drilling platform, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

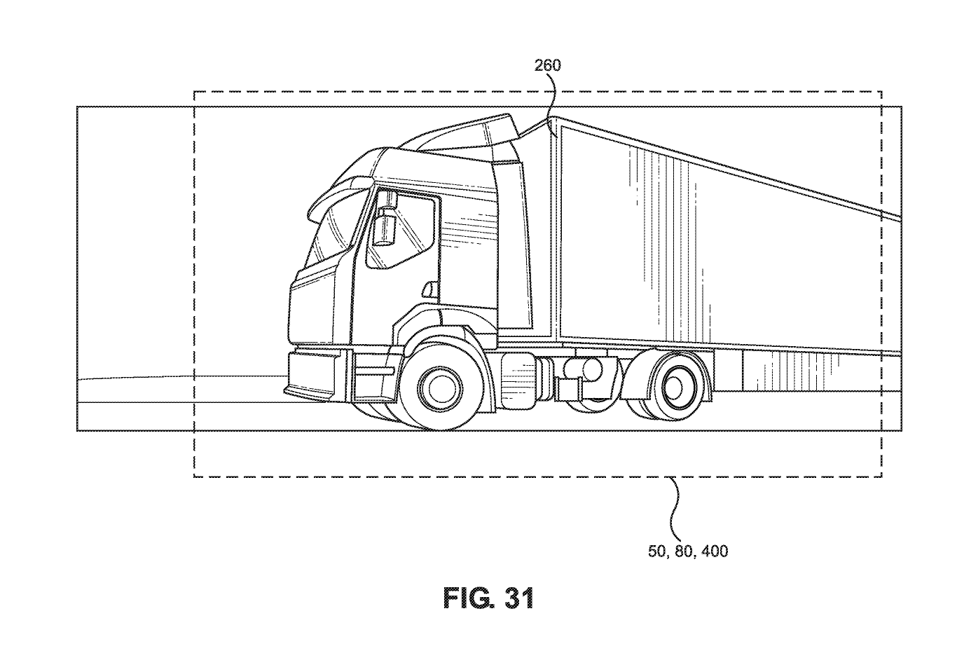

FIG. 31 shows a tractor and trailer vehicle 260 in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated spaces in the tractor and trailer vehicle, in response to automated fire detection by one or more automated fire detectors, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

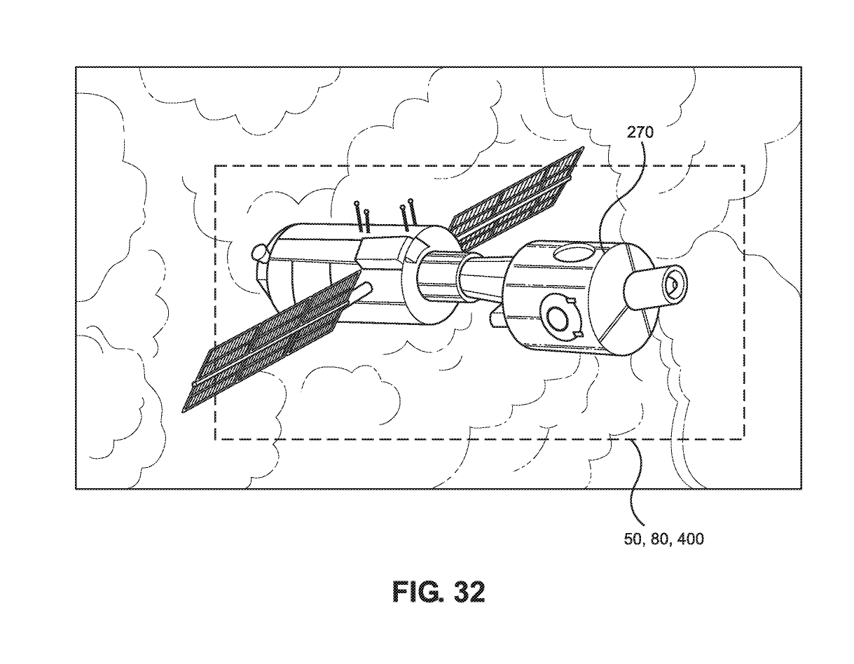

FIG. 32 shows a space-station 270, in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated spaces in the space-station, in response to automated fire detection by one or more automated fire detectors, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

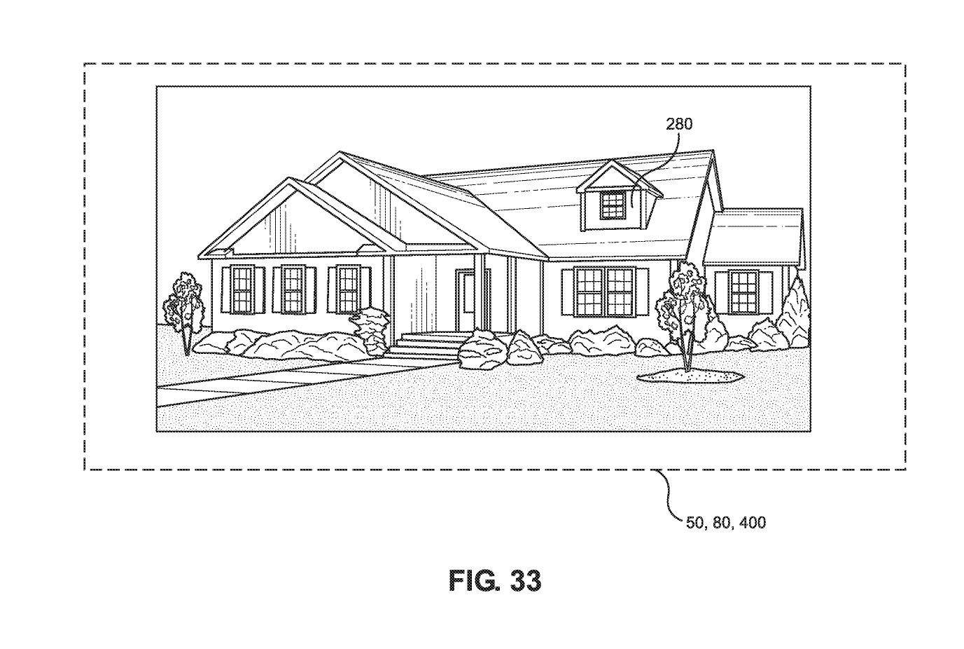

FIG. 33 shows a first prefabricated home 280, in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated spaces in the prefabricated home, in response to automated fire detection by one or more automated fire detectors, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

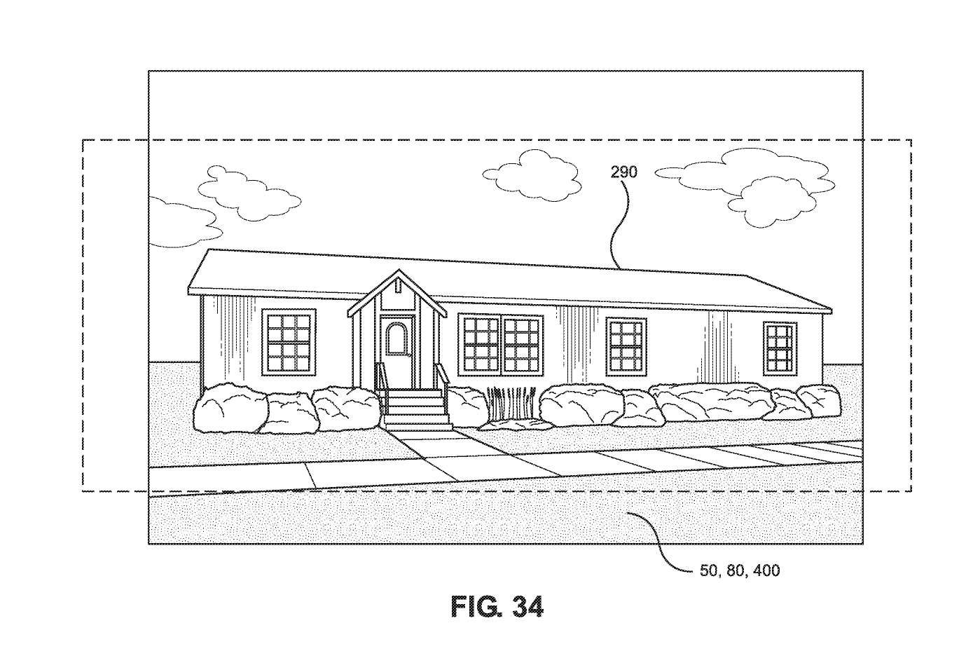

FIG. 34 shows a first prefabricated modular home 290, in which one or more of the fire suppression systems of the present invention 50, 80 shown in FIGS. 7 through 14 are installed and commissioned, for automatically generating clean-chemistry water-based free-radical chemical-reaction interrupting mist clouds of the present invention 61, 108, within designated spaces in the modular home, in response to automated fire detection by one or more automated fire detectors, in response to automated fire detection by one or more automated fire detectors 60, 93, so as to automatically suppress and extinguish the detected fire outbreak in accordance with the principles of the present invention. The portable fire suppression system 400 of the present invention can be installed in this application environment, and quickly accessed and used when required to manually suppress and extinguish fire outbreaks when they may occur.

Modifications to the Present Invention which Readily Come to Mind

The illustrative embodiments disclose the use of environmentally-clean Hartindo AF31 anti-fire (AF) water-based liquid chemical from Hartindo Chemicatama Industri, as the environmentally-clean water-based free-radical chemical-reaction interrupting liquid (62, 82) of the present invention. However, it is understood that other aqueous-based (i.e. water-based) solutions may be used provided that sufficient chemicals are added to a water solution (i.e. liquid phase at room temperature) so that the resulting water-based solution can be used to hydraulically and/or pneumatically generate clouds of mist consisting of countless microscopic droplets (i.e. micro-droplets having diameters ranging from 1 microns to 1000 microns), wherein each micro-droplet contains dissolved ions (i.e. electrically-charged atoms or molecules) supplying free-electrons that pair with and stabilize the free-radicals (i.e. free-radical vapor) in the combustion phase of a fire before any other molecules in the combustion phase can do so to sustain the chemical-reactions (i.e. free-electrons that reduce and stabilize the free-radicals before rapidly-oxidizing molecules within the combustion phase of the fire to sustain the chemical-reactions), and thereby quickly suppress and extinguish the fire.

Based on the teachings and disclosure of the present invention, those skilled in the art will know how to formulate and produce environmentally-clean water-based free-radical chemical-reaction interrupting liquid that can be used to practice the various clean-chemistry water-mist fire suppression methods, according to the principles of the present invention.

While FIGS. 7 through 14 show several illustrative embodiments, it is understood that the clean-chemistry water misting methods and apparatus of the present invention can be applied to dry and wet type system alike, within the scope and spirit of the present invention.

These and other variations and modifications will come to mind in view of the present invention disclosure.

While several modifications to the illustrative embodiments have been described above, it is understood that various other modifications to the illustrative embodiment of the present invention will readily occur to persons with ordinary skill in the art. All such modifications and variations are deemed to be within the scope and spirit of the present invention as defined by the accompanying Claims to Invention.

1-2. (canceled)

3. A single-fluid building fire suppression system using clean-chemistry free-radical chemical-reaction interrupting water-misting, wherein the system comprises
a plurality of liquid misting heads mounted in a room space and connected to a section control valve that is connected to a main control valve, where the main control valve is connected to a hydraulic fluid pump unit that pumps into the misting nozzles at a one or more of
(i) environmentally-clean water-based free-radical chemical-reaction interrupting liquid supplied from a clean-chemistry liquid storage/buffer tank via a feed fluid pump controlled by a system controller when a fire or extreme source of heat energy is automatically detected within the room or space by one or more automatic fire detectors in the building section, and
(ii) filtered water supplied from the water storage/buffer tank if and when the supply of water-based free-radical chemical-reaction interrupting liquid falls below a predetermined threshold level, while the automatic fire detector still detects predetermined conditions of fire and/or smoke in the building section, so that the system continues to produce fine fog-like water mist in the building section and extinguish the fire, while said system controller automatically controls a solenoid control valve controlling the clean-chemistry water-based free-radical chemical reaction liquid and a solenoid control valve controlling the supply of water from the main water supply, as required by the operational requirements of the system.

4. (canceled)

4. A method of suppressing a fire in a building, vessel or vehicle using a clean-chemistry water-based free-radical chemical-reaction interrupting cloud, so as to rapidly suppress and extinguish fire with less water, smoke development and risk of re-ignition, said method comprising the steps of:
(a) the presence of a fire in a building, vessel or vehicle is automatically detected by a clean-chemistry water-based misting fire suppression system supporting automatic fire detectors;
(b) environmentally-clean water-based free-radical chemical-reaction interrupting liquid is supplied to one or more misting nozzles with tiny openings under low, intermediate or high hydraulic pressure, thereby forming a cloud of fine fog-like mist comprising billions of microscopic droplets;
(c) when the water-based free-radical chemical-reaction interrupting droplets approach a burning fire, the water-based free-radical chemical-reaction interrupting droplets flash evaporate around the fire and rapidly expands near the burning fire, changing from a liquid to a gas, causing fire to cool, and displacing oxygen; and
(d) the water-based free-radical chemical-reaction vapor interrupting the free-radical chemical reactions within the combustion phase of the fire, thereby suppressing or extinguishing the fire and reducing smoke development and preventing re-ignition of fire.

5. The method of claim 4, which further comprises:
(e) if the supply of water-based clean-chemistry free-radical chemical-reaction interrupting liquid falls below a threshold level, while automatic fire detector still detect predetermined conditions of fire and smoke, then the system controller automatically switches the misting supply to water and continues to produce fine fog-like water mist in the building to extinguish the detected fire.

6. A fire suppression system using clean free-radical chemical reaction interrupting water-misting, compressing:
a plurality of atomizing-type liquid misting heads supplied with clean water-based mounted in a room space and connected to a section control valve that is connected to a main control valve;
a main control valve connected to a hydraulic fluid pump unit that pumps into the misting nozzles one or more of:
(i) environmentally-clean water-based free-radical chemical-reaction interrupting liquid supplied from a clean-chemistry liquid storage/buffer tank via a feed fluid pump controlled by a system controller, along with a pressurized atomizing media when a fire or extreme source of heat energy is automatically detected within the room or space by one or more electronic fire/smoke sensors in the section; and
(ii) filtered water supplied from the water storage/buffer tank, along with a pressurized atomizing media if and when the supply of water-based free-radical chemical-reaction interrupting liquid falls below a predetermined threshold level, while the electronic fire/smoke sensors still detect predetermined conditions of fire and/or smoke in the section, so that the system continues to produce fine fog-like water mist in the section and extinguish the fire, while the programmed system controller automatically controls a solenoid control valve controlling the clean-chemistry water-based free-radical chemical reaction liquid, and pressurized atomizing media and a solenoid control valve controlling the supply of water from the main water supply, as required by the programming of the system controller.

7-30. (canceled)
